(19) United States
(12) Patent Application Publication
(10) Pub. No.: US 2007/0073625 A1
(43) Pub. Date: Mar. 29, 2007

(54) System and method of licensing intellectual property assets

(76) Inventor: Robert H. Shelton, Coto de Caza, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/235,908

(22) Filed: Sep. 27, 2005

(51) Int. Cl. G06Q 99/00

(52) U.S. Cl. 705/59

(57) ABSTRACT

This disclosure provides an improved system and method of licensing intellectual property rights. This disclosure relates to intellectual property licensing arrangements involving a plurality of patents or other intellectual property assets that may be licensed by or on behalf of the owner(s) to one or more entities, and in which a system and method is provided for assembling a portfolio of assets that are complementary in nature; negotiating royalties with prospective licensees who are users or prospective users of all or some portion of that complementary asset portfolio; and allocating among the owners of the assets comprising such portfolio the royalty revenue thereby earned in consideration of granting certain enumerated rights in, to and under those intellectual property assets, in whole or in part, to such one or more licensees.

### BACKGROUND

1. Technical Field

The present disclosure relates to the field of licensing and, in particular, to a system and method of licensing patents and other intellectual property assets.

2. Brief Background

It is widely accepted that patents and other forms of intellectual property play an important role in our economy in encouraging a well-spring of innovation and private investment in the development of new technologies that improve productivity and quality of life for everyone. However, when one gets beneath such superficial platitudes and begins to discuss various details concerning the present system of patent procurement and enforcement, both proponents as well as detractors speak of inefficiencies, errors, inequities, abusive practices and the clear and present need for improvements.

Consider, for example, in March 2005, in remarks before an American Enterprise Institute for Public Policy Research event entitled “The Patent System and the New Economy,” Bradford L. Smith, Senior Vice President, General Counsel, and Corporate Secretary of Microsoft Corporation, stated: “We have a major interest in ensuring that we and the rest of our industry benefits from good patent protection for our inventions. But we also sit squarely on the other side of the fence as well. We, for the last three years, every week had to deal with 35 to 40 patent lawsuits pending against us. We win some. We settle some, and new suits are filed. We spend roughly $100 million a year defending against patent litigation. [ . . . ] [W]e confront a patent system in the U.S. that is excessively litigious. It's too easy for a litigant to manipulate the U.S. system and look to a patent lawsuit as the ultimate lottery ticket, hoping to confuse jurors with technical jargon that will yield the payment of a lifetime. We need to eliminate the abusive lawsuits and the patent litigation lottery it fosters.”

One readily finds there are two sides to such an account. As a patent attorney writes in a recent blog responding to an April 2005 Motley Fool article entitled “The Lowdown on Patent Shakedowns” (addressing “patent trolls,” “patent terrorism” and the likes of the abusive litigants about whom Mr. Smith's remarks castigate): “The supposed problems with the patent system are for the most part created by big business itself. It's not the individual inventors and smaller businesses that stretch patent litigation over several years and run up millions of dollars in legal fees. It's not the smaller inventors and businesses that elect ‘to leave no stone unturned’ in their pursuit to avoid a legitimate patent claim. (Despite stories to the contrary, weak patent cases are quickly and routinely tossed out on summary judgment.) And it's not the smaller inventors and businesses that have the deck stacked in their favor. Far from it. Big business is and always has been the primary beneficiary of the patent system. The cries we hear now are not those of innocents ‘victimized’ by an unfair system. Rather, they are the cries of those who don't like finding out they're expected to follow the laws and live under the same system they have mostly created themselves. Some call that unfair. Others call that justice.”

Costly patent litigation is certainly one aspect of the problem. In fact, according to a 2003 report by the American Intellectual Property Law Association, the average cost of a patent case with over $25 million in damages at stake is about $3.9 million; and cases with damages of between $1 million and $25 million cost about $2 million to litigate. Nevertheless, a realistic assessment reveals that the issues involved are far more complex than simply abusive lawsuits, irrespective of ones' view concerning which party may be responsible for fomenting them or driving up related litigation costs. In this regard, part of the underlying challenge is the unique character of intellectual property compared with other forms of assets such as real and personal property. Several of these differences are exceedingly fundamental, and must be taken into account in appreciating the challenges inherently involved in this field.

For one, intellectual property rights give their owner no right to make, use, sell, or copy the technology or expression that is protected by such rights. For example, inventions are often improvements on earlier basic inventions made by others. If the owner of the intellectual property rights to the basic invention wants to exercise its exclusivity, that owner can stop the owner of the rights to the improvement from making, using, or selling the improved invention. Likewise, the owner of the rights to the improvement can stop the owner of the rights to the basic invention from making, using, or selling the improved invention. As shown in the foregoing example, the intellectual property right each party owns conveys only the right to exclude, not the right to use. Although intellectual property includes patents, trademarks, copyrights, trade secrets and a variety of other legally cognizable intangible rights to innovations and their expression, it is addressed herein in terms of patents. Thus, a patent is by definition only a negative property right—strictly speaking, a right for a limited period of time to forbid others from making or using without permission.

As a stand-alone asset, a patent does not give its owner the right to practice his or her own invention, much less give that owner positive rights to do so that he may in turn convey to a third party such as a licensee. For this reason, most exclusive rights are nothing more than the right to sue an infringer; and a party licensing non-exclusive rights—particularly in a field involving numerous patented as well as unpatented technologies owned by multiple parties—is acquiring little more than avoidance of the threat of litigation and the related liability by only one of what may be numerous prospective plaintiffs. Accordingly, some firms with relatively modest or no intellectual property but substantial other assets, personnel and capital invested in implementation view being exceedingly tough on any one patent holder seeking to assert his, her or its rights as prophylactic against further claims being asserted by others and therefore of greater value than what they view as being little or no “real” value in voluntarily paying for a license.

Second, although it's often said that the language of the patent claims sets forth the “metes and bounds” description of the invention, in fact a metes and bounds survey of real property is far more precise than the words of any issued patent—particularly in the hands of a capable patent litigator. Moreover, until these words have been construed by a Federal District Court judge as a matter of law, neither the patent owner nor prospective licensee has any assurance where the precise boundary between infringing and non-infringing use is located. To make matters even more challenging (as well as contentious, time-consuming and costly), the Court of Appeals for the Federal Circuit (the Federal Circuit) reviews all claims construction decisions de novo on appeal and has an exceptionally high reversal rate (currently reported as approaching 50%/) of all District Court claims construction rulings, meaning that until the matter is litigated and that outcome has been affirmed on appeal by the Federal Circuit, no one knows precisely where the boundaries of the [negative] rights conveyed by an issued patent are situated and therefore whether a license is even required. Without a clear definition of such boundaries, title insurance and other traditional types of financial instruments (that inherently rely upon the ability to clearly define where a party's rights exist and what they are worth) become impractical or prohibitively expensive, if not rendered entirely impossible under the present system.

And third, likely exacerbated to at least some degree by the foregoing issues, placing a fair and reasonable value on the use of an intellectual property right (particularly when removed from other complementary rights) often involves considerable margin for debate—even to the extent both parties agree that there is literal infringement and some level of compensation would be appropriate. As Robert Kohn, Vice-Chairman of the Board of Borland Software Corporation (who coincidentally served as the company's General Counsel during the Lotus v. Borland intellectual property case), explained in February 2002:
[T]he point I want to make about the system is this. When you get involved in one of these cases, or you get involved even with a settlement discussion, and let's say you're legitimately infringing somebody else's patent in some small piece of process or something that you use in this ten million lines of software code for your product, potentially hundreds of thousands of patentable ideas in your code, somebody sues you and says, “You're using our process, you're using our this or that, our interface design. We want a ten percent royalty on your sales, we want ten percent of your gross.”
I mean, you end up getting into these discussions, “Well, wait a minute, wait a minute. This is only one patent out of a hundred thousand, okay. You can't ask us for ten percent of our product, it's just a minor feature. Yeah, we're infringing it.” “Well, if you don't pay us the money, we're going to sue you, and you know what the damages are in a patent case.” [ . . . ]
So, my argument is at the end of the day there needs to be a major overhaul of how damages are determined in these large intellectual property cases so that there's some reasonableness brought to the table so that when there's one little process or procedure in a code you don't get into this huge discussion of what are your profits and what are our lost profits. Some judge should be able to say, “Look, I'm going to set a reasonable royalty here. It should be one-hundredth of one-thousandth of a percent because this is what the value of your particular idea is to the whole piece of software.”

Intellectual property valuation specialists have traditionally employed three main approaches for valuing patents and other intangible intellectual property assets. These are: (1) the cost-basis approach; (2) the market approach; and (3) the income approach. See, for example, Gordon Smith and Russell Parr, Valuation of Intellectual Property and Intangible Assets, 3rd Edition (John Wiley & Sons: 2000) and Intellectual Property: Valuation, Exploitation and Infringement Damages (John Wiley & Sons: 2005). Dr. Richard Razgaitis, in Valuation and Pricing of Technology-Based Intellectual Property (John Wiley & Sons: 2002) (herein the “2002 Razgaitis textbook”), suggests six methods for valuation, including: (1) industry standards; (2) rating/ranking scores; (3) rules of thumb; (4) discounted cash flow; (5) Monte Carlo calculations and (6) auctions.

Several patented methods have also been proposed, including U.S. Pat. No. 6,847,966 to Matthew Sommer, et al., entitled “Method and System for Optimally Searching a Document Database Using a Representative Semantic Space” ('966 patent), which is reportedly employed in preparing the so called Patent Factor™ Index (PF/i) reports (a sample of which may be viewed on line at http://www.iamcafe.com/patent_reports/patentfactor_terms.pdf) and other specialty products offered by PatentCafe®; U.S. Pat. No. 6,556,992 to Barney et al., entitled “Method and System for Rating Patents and Other Intangible Assets” ('992 patent), which discloses a statistical method and system for independently assessing a patent's relative breadth, defensibility and commercial relevance, as reportedly employed in whole or in part by PatentRatings LLC in calculating Intellectual Property Quotient (IPQ) scores and Patent Rating™ reports for patent assets (a sample of which may be viewed online at http://www.patentratings.com/001/rating_report_{—}01.pdf); and U.S. Pat. No. 6,263,314 to Donner, entitled “Method of Performing Intellectual Property (IP) Audit Optionally Over Network Architecture” ('314 patent).

Additionally, the matter is the subject of several currently pending patent applications, including U.S. Patent Application No. 20050010515 by Woltjen et al., entitled “Method of Identifying High Value Patents Within a Patent Portfolio;” U.S. Patent Application Nos. 20020004775, 20020002524 and 20020002523 by Kossovsky et al., entitled “Online Patent and License Exchange” (proposing use of the Black-Scholes option pricing formula in conjunction with a proposed online patent exchange known as pl-x.com); U.S. Patent Application No. 20030212572 by Poltorak, entitled “Method and Apparatus for Patent Valuation;” U.S. Patent Application No. 20020077835 by Hagelin, entitled “Method for Valuing Intellectual Property” (associates the value of intangible assets based on the comparative monetary value of tangible assets associated with such intangible assets); U.S. Patent Application No. 20040133433 by Lee et al., entitled “Method for Analyzing and Providing of Inter-Relations between Patents from the Patent Database;” U.S. Patent Application No. 20040181427 by Stobbs et al., entitled “Computer-Implemented Patent Portfolio Analysis Method and Apparatus” and U.S. Patent Application No. 20030139988 by Clarkson, entitled “Method for Deriving Optimal Income Stream in Intellectual Asset Transactions.”

In March 2001, at the National Bureau of Economic Research's “Innovation Policy and the Economy” conference, Dr. Carl Shapiro, a professor of Business Strategy at University of California, Berkeley, presented a paper entitled “Navigating the Patent Thicket: Cross Licenses, Patent Pools, and Standard-Setting,” a copy of which paper (“Navigating the Patent Thicket”) may be reviewed online at http://www.idei.fr/doc/conf/sic/papers2001/shapiro.pdf, and which is incorporated herein by reference. In it, Dr. Shapiro observes: “Our current patent system is causing a potentially dangerous situation in several fields, including biotechnology, semiconductors, computer software, and e-commerce in which a would-be entrepreneur or innovator may face a barrage of infringement actions that it must overcome to bring its product or service to market. In other words, we are in danger of creating significant transactions costs for those seeking to commercialize new technology based on multiple patents, overlapping rights, and hold-up problems.”

Jordan Greenhall, the Chief Executive Officer of DivX, Inc., a privately-held firm that offers a proprietary video compression technology with over 160 million users worldwide, explained the problem this way during a February 2002 workshop: “I recently took one of my lead developers, a gentleman who's widely considered a leader in his field . . . and asked him to evaluate a particular patent that we've been hearing about in the marketplace. We did a quick search on the [USPTO] website . . . and uncovered no less than 120 patents that claim to be within the general scope of this particular patent, which was widely cited. The poor guy spent the better part of five days examining all these different patents and came back to me saying, ‘I haven't the slightest idea whether or not we infringe on these patents, and frankly, they all seem to infringe on one another.’ The end result being that I have no idea whether my product infringes on upwards of 120 different patents, all of which are held by large companies who could sue me without thinking about it.” A copy of Mr. Grenhall's testimony, along with other top executives from a variety of industries who described their challenges under the existing state of the art, may be reviewed online at http://www.ftc.gov/opp/intellect/020227trans.pdf, and is incorporated herein by reference (“February 2002 workshop”). Mr. Greenhall summarizes this way the risk that he and hundreds of other leading-edge firms confront: “I'm sitting with a nuclear bomb on top of my products that could go off at any point and cause me to simply not have a business anymore.”

True to his paper's title, Professor Shapiro coins the term “patent thicket” to refer to the overlapping set of patent rights (inherently made more gnarly by the foregoing described unique characteristics of patents) with such firms seeking to commercialize new technologies must contend. Additionally, he posits a second concern, which he refers to as the “hold-up problem,” and remarks that it is worst in industries where hundreds if not thousands of patents, some already issued, others pending, can potentially be read on a given product. About these, he notes: “In these industries, the danger that a manufacturer will ‘step on a land mine’ is all too real. The result will be that some companies avoid the mine field altogether, i.e., refrain from introducing certain products for fear of hold-up. Other companies will lose their corporate legs, i.e., will be forced to pay royalties on patents that they could easily have invented around at an earlier stage, had they merely been aware that such a patent either existed or was pending.”

Jordan Greenhall candidly described his firm's strategy designed to confront these realities during the February 2002 workshop. “The end result,” he testified, is that “I have now issued a directive that we reallocate roughly 20 to 35 percent of our developer's resources and sign on two separate law firms to increase our patent portfolio to be able to engage in the patent spew conflict. I think the concept here would be called saber rattling. I need to be able to say, ‘Yeah, I've got that patented too, so go away and leave me alone.’” As Dr. Shapiro points out in Navigating the Patent Thicket, DivX is not unique in this approach. There is, he writes, considerable research showing “that companies are increasingly inclined to seek patents, causing an increase in the ‘propensity to patent,’ as well as an increase in the practice of ‘defensive patenting.’”

Other companies take the approach of ignoring these issues altogether, some say because they don't know any better, some perhaps borne out of frustration with the present state of affairs, and others based on the view that whatever they're compelled to pay to those parties who may successfully enforce their rights following years of contentious litigation and millions of dollars in related legal costs will end up being far less than taking any of these rights seriously from the start. As Eric Raymond, co-founder and president emeritus of the Open Source Initiative (OSI) candidly explains: “And this [e.g., completing just enough of a pro forma review to have on the record that a review was carried out, then basically ignore your risks until and unless you are sued] is exactly the advice patent lawyers will give you. You don't ‘want’ to know what patents you may be infringing in advance—that makes it ‘willful’ and trebles the damages.” “Yes, this is crazy,” Raymond is also quoted as saying in SitePoint's March 2005 column concerning the legal issues of Open Source. “It reflects the fundamental insanity of modern IP law.”

Microsoft, DivX, Shapiro, Raymond and advocates for patent owners who contend their clients' rights are routinely infringed by companies playing the odds they will not be held accountable are far from alone in expressing grave concerns. In fact, between February and November 2002, the Federal Trade Commission and the Anti-Trust Division of the Department of Justice held 24 days of hearings concerning the problems of commercializing new discoveries and the need for clearing the thicket, ultimately issuing a report in March 2003. Drawing upon input from more than 300 panelists, including business representatives from large and small firms, and the independent inventor community; leading patent and antitrust organizations; leading antitrust and patent practitioners; and leading scholars in economics and antitrust and patent law, in October 2003, the FTC released an extensive report, entitled “To Promote Innovation: A Proper Balance of Competition and Patent Law and Policy,” a copy of which report (“2003 FTC report”) is available online at http://www.ftc.gov/os/2003/10/innovationrpt.pdf, and is incorporated herein by reference. Also, see http://www.ftc.gov/opp/intellect/index.htm for links to all of these hearings.

A number of participants have periodically suggested the prospect for forming patent pools as a way to help address a number of these problems. In fact, on Jan. 19, 2001, the United States Patent and Trademark Office (“PTO”) officially announced that it was releasing a white paper concerning the potential use of patent pools as a way to improve “access to vital patented biotechnology products and processes.” Accompanying the USPTO's public announcement was a report, dated Dec. 5, 2000, entitled “Patent Pools: A Solution to the Problem of Access in Biotechnology Patents?,” which report (“PTO white paper”) may be reviewed online at http://www.uspto.gov/web/offices/pac/dapp/opla/patentpool.pdf, and is incorporated herein by reference.

Similarly, Dr. Shapiro has repeatedly suggested that the patent thicket situation “is precisely the classic ‘complements problem’ originally studied by [French philosopher, mathematician and economist, Augustin] Cournot in 1838,” and suggested that the “basic theory of complements (used in fixed proportions) gives strong support for businesses to adopt, and for competition authorities to welcome, either cross-licensees, package licenses, or patent pools to clear [ ] blocking positions.” He remarks that while a “royalty-free cross license is ideal from the point of view of competition[,] any cross license is superior to a world in which the patents holders fail to cooperate, since neither [party] could proceed with actual production and sale in that world without infringing on the other's patents. Alternatively, if the two patent holders see benefits from enabling many others to make products that utilize their intellectual property rights, a patent pool, under which all the blocking patents are licensed in a coordinated fashion as a package, can be an ideal outcome.”

He concludes that in order to “solve the complements problem generally, and to cut through the patent thicket specifically, requires coordination among rights holders.” But he notes that “[s]uch coordination itself faces two types of obstacles. First, there are inevitably coordination costs that must be overcome. Second, antitrust sensitivities are invariably heightened when companies in the same or related lines of business combine their assets, jointly set fees of any sort, or even talk directly with one another.”

In April 2002, Gerrard Beeney, a partner with Sullivan & Cromwell, testified before the joint FTC/DOJ hearings and, alluding to Professor Shapiro's 2001 paper in his written testimony, stated: “[I]ntellectual property pools serve an important pro-competitive goal of clearing the ‘patent thicket.’ [ . . . ] Indeed, Professor Shapiro calls the pool the ‘purest solution’ to the intellectual property bottleneck. [ . . . ] Thus, it is appropriate to begin analysis of intellectual property pools by emphasizing that, in a proper form, pools are good. [ . . . ] Thus, the question that should be addressed is not yes or no to pools, but rather how to balance the measures necessary to licensors and licensees to facilitate formation and use of pools with guidelines intended to minimize any harm to competition or consumer welfare. [ . . . ] The question is not whether to permit or forbid the formation of patent pools, but rather to identify those licensing practices that advance the undeniable pro-competitive aspects of pool licensing without causing unjustifiable or countervailing competitive harm.” A copy of Mr. Beeney's remarks (“2002 Beeney testimony”) may be reviewed online at http://www.ftc.gov/opp/intellect/020417garrardrbeeney.pdf, and is incorporated herein by reference.

As a February 2005 article in IP Law and Business attests, despite some limited success by a few firms such as Denver-based MPEG LA in using patent pools to clear the thicket pertaining to several key digital compression standards, “[b]ranching out beyond the pool-friendly world of compression technology hasn't been easy.” A copy of the IP Law article may be reviewed online at http://www.ipww.com/texts/0205/splash0205.html, and is incorporated herein by reference (“IP Law article”). Denver-based MPEG LA (whom Mr. Beeney coincidentally represented in securing a business review letter from the DOJ with respect to its first such patent pool respecting MPEG-2 video compression tools) has since 1997 formed six pools, all related in one way or another to video. As described in the IP Law article, since 1997, the firm's Vice President for Licensing and Business Development, Lawrence Horn, has been seeking to expand into other fields, including biotechnology—a field in which the USPTO has itself suggested the use of patent pools—as well as digital rights management (DRM). Nonetheless, to date the firm's efforts in biotech have met with little success since, as Horn concedes, “the mind-set is not exactly to pool,” and the firm has similarly experienced difficulty in getting much traction in DRM where although “the big [patent owners] are pushing for standards, they're also pushing their own proprietary solutions,” thereby making a patent pool under the existing state of the art less attractive. Despite Horn's statement that a very narrow DRM-based patent pool “is the first of what we think will be many licensing pools,” and that as new standards emerge, so too will new pools, IP Law for one remains skeptical, with its writer remarking that “breaking in a new DRM pool may prove harder than breaking into the content it protects.”

Turning to a different field from the foregoing problematical backdrop in the fields of patents, patent licensing, antitrust law and, as shown, even patent pools under the existing state of the art, one finds a considerably brighter outlook. Over the past several years a number of large group collaboration technologies have been successfully employed in the telecommunications, software programming, retail, finance, entertainment, media and advertising industries. The cover story in the Jun. 20, 2005 issue of Business Week, entitled “The Power of Us: Mass Collaboration on the Internet is Shaking Up Business,” provides a discussion of this trend toward “mass collaboration” and describes the trend toward using a variety of Internet-based technologies to enable companies and industries to “tap into the collective intelligence of employees, customers and outsiders.” The Jun. 20, 2005 Business Week article may be reviewed on online at http://www.businessweek.com/go/future_of_tech; and together with its various embedded hypertext links (collectively, “June 2005 articles”), is incorporated herein by this reference.

The June 2005 articles quote one industry insider as commenting that “the Web's ability to serve as a meeting ground and scheduling coordinator” represents nothing less than “The Future of Competition.” As persons of ordinary skill in the art will understand, these capabilities including email, traditional TCP/IP and HTTP-based infrastructure, and an emerging generation of network-based technologies that include file-sharing, blogs, group-edited sites, instant messaging, widgets and a number of social networking services, can be used to connect many people with many others focused on a common interest and that permit persons to weigh in on issues of relevance. Without limitation, these systems of the prior art include U.S. Pat. No. 6,189,029 to Fuerst, entitled “Web Survey Tool Builder and Result Compiler” ('029 patent); U.S. Pat. No. 6,457,045 to Hanson et al, entitled “System and Method for Group Choice Making” ('045 patent); and U.S. Pat. No. 6,801,900 to Lloyd, entitled “System and Method for Online Dispute Resolution” ('900 patent).

In this regard, the '029 patent appears to describe a system comprising a computer, a communications link between the computer and the Internet and the creation of surveys and the automatic collection and tabulation of survey results corresponding to user responses. Such surveys are constructed by a creator entering the text comprising the survey questions. The form of the questions may include at least seven different question types such as, radio (e.g., a multiple choice question with a single answer), multiple choice with multiple answers, input (with a defined input field size and type) short answer text (with a defined field length), scaled response (e.g., answer selected from among five options such as “strongly disagree,” “disagree,” “neutral,” “agree,” and “strongly agree”), Yes/No, or left/right, text areas with various number of columns and rows, and the like. Survey results are collected in a relational database as each user completes the survey; and thereafter, the survey creator can access the results and apply statistical tools or other analytical software applications to data mine the tabulated results.

The '045 patent appears to describe a system that can be used to support making choices among a group of participants connected to a network. Under this system, a participant creates an electronic form specifying the subject matter of a choice topic and a list of network addresses corresponding to other participants. A server receives the form and includes resources for delivering an electronic mail message associated with an electronic medium providing various choices. When the participant opens the message, an electronic medium is produced by the server that includes static and dynamic regions. The participant can input a choice using an interaction region. The dynamic regions are asynchronously updated in the server and indicate the current content of the electronic medium that can be accessed by other participants in the group.

The '900 patent appears to describe a system comprising a computer, a communications link between the computer and the Internet and an active issue database, accessible by the computer, containing a plurality of issue files and corresponding voting forms. The system also includes issue presentation software executing on the computer for retrieving issue files and corresponding voting forms from the active issue database and presenting the issue files and corresponding voting forms to users over the communications link. The system further includes vote processing software executing on the computer for receiving the completed voting forms submitted by users over the communications link, updating the issue files in the active issue database to reflect the completed voting forms, and presenting vote tallies to users over the communications link.

Additionally, those of ordinary skill in the art will recognize that a number of other technologies are used to help enable such services and benefit from information derived from them. These include collaborative filtering techniques to generate personal recommendations based upon explicit ratings, as well as so called “content-based” filtering techniques that extract key concepts from documents and websites and automate the categorization, cross-referencing, hypertext linking and/or presentation of such information. Another technology is referred to as “content mining,” which automatically analyzes text and other unstructured content to make intelligent decisions and recommendations. And yet another technique involves the use of so called “implicit ratings” that are based on specific actions of participants and which are, in turn, used to provide recommendations based on peer group categorization but without resorting to explicit ratings.

Well conceived implementations employing these and other related network-based technologies are understood as increasingly providing a way “of turning self-interest into social benefit—and real economic value [through an] ‘architecture of participation,’ so it's easy for people to do their own thing . . . [but where] those actions can be pooled into something useful to many.” The June 2005 articles describe capabilities like the seller ratings on eBay, song ratings on Yahoo! and millions of customer-generated product reviews on Amazon.com, eOpinions.com and a multitude of similar services—all of which, at their core, “help decide hits and duds”—as being examples of the power of such technologies in action. Yet these sorts of technologies have not heretofore been proposed nor applied to the field of patent licensing and enforcement.

3. Description of the Related Art

Although the origins of patents for invention are obscure, many scholars trace the tradition to England, where its origins can be traced back to the 15th century when the Crown started making specific grants of privilege to manufacturers and traders. Such grants were signified by Letters Patent, open letters marked with the King's Great Seal. According to the UK Patent Office, the earliest known English patent for invention was granted by King Henry VI to Flemish-born John of Utynam in 1449. The patent gave John a 20-year monopoly for a method of making stained glass, required for the windows of Eton College, which had not been previously known in England.

The first Article of the U.S. Constitution, Section VIII, provides the basis for the U.S. patent system. [U.S. Constitution, Article I, Section 8, clause 8]. In this article, the Founding Fathers granted to Congress the power to form a system “to promote the progress of Science and useful arts by securing for limited terms to authors and inventors the exclusive right to their respective writings and discoveries.” Almost a century later, Abraham Lincoln expressed his support for the patent system when he stated that “the patent system . . . add[s] the fuel of interest to the fire of genius, in the discovery of new and useful things.”

Clearly, the purpose of the patent system, from its earliest beginnings was to provide inventors and their employers with the incentive to create and fund the development of new and useful technologies. As described above, in order to achieve this objective, the incentive that the government chose to offer was the granting of an exclusive right to prevent others from making, using or selling the invention for a period of years sufficient to enable the recovery of these costs and, if all went well, to return a profit. In exchange for this exclusive grant of monopolistic rights, the inventor provides the public with a full written and graphical disclosure of his or her invention, sufficient to enable a person having ordinary skill in the field of the invention to make and use the invention, which rights in turn become public property upon the expiry of such period.

Thus, a patent may be thought of as a bilateral agreement with the government, an agreement whereby both the inventor and the public benefit if the terms are honored. In fact, this bilateral agreement underscores a system that most people agree has worked extremely well. As the USPTO has itself said: “The American IP system has played a significant role in the history of our nation's economy. Patents and trademarks have long protected American creativity and ingenuity. [ . . . ] The strength and vitality of our technology-driven economy depends directly on the effectiveness of the mechanisms that protect new ideas and investments in innovation and creativity. The continued demand for patents and trademark registrations underscores the ingenuity of U.S. inventors and entrepreneurs.”

Today's inventors and entrepreneurs join a long and esteemed tradition. According to historical accounts, the first U.S. patent was issued on Jul. 31, 1790 for an improvement “in the making Pot ash and Pearl ash by a new Apparatus and Process.” The patent was signed by President George Washington, Attorney General Edmund Randolph and Secretary of State Thomas Jefferson. Only two other patents were granted that year, one for a new candle-making process and the other for flour-milling machinery. Between 1790 and 1836, when the current patent numbering system began, a total of only 9,957 patents were issued (or approximately 220 patents per year over the 45-year period).

By the 1850's, the pace of innovation had quickened substantially. In fact, during the decade between 1850 and 1860, the U.S. Patent Office issued an average of approximately 2,000 patents annually (e.g., between 1850 and 1860, the USPTO issued U.S. Pat. Nos. 6,981 to 26,642). By that time, two other things changed as well. First, the sheer complexity of inventions was increasing as America moved from having been an essentially agrarian society to an industrial economy; and with this change, the possibility was inevitably increasing that a commercial product would entail a number of distinct innovations conceived and patented by several different inventors. And second, the accelerated speed of invention, aggregate number of patents issued each year and duration in the period of exclusivity each patent conveyed reached the point that the patents owned by multiple parties were almost certain to be implicated in producing a number of the more complex products in the manner that an increasingly sophisticated consumer base demanded.

Within this context, in one cutting-edge industry of the day, it is written that by the late-1850's, “close to 1,000 sewing patents existed, and every machine made infringed on not one or two, but several patents held by somebody some place. Court dockets filled to overflowing. Attorney's specialized in the complicated in and outs of sewing machine patents and raked in hefty and seemingly unending fees.” As the aforementioned USPTO white paper summarizes, in order to overcome these inevitable challenges, reportedly America's first patent pool was created.

Named the Sewing Machine Combination, this patent pool was formed by Isaac Merritt Singer, Elias Howe, Wheeler & Wilson Co., and Grover & Baker Co. According to historical accounts, the rapidly escalating number of patent infringement cases involving various components of the sewing machine prompted Orlando B. Potter, a lawyer and president of Grover & Baker, to recommend an alternative to his firm and the other major manufacturers “suing their profits out of existence.” According to that proposal, implemented in 1856, the four parties combined their patents and sold licenses to manufacturers for a single fee. That fee—according to at least one account, reportedly $15 per machine—was in turn divided among the patent holders until 1877 (or in Elias Howe's case through 1867), when the last patent expired.

The USPTO white paper provides a brief summary concerning the history of patent pools, various benefits that can derive from their use, a number of the concerns that have historically been voiced about them, and provides a broad overview of the legal guidelines for forming and operating such intellectual property pooling arrangements. As the USPTO states, “patent pools have played an important role in shaping both the industry and the law in the United States.” Over the past 150 years, the public and legal perceptions concerning the practice of pooling intellectual property rights have waxed and waned, ranging from patent pooling being legally proscribed due to various abuses and related antitrust concerns, to viewing such pooling arrangements as being highly desirable (if not essential), such as when the combination of patents held by the Wright Company and the Curtiss Company was desperately needed to enable the country's production of airplanes prior to World War I.

The statistical measures concerning patent activity (and the likelihood that with more issued patents, there will be more overlapping rights) are themselves revealing about why the USPTO and others have again suggested taking a hard look at patent pools. Currently, the U.S. Patent Office is approaching 170,000 new patent issuances annually (e.g., between 1999 and 2004, the USPTO issued U.S. Pat. Nos. 5,855,021 to 6,671,884). At such rates of issuance, approximately two million patents—each with its respective claims designed to exclude unlicensed parties from practicing one or more disclosed inventions—have yet to pass into the public domain. Whereas upon expiry, all of these rights will become public property free for anyone's use, until that time, under 35 U.S.C. § 284, all of these patent holders are legally entitled to obtain at least a reasonable royalty from anyone who makes, uses, sells, offers to sell, or imports into the United States the invention (or substantially the invention) as claimed therein.

Moreover, in addition to the sheer number of patents that must be considered as giving rise to liability, the products, processes and services that these patents cover have become far more complex as the subject matter has evolved from early sewing machines being considered as “cutting-edge” in the late-1850's to today's technologies involving microchips that are produced in billion dollar factories, diagnostics and drug development efforts costing literally hundreds of millions, personal computers and consumer electronics which are increasingly converging and whose product life cycle is often measured in just months rather than years or decades, and specialized financial and communications networks of global reach, just to name a few.

Over the past approximately 25 years, key legal authorities (including the relevant regulatory agencies both in the United States and elsewhere around the world) have increasingly held the view that patent pools can promote efficiency in production and distribution, as well as facilitate risk-sharing. As a result, these groups have tended toward increasingly favoring a case-specific evaluation of such arrangements. By way of example, in the United States, the current enforcement approach is embodied in the 1995 Department of Justice (“DOJ”) and Federal Trade Commission (“FTC”) Antitrust Guidelines for the Licensing of Intellectual Property (“Guidelines”). The Guidelines document may be reviewed online at http://www.usdoj.gov/atr/public/guidelines/ipguide.htm, and is incorporated herein by this reference.

Three basic principles underlie the Guidelines. First, for the purpose of antitrust analysis, the Guidelines indicate that intellectual property should be viewed in essentially the same way as any other forms of tangible or intangible property. As such, the Guidelines expressly acknowledge that “an intellectual property owner's rights to exclude are similar to the rights enjoyed by owners of other forms of private property.”

Second, the Guidelines indicate that although an “intellectual property right confers the power to exclude with respect to the specific product, process or work in question, there will often be sufficient actual or potential close substitutes . . . to prevent the exercise of market power” (referring to the ability profitably to maintain prices above, or output below, competitive levels for a significant period of time). Accordingly, the Guidelines do not assume that a patent creates market power in the antitrust context.

And third, the Guidelines recognize that intellectual property “typically is one component among many in a production process and derives value from its combination with complementary factors, [ . . . including] other items of intellectual property.” As such, the Guidelines recognize that an owner of such rights may find it most efficient to contract with others for these factors; and that licensing which allows firms to combine complementary factors of production can lead to more efficient exploitation and be pro-competitive by virtue of helping to speed innovations to market and encouraging further innovation. Additionally, the Guidelines acknowledge that “[s]ometimes the use of one item of intellectual property requires access to another. An item of intellectual property ‘blocks’ another when the second cannot be practiced without using the first. For example, an improvement on a patented machine can be blocked by the patent on the machine. Licensing may promote the coordinated development of technologies that are in a blocking relationship.”

According to the Guidelines, the vast majority of licensing restrictions (all except naked price fixing, coordinated output restraints, market division agreements among horizontal competitors, as well as certain group boycotts and resale price maintenance that have no plausible efficiency rationales) are evaluated under the “antitrust rule of reason.” Under the rule of reason, enforcers ask first whether the licensing restraint is likely to have an adverse effect on competition; and if so, whether the restraint is reasonably necessary to achieve pro-competitive benefits or efficiencies that outweigh those adverse effects.

The Guidelines document also expressly discusses “[c]ross-licensing and pooling arrangements,” which it indicates “may provide pro-competitive benefits by integrating complementary technologies, reducing transaction costs, clearing blocking positions, and avoiding costly infringement litigation.” On this basis, the document concludes that by promoting the dissemination of technology, such arrangements are often pro-competitive. Additionally, the Guidelines document acknowledges that “[s]ettlements involving the cross-licensing of intellectual property rights can be an efficient means to avoid litigation;” and note that “in general, courts favor such settlements.”

At the same time, the Guidelines also recognize that patent pooling can have anti-competitive effects in certain circumstances. For instance, the document states that when such cross-licensing involves horizontal competitors, “the Agencies will consider whether the effect of the settlement is to diminish competition among entities that would have been actual or likely potential competitors in a relevant market in the absence of the cross-license [and, as a result, in] the absence of offsetting efficiencies, such settlements may be challenged as unlawful restraints of trade.”

The Guidelines document also indicates a “possible anti-competitive effect of pooling arrangements may occur if the arrangement deters or discourages participants from engaging in research and development, thus retarding innovation. For example, a pooling arrangement that requires members to grant licenses to each other for current and future technology at minimal cost may reduce the incentives of its members to engage in research and development because members of the pool have to share their successful research and development and each of the members can free ride on the accomplishments of other pool members.” Simultaneously, the document notes: “However, such an arrangement can have pro-competitive benefits, for example, by exploiting economies of scale and integrating complementary capabilities of the pool members, (including the clearing of blocking positions), and is likely to cause competitive problems only when the arrangement includes a large fraction of the potential research and development in an innovation market.”

The Justice Department has applied the Guidelines in considering and approving three patent pools. The results of its first review are presented in a Jun. 26, 1997, review letter (“1997 Review Letter”) affirming the pooling of video system patents by a group of [initially] nine firms including Fujitsu, Lucent Technologies, Matsushita Electric, Mitsubishi Electric, Philips Electronics and Sony Corporation. The 1997 Review Letter may be reviewed online at http://www.usdoj.gov/atr/public/busreview/1170.pdf, and is incorporated herein by reference.

The 1997 Review Letter sets forth five additional guidelines for assessing a patent pooling arrangement, including: (1) the patents in the pool must be valid and not expired; (2) although the aggregation of competitive technologies and setting a single price for them “would raise serious competitive concerns[,] [o]n the other hand, a combination of complementary intellectual property rights, especially ones that block the application for which they are jointly licensed, can be an efficient and pro-competitive method of disseminating those rights to would-be users;” (3) “limitation of the Portfolio to technically essential patents, as opposed to merely advantageous ones, helps ensure that the Portfolio patents are not competitive with each other and that the Portfolio license does not, by bundling in non-essential patents, foreclose competitive implementation options” and as a corollary thereof, the continuing role of an independent expert “to assess the essentiality of patents is an especially effective guarantor that the Portfolio patents are complements, not substitutes;” (4) the pool agreement must not disadvantage competitors in downstream product markets; and (5) the pool participants must not collude on prices outside the scope of the pool, e.g., on downstream products.

The 1997 Review Letter provides the foundation for MPEG LA (an acronym for “MPEG Licensing Agent”) to offer a package license on behalf of the intellectual property owners of a group of patents that are assessed by an independent expert as being “essential” to compliance with the MPEG-2 compression technology standard, and to distribute royalty income among such patent owners “pursuant to a pro-rata allocation based on each Licensor's proportionate share of the total number of Portfolio patents in the countries in which a particular royalty-bearing product is made or sold.” According to the 1997 Review Letter and subsequent industry publications, the approximately nine-year old MPEG-2 patent pool commenced with less than 30 patents owned by nine licensors, which were selected by the independent expert from over 8,000 submittals from more than 100 firms, and has grown to now include about 650 MPEG-2 essential patents owned by 24 licensors in 56 countries. According to trade publications, this substantial patent pool has attracted more than 800 licensees accounting for most MPEG-2 products in the current world market.

On the basis of the MPEG-2 precedent, and the aforementioned 1997 Ruling Letter, MPEG LA has organized and/or operates approximately half a dozen other pooling arrangements involving the owners of patents deemed to be “essential” to compliance with various technical standards. These include patent pools for the MPEG-4 visual standard and MPEG-4 systems standards; the IEEE 1394 high speed transfer digital interface; the DVB-T digital television broadcast standard employed in Europe, parts of Asia, Australia and New Zealand; and the AVC.264 audio-visual coding standard. In accordance with these same principles, MPEG LA is currently attempting to organize at least four additional patent pools comprising owners of “essential patents” for other key technology standards. These include proposed patent pools for the application of DRM (digital rights management) standards to electronic media distribution systems on computers, mobile and consumer electronics platforms; the SMPTE VC-1 video compression standard for television; the ATSC digital television standard; and the DVB-H digital handheld terminals broadcast standard.

MPEG LA also notes in multiple press releases issued during 2004 and 2005 that, “[i]n addition, MPEG LA actively seeks to adopt its alternative patent licensing model in other industries including biotech and pharmaceutical.” According to MPEG LA's site on the World Wide Web, which may be reviewed online at http://www.mpegla.com, “MPEG LA is the world leader in one-stop technology platform patent licenses, enabling users to acquire patent rights necessary for a particular technology standard or platform from multiple patent holders in a single transaction.” Thus, MPEG LA asserts that “[w]here-ever an independently administered one-stop patent license would provide a convenient marketplace alternative to assist users with implementation of their technology choices, the licensing model pioneered and employed by MPEG LA may provide a solution.”

Shortly after the 1997 Ruling Letter effectively laid the foundation for the patent pool approach taken by MPEG LA, in 1998, Sony, Philips and Pioneer disclosed having an interest in forming a patent pool to “assemble and offer a package license under the patents of Philips, Sony and Pioneer . . . that are ‘essential,’ . . . to manufacturing Digital Versatile Discs (DVDs) and players in compliance with the DVD-ROM and DVD-Video formats, and [to] distribute royalty income among [these firms].” Accordingly, they also sought and obtained a business review letter from the DOJ on their proposed patent pool arrangement (“1998 Ruling Letter”). The 1998 Ruling Letter, issued on Dec. 16, 1998, may be reviewed online at http://www.usdoj.gov/atr/public/busreview/2121.htm, and is incorporated herein by reference.

Approximately six months later, on Jun. 10, 1999, the DOJ issued a third opinion letter (“1999 Ruling Letter) in response to a request for business review of yet another patent pool proposed by Toshiba Corporation, Hitatchi, Matsushita, Mitsubishi, Time Warner and Victor Company of Japan for products manufactured in compliance with the DVD-ROM and DVD-Video formats. The 1999 Ruling Letter also may be reviewed online at http://www.usdoj.gov/atr/public/busreview/2485.htm, and is incorporated herein by reference.

As stated in the USPTO white paper, the 1998 and 1999 Ruling Letters tend to effectively “collapse” the guidelines enumerated within the 1997 Review Letter into “two overarching questions,” namely: (1) “whether the proposed licensing program is likely to integrate complementary patent rights,” and (2) “if so, whether the resulting competitive benefits are likely to be outweighed by competitive harm posed by other aspects of the program.”

In addition to MPEG LA and these specialized industry consortiums, several other firms either serve or propose to serve as intermediaries respecting patent pools addressing various technology standards. For example, according to the aforementioned IP Law article, “Via Licensing Corporation, a spin-off from Dolby Laboratories, Inc., has already issued patent calls for nine different pools . . . . Like MPEG LA, Via Licensing has focused largely on technology standards related to compression.” According to the Via Licensing site on the World Wide Web, which may be reviewed online at http://www.vialicensing.com, it too focuses exclusively on “standards based” patent pooling arrangements that incorporate “essential” patents to implementing such standard.

As the foregoing examples aptly illustrate, according to limitations of the present state of the art, in order to avoid concerns that the pool might restrain competition, patent pooling arrangements tend to impose a structural requirement that all of the patents in such pool be limited exclusively to “essential” patents. As those skilled in the art understand, the term “essential” in this context generally refers to valid patents that are technically essential—i.e., inevitably infringed by compliance with a mandated and/or de facto industry standard or specification—and those for which existing alternatives are economically unfeasible.

A variety of experts have urged key regulatory agencies—in the United States, the FTC and DOJ—to liberalize this restriction, thereby opening pooling to patents which are something less than essential in character. Given the limitations of the present state of the art, such recommendations inherently call into question the balance between competition, patent law and public policy, which examination persons of ordinary skill in the art will understand is the principal focus of the aforementioned 2003 FTC report and the testimony from the more than 300 panelists that it summarizes.

Shortly thereafter, in April 2004, the National Academies of Science (“NAS”) released a report, entitled “A Patent System for the 21st Century” (“2004 NAS study”), calling for significant changes in the U.S. patent system. A summary of the 2004 NAS study is available online at http://thefdp.org/STEP_Patent_Rpt.pdf; and the full report is available at http://books.nap.edu/catalog/10976.html, both of which are incorporated herein by reference.

An excellent summary of the 2003 FTC report and 2004 NAS study is provided in a 2004 paper authored by Dr. Carl Shapiro, the aforementioned author of Navigating the Patent Thicket. A copy of this analysis (“2004 Shapiro paper”) may be reviewed online at http://faculty.haas.berkeley.edu/shapiro/patentreform.pdf, and is incorporated herein by reference. In it, Dr. Shapiro characterizes the 2003 FTC report and 2004 NAS study as being very helpful in assembling evidence to support a call for patent reforms, but notes that “the problems with the patent system so many industry participants perceive do not primarily fit the picture often painted: absurd or obviously invalid patents being brandished by non-inventors who are exploiting the patent system to extract royalties from upstanding companies who are the true innovators.” Instead, the 2004 Shapiro paper suggests “there appears to be a much more subtle and deeper complex of problems, consisting of [nine] basic elements.”

Four of these nine elements focus principally on a number of proposed changes to USPTO examination resources, policies and procedures, and/or statutory changes respecting the threshold of obviousness and the appropriate burden for overcoming the presumption of patent validity. These and similar reform recommendations are still being debated in the Congress, by the affected agencies themselves, by the courts and by numerous interested parties.

This disclosure relates, among other things, to the other five elements cited by Dr. Shapiro in the 2004 Shapiro paper as being problems arising out of limitations in the present state of the art. These include: (1) “the [ ] presence of a very large number of patents that are likely to be invalid if actually tested in court;” (2) “the fear that many patents could be asserted against a given product, perhaps by a single entity holding a large portfolio of patents;” (3) “the danger that a company developing, designing, and even manufacturing a new product will be unaware of many patents which can then be asserted opportunistically against its products after it has made significant investments;” (4) “the danger that such an assertion can lead to an injunction, damages, and even treble damages in the case of willful infringement;” and (5) the “very expensive and time consuming litigation process involving unpredictable juries.”

There is also a need to find a way to overcome problems associated with attracting greater interest and participation in patent pools and to assure that such pools operate in a consistently pro-competitive manner. Quite clearly, there is a need even in patent pools involving only “essential” patents for an improved method of assuring that such pools are more pro-competitive and broadly inclusive. This is particularly true in fields which either don't lend themselves to industry standards or that aren't accustomed to such practices, and/or where gross disparities in market power may exist between the owners of essential patents (e.g., a small start-up company or independent inventor with little or no market share but an early priority date on a patented invention in a field that is dominated by major companies).

Additionally, there is a potentially even more significant need for accomplishing the foregoing described pro-competitive objectives in a manner that could supplant (or at a minimum render moot) the present requirement that such patent pool must include only essential patents in order to strike the proper balance under the antitrust rule of reason, as summarized above.

As Dr. Shapiro has warned, while patent pools may afford a pro-competitive solution, “antitrust law can potentially play [ ] a counterproductive role, especially since antitrust jurisprudence starts with a hostility towards cooperation among horizontal rivals. [ . . . ] Unfortunately, antitrust enforcement and antitrust law have a deep-rooted suspicion of cooperative activities involving direct competitors. But such cooperation, in one form or another, may be precisely what is needed to navigate the patent thicket. As a result, unless antitrust law and enforcement are quite sensitive to the problems posed by the patent thicket, they can have the perverse effect of slowing down the commercialization of new discoveries and ultimately retarding innovation, precisely the opposite of the intent of both the patent laws and the antitrust laws.”

### BRIEF SUMMARY OF THE INVENTION(S)

This invention relates to intellectual property licensing arrangements involving a plurality of patents or other intellectual property assets that may be licensed by or on behalf of the owner(s) to one or more entities, and in which a system and method is provided for assembling a portfolio of assets that are complementary in nature; negotiating royalties with prospective licensees who are users or prospective users of all or some portion of that complementary asset portfolio; and allocating among the owners of the assets comprising such portfolio the royalty revenue thereby earned in consideration of granting certain enumerated rights in, to and under those intellectual property assets, in whole or in part, to such one or more licensees.

It is contemplated that such licenses could, depending on the interests of each such licensee, (1) cover the development, offer, sale and/or use of licensee's existing products, systems and activities that in the absence of such license could infringe some or all of such rights; and/or (2) provide the licensee with the added flexibility to modify, enhance, revise, substitute or develop new products, systems and activities without infringement concerns, without need for and expense of devising workarounds to avoid infringing some or all of such rights, and without need to disclose trade secret and proprietary information, processes and systems.

In one embodiment of the present invention, among others, the system and method includes an algorithm that can be used to allocate such royalty earnings in a fair and unbiased manner among the owners of all of the patents having relevance to such licensee(s). In a preferred embodiment of the present invention, such algorithm also takes into consideration whether and the extent to which the application of such rights by each such licensee is highly material to their existing products, systems and activities or entirely peripheral in nature such as simply providing the licensee the flexibility to in the future modify, enhance, revise, substitute or develop new products, systems and activities without infringement concerns. Additionally, a preferred embodiment includes an optional system for resolution of disagreements, if any, as and when these occur among members of the patent pool concerning the proposed allocation of royalty revenue. In accordance with the principles and objectives of the invention, in one preferred embodiment of the invention, the foregoing algorithms go beyond simply analyzing the words of the patent; and take into account one or more other factors including analysis of the number, nature and timing of citations subsequently received by a patent (herein “forward citation analysis”), analysis of the number, nature and timing of prior art references cited during prosecution of the patent (herein “backward citation analysis”), explicit ratings by other patent owners within the same field, and optionally implicit ratings based upon the interaction of system users, in order to provide a fair and appropriate formula for allocating the royalties paid for such rights among the parties contributing to the collective portfolio of intellectual property rights in the patent pool.

Additionally, a preferred embodiment of the invention applies a variety of known network-based group collaboration technologies tailored to the specific requirements of patent licensing and management of intellectual property assets to make the process of licensing and fairly allocating the royalties among the owners thereof more intuitive, economical and efficient. Simultaneously, one preferred embodiment of the invention includes a system and method to avoid and/or minimize unnecessary patent litigation and make the outcome of such litigation—if ultimately pursued by any discontented party (whether they be a patent owner or an alleged infringer)—far more predictable. In a preferred embodiment, the application of such advances over the prior state of the art is shown in combination with indemnification from litigation exposure, thereby opening the prospect for traditional sorts of title coverage and related guarantees and assurances to be extended to the patent field. In another embodiment, such advances are shown in combination with access to capital markets, including investors such as hedge funds, as well as debt and equity sources interested in such investments but heretofore largely foreclosed by the inherent uncertainties involved. The foregoing advance is not only shown to be relevant to individuals and firms who are patent owners and thereby as a stimulus to greater invention, but additionally to those users of the patent pool as a way to reduce, quantify and contain financial exposure due to patent infringement liability, and to provide these firms with an incentive to innovate with a profit motive in mind rather than merely for defensive purposes.

Various preferred embodiments employ a variety of known Internet, intranet and other interactive technologies (collectively herein, “network-based technologies” or “network-based systems”) to effectively connect masses of people in synchronous, as well as coordinated asynchronous, interactions and communications focused on an issue of common interest—in this case to have their intellectual property ownership and/or usage treated fairly and to not be subject to being either “held up” or “ripped off” by unreasonable or unscrupulous patent owners or intellectual property users. In this regard, a preferred embodiment will encourage open and honest communications, fair and equitable outcomes, and will facilitate early dispute resolution through the complementary nature of the system components, workflow and corresponding information educed and applied in the process of the users' interactions within a preferred embodiment.

The foregoing objectives may be advanced in a preferred embodiment by separating the processes of characterizing prospective patents as “substitutes” (as herein-after defined) from the process of excluding patents from the patent pool, and the process of allocating royalties paid on the basis of the entire patent pool among the patents that comprise it from the negotiation of the value of a coherent portfolio of patents rather than any single asset or small group of assets in that portfolio, and then integrating these concepts in a series of recursive loops, preferably comprising:

| | |
|---|---|
| Negotiation | See, e.g., FIG. 2 (204, 207); |

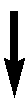

| | |
|---|---|
| Algorithm driven formulas | See, e.g., FIG. 2 (210(a), 213(a)); FIG. |
| | 3; FIG. 4 (401, 404); FIG. 5 (501, 505); |
| | FIG. 6A (605); and FIG. 7; |

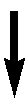

| | |
|---|---|
| One-on-one interaction | See, e.g., FIG. 2 (210(b), 213(b)); FIG. |
| | 4 (402-3, 405-6); FIG. 5 (502-4, 506-11); |
| | FIG. 6A (606-7); FIG. 6E and FIG. 6F |
| | (640); |

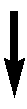

| | |
|---|---|
| Peer-to-peer polling | See, e.g., FIG. 2 (210(c), 213(c)); FIG. |
| | 4 (408-15); FIG. 5 (512-16); FIG. 6G, |
| | FIG. 6H and FIG. 6I; |

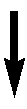

| | |
|---|---|
| Third-party arbitration | See, e.g., FIG. 2 (210(d), 213(d)); FIG. |
| | 4 (416-18); and FIG. 5 (517-19); |

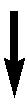

| | |
|---|---|
| Litigation | See, e.g., FIG. 2 (214-5); FIG. 5 (522-31) |
| | and FIG. 6 (605); |

and the corresponding automatic maintenance within the system of outcomes, contact and activity logs that may be used as reference materials in each subsequent process.

In this regard, the integration of the foregoing features in the manner described in one preferred embodiment of the invention is designed to achieve the favorable outcomes of the so called “prisoners' dilemma.” Accordingly, reference is hereby made to the description of the classical prisoners' dilemma at Principia Cybernetica Web, which description may be reviewed online at http://pespmcl.vub.ac.be/PRISDIL.html, and the related links therein, all of which are incorporated herein by this reference. Thus, it will be appreciated that the foregoing system and method will, in such a preferred embodiment, create a situation (i) wherein the parties are more likely to be rewarded as a result of being fair and cooperative, and the likelihood of loss is increased by being unfair and/or unreasonable; and (ii) wherein each of the parties recognizes this inherent quality from the outset.

In so doing, in a preferred embodiment, the system and method will help to decide “hits from duds” and bring about compliance with what is fair and justified in a way that neither an army of patent attorneys nor a legion of Federal District Court judges could ever hope to do under the present state of the art.

For purposes of summarizing the invention and the advantages achieved over the prior art, certain objects and advantages of the invention have been described herein. Of course, it is to be understood that it is not necessary that all such objects or advantages may be achieved in accordance with any particular embodiment of the invention. Thus, for example, those skilled in the art will recognize that the invention may be embodied or carried out in a manner that achieves or optimizes one advantage or a group of advantages as taught herein without necessarily achieving other objects or advantages as may be taught or suggested herein.

All of these embodiments and obvious variations thereof are intended to be within the scope of the invention herein disclosed. These and other embodiments of the present invention will become readily apparent to those skilled in the art from the following detailed description having reference to the attached figures, the invention not being limited to any particular preferred embodiment(s) disclosed.

### BRIEF DESCRIPTION OF THE DRAWINGS

FIG. 1 is a diagram that depicts a distributed digital data processing system environment of the type with which a preferred embodiment of the invention is practiced.

FIG. 2 is a block diagram depicting practice of the principles of this disclosure in a preferred embodiment of a system such as in FIG. 1.

FIG. 3 is a diagram illustrating a preferred manner of the system allocating royalties to the owners of the patents comprising a patent pool using the system of FIG. 1.

FIG. 4, consisting of parts 4A and 4B, is a diagram illustrating the process flow of an optional step for resolving disagreements, if any, among one or more members of a patent pool regarding allocation of royalties to the owners of the patents comprising that pool using one preferred embodiment of the system of FIG. 1.

FIG. 5, consisting of parts 5A and 5B, is a diagram illustrating the process flow of another optional step relating to using the system of FIG. 1 to remove from the license grant (and corresponding royalty payment obligation) any one or more patents that a licensee believes are substitutes, as well as for resolving disagreements, if any, arising out of such action.

FIG. 6, consisting of parts 6A through 6I, is a series of illustrations showing a preferred embodiment of portions of a graphical user interface that may be used to carry out the process of this disclosure to conduct the types of communications that may be entailed in connection with practicing the optional workflows described in FIGS. 4 and 5.

FIG. 7 is a diagram illustrating the process flow of an additional optional step for incorporating information acquired in practicing the workflows described in FIGS. 3, 4 and 5 (and optionally information educed through employing the interface described in FIG. 6) to enhance the reliability of patent ranking factors.

### SPECIALLY DEFINED TERMS

Numerous Federal Circuit decisions have held that by placing persons of ordinary skill in the art on notice of his or her intention to do so, a patentee may act as his or her own lexicographer with respect to the meaning of a term or terms. This section is incorporated into the specification in order to expressly provide this notice and sets forth the following specialized and/or expanded meanings for the following terms, when and as used herein:

The term “patent pool” is generally understood to refer to an arrangement in which two or more patent owners agree to hold their individual patents collectively. The agreement (or agreements) concluded by and between these patent owners generally defines the terms upon which members of the pool and third parties may utilize the technologies covered by the pool, as well as the manner in which the patent owners will share in royalties earned from such activity.

Although persons skilled in the art may use a variety of terms to describe this practice based on specific circumstances, for the purposes hereof, the term “patent pool” is intended to be used in its broadest possible sense, including any portfolio or aggregation of a plurality of intellectual property rights that are or may be the subject of licensing, irrespective of whether such rights are transferred directly by the patentee(s) to one or more licensee(s) or through an intermediate party or parties who may, for example, acquire such rights by any means, including assignment, license, joint venture or representation agreement, and thereafter act as a licensor, sub-licensor or licensing agent in granting rights to third-parties respecting all or any portion of such intellectual property rights. Additionally, based on the intention that such term be interpreted in the broadest reasonable manner consistent with the instant invention, for the purposes hereof, the term “patent pool” is deemed to include all other related commercial arrangements including but not limited to package licenses, blanket licenses, bilateral or multilateral licenses, cross-licenses, cooperatives, collective rights organizations (CROs), mega-pools, common property rights institutions (CPRs), clearinghouses and the like.

The word “substitute” is generally understood to mean a person or thing acting or used in place of another. For the purposes hereof, the terms “substitute,” “substitutes,” “substitute patent” and “substitute patents” are used interchangeably as the context dictates and intended to be given the broadest reasonable construction in accordance with the ordinary and customary meaning of the word “substitute” plus the special meaning of such term, as set forth herein. By way of example, but not limitation, a “substitute patent” includes any patent for which a licensee believes there to be an alternative or competing patented technology, including perhaps one that the prospective licensee already owns or that it has already licensed or intends to license (either through the patent pool or independently), or concerning which a non-infringing alternative exists in the public domain (e.g., as a consequence of adopting the practice taught by an already expired patent or employing the teachings of a publication that shows all of the elements of the patented invention, etc).

Persons of ordinary skill in the art will understand that there are numerous other legitimate reasons that a prospective licensee may wish to forego licensing one or more patents (alone or as part of a patent pool), including a belief that a patent is invalid, unenforceable or non-infringed. By way of example, but not limitation, persons of ordinary skill will appreciate that although patents are entitled to a presumption of validity, this is a refutable presumption (in accordance with a related burden of proof) and thus, if these beliefs concerning invalidity, unenforceability or non-infringement are vindicated, a prospective licensee would not (and should not) be under any requirement or compulsion to pay anything for the use of that patent(s). In accordance with the objects and features of the invention, one of the purposes of the invention is to assure that a licensee is not coerced into licensing a patent that is invalid, unenforceable or not infringed. Thus, for the purposes of practicing one or more preferred embodiments of the invention, all of these additional justifications for declining to license a patent (e.g., the belief that the patent may be invalid, unenforceable and/or non-infringed by a prospective licensee) are expressly included within the meaning of the terms “substitute,” “substitutes,” “substitute patent” and “substitute patents,” as used herein.

The foregoing notwithstanding, it will be understood that a prospective licensee may also legitimately believe a patent is a substitute at the time he is considering negotiating a license (for example, he may reasonably believe there to be no issue of past or current infringement thereof), but the prospective licensee may nevertheless voluntarily wish to obtain a license on such patent(s) for legitimate business reasons. By way of example, but not limitation, a prospective licensee may voluntarily desire to obtain a license on the patent(s) for the sake of assuring himself the freedom and flexibility to practice such patented subject matter in the future, including the prospect of making improvements to existing processes, systems, devices and/or practices without any infringement concerns, without the need for and expense of developing workarounds to avoid such patent(s), and without the risk of needing to disclose trade secret and/or proprietary information in order to defend against an assertion of infringement by the owner(s) of such patent(s).

As persons of ordinary skill in the art will also readily appreciate, these sorts of motivations (and a number of other practical considerations of this sort) represent common, legitimate commercial considerations that any prospective licensee takes into account when considering a license on intellectual property (irrespective of whether the offer is made on a stand alone basis or through a patent pool). Accordingly, for the purposes hereof, once a determination is voluntarily made by a prospective licensee that it could be advantageous for whatever reason that he, she or it obtain a license on such patent(s), whether alone or as part of a patent pool, such patent is no longer considered to be a “substitute” (or “substitute patent”) as it pertains to that prospective licensee.

While the terms and expressions employed herein are described in the context of the patent and anti-trust laws of the United States, there is no intent to exclude other asset classes and/or countries; and on the contrary, the herein described improved system and method of licensing is intended to be employed with any variety of asset classes, including all intellectual property rights, internationally as well as in the U.S.

Except as expressly set forth above, all other terms used herein are intended to be construed consistently with their ordinary and customary meanings to those persons of ordinary skill in the art as of the filing date hereof.

### DETAILED DESCRIPTION

A well-ordered system and method of licensing intellectual property assets will enable and encourage the integration of complementary technologies in pro-competitive pooling arrangements that will reduce problems created by patent thickets and stacked royalties and will simultaneously provide for the requisite protections against anti-competitive practices to overcome the aforementioned concerns that antitrust law not inadvertently play a counterproductive role. Thus, in one preferred embodiment, the system and method disclosed herein will reduce the anti-competitive risks of patent pooling arrangements in a new way—a way that will permit patent pools to be comprised of complementary patented technologies that are desirable to license as a package, irrespective of whether such patents are essential. Although this is merely a preferred embodiment (and therefore not required in some other embodiments), the reason that incorporating some or all of the optional features is so desirable for navigating the patent thicket and overcoming the hold-up and royalty-stacking problems of the existing state of the art is that many of the patents creating such over-lapping rights, and by definition all of the patents creating the perceived hold-up problems, are the patents whose owners claim them to be essential but which prospective licensees contend are not essential.

Accordingly, the way in which a preferred embodiment addresses the problems arising out of these [questionably] essential patents is to include them in the system and method. Stated in a different way, excluding these [arguably] non-essential patents—whether by system design or by administrative dictate—has the effect of rendering such system and method less capable of resolving the problems these patents (and the maladaptive ways in which companies have heretofore sought to address them) are creating in the present state of the art. Thus, in order to include these patents and still avoid anti-competitive risks, other optional mechanisms of such preferred embodiments are included in order to achieve a proper balance under the aforementioned antitrust rule of reason.

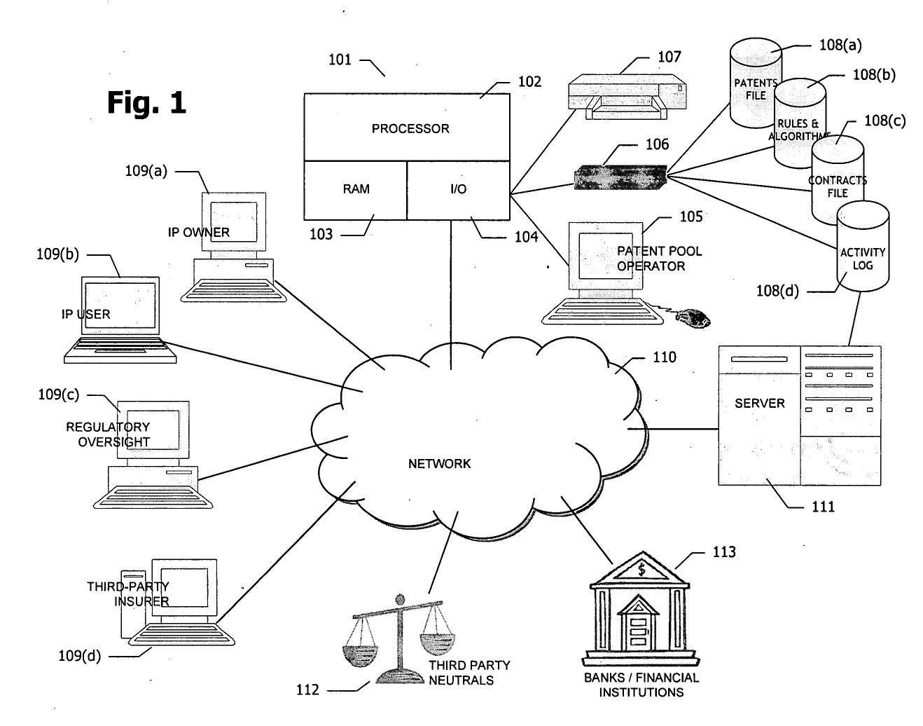

Now turning to the drawings, and more particularly to FIG. 1 thereof, it will be observed that it depicts the primary components of a preferred system in accordance with the principles of the invention. Depicted therein are a digital data processor 101, including a processor section 102, a random access memory section 103 and an input/output control section 104. Digital data processor 101 is connected via input/output control section 104, to workstation 105 (including a monitor, keyboard and pointing device), one or more drives or alternative storage media 106 for storage of software and data, and printer 107. As shown, the software and data maintained on storage media 106 preferably includes a patents database file 108(a), rules and algorithms 108(b), contracts files 108(c) and system activity log 108(d).

As depicted, digital data processor 101, as well as its sub-components 102-104, peripherals 105-107, and related databases and/or software 108(a), 108(b), 108(c) and 108(d), comprise the system managed and maintained by a patent pool operator. The patent pool operator's computer, along with other computers 109(a), 109(b), 109(c) and 109(d) may be interconnected via network 110 to file server 111. As depicted, computer 109(a) comprises a representative workstation employed by an intellectual property owner; and computer 109(b) is illustrative of a representative workstation employed by an intellectual property user (i.e., licensee or prospective licensee) of some or all assets in the patent pool. Although it is considered likely that a number of intellectual property owners employing the system will also be licensees and may employ a single computer workstation, these individuals are nonetheless depicted separately in FIG. 1 solely for the purposes of illustrating the invention.

Computer 109(c) depicts a workstation maintained by a regulatory agency for oversight purposes, if desired; and computer 109(d) illustrates a representative workstation employed by one or more third-party insurers, such as insurance underwriters, title insurance analysts and the like. Digital data processor 101, as well as its sub-components 102-104 and peripherals 105-107, preferably comprise a conventional commercially available personal computer or workstation adapted in accord with the teachings below for storing, accessing and processing data bases, rules and algorithms 108(a)-108(d). Computers 109(a)-109(d) and file server 111 also comprise conventional commercially available components of their respective types. Network 110 may be, as a non-limiting example, the Internet or any alternative public and/or proprietary networks. Computers 109(a)-109(d) can likewise be adapted in accordance with the teachings below for viewing a browser for accessing a patent management program and interacting with other system users and the patent pool operator according to a system clock and rules database.

FIG. 1 also illustrates optional interconnections with third-party neutrals, such as arbitrators and/or judicial system 112, as required, as well as banking and financial institutions 113. Those skilled in the art will appreciate that, in addition to implementation on stand-alone or “networked” computers of the type shown in FIG. 1, the system and methods and taught herein can be implemented on other digital data processing apparatus of the type known in the art (e.g., mainframe computers, network computers, dedicated microprocessor-based systems, handheld wireless devices and other network-system devices etc.)

As will be perceived by those skilled in the art, pertinent components needed for implementation of the system will vary corresponding to certain optional features, and the components identified in FIG. 1 are set forth for illustrative purposes and are not intended to suggest that all of such components and/or data are required in every instance in order to implement the principles hereof. For example, some of the parties for whom computer workstations and/or network connections are indicated in FIG. 1 will be utilized in various preferred embodiments, and thus the computers and connections to these additional entities identified in FIG. 1 are set forth of illustrative purposes and are not intended to suggest that all of such workstations and connections are required in every instance in order to implement the principles hereof Similarly, activity log 108(d) is optional and utilized in certain preferred embodiments. Thus, although all of the elements of the system shown in FIG. 1 are not necessarily utilized in order to practice the principles of the invention and thus some of them are optional, it is deemed apparent that each of the elements illustrated are attractive and add to the usefulness of the overall system.

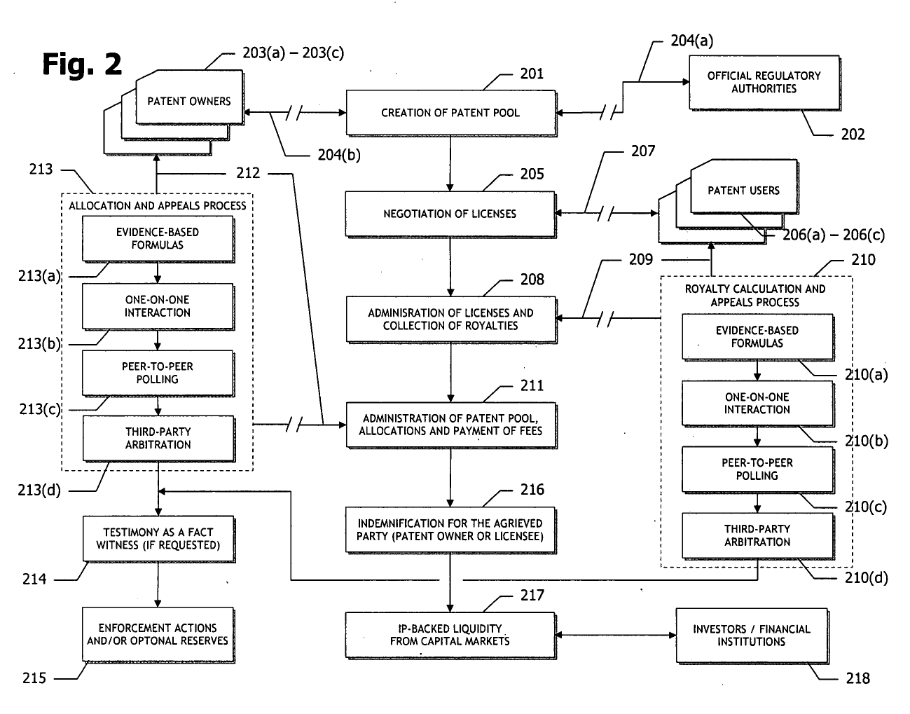

Now turning to FIG. 2, it will be observed that a flow diagram is provided, which depicts practice of the principles hereof suitable for implementation in the system identified in FIG. 1. In this regard, it will be observed that the first element thereof is rectangular box 201, entitled “Creation of Patent Pool.” As is well known to those skilled in the art, this step necessarily involves an assessment of the likely needs and objectives of patent owners 203(a)-203(c) as well as prospective licensees 206(a)-206(c), who are generally users or potential users of the technology covered by patents owned and/or controlled by these patent owners, all within a context of applicable regulatory guidelines, consisting of applicable statutory and administrative rules as interpreted by official regulatory authorities 202.

To the extent the patent pool is intended to conduct business in the United States and depending upon the nature of such anticipated patent pool, it may be advisable in this non-limiting example for the proponent(s) thereof to request a business review letter pursuant to the DOJ's Business Review Procedure, 28 C.F.R. § 50.6. Persons who are knowledgeable in the field will understand that such a business review letter expresses a statement of the DOJ's antitrust enforcement intentions based upon the representations made to the Department respecting the proposed arrangement.

At this point, it is contemplated that information describing the nature of the proposed patent pool and various supporting data may be provided to the regulatory agency and a series of meetings and exchanges (including letters and documents sent by mail and facsimile transmission, email messages, face-to-face and telephonic communications, etc.) may take place to discuss them. These contacts are illustrated by link 204(a), which indicates such periodic direct intercommunications between the patent pool operator and the official regulatory authorities.

As noted above, one optional feature of the system contemplates that the regulatory authorities may condition approval of the patent pool on having the ability to oversee (directly or through an independent agent hired for this purpose) all or a periodic sampling of the interactions that take place by and among the pool participants using the system. It will be understood that such oversight may be desirable or, in some governmental jurisdictions, may be required in order to assure that such interactions between such system users—many of whom are likely to be horizontal competitors—do not in any way constitute an effort by them to unlawfully use the system to engage in price fixing (including among other things against one or more intellectual property users), coordinating output, division of markets, group boycotts (including among other things against a particular patent owner, down-stream user or competitor who is not a participant in the patent pool), resale price maintenance or any other communications that would have an adverse effect on competition. To the extent this optional feature is incorporated, it will be understood that link 204(a) may integrate such regulatory oversight function as illustrated by the communication link between the network 110 and regulatory computer workstation 109(c) of FIG. 1.

Although it is unlikely that the official agreement(s) forming the patent pool and through which each of the patent owners agrees to participate therein should or will be consummated prior to having an acceptable level of comfort concerning the enforcement intentions of the appropriate regulatory authorities 202, persons of ordinary skill in the art will understand that creation of the patent pool 201 may also entail concluding one or more agreements with and/or among patent owners 203(a)-203(c) to license their patents jointly through a common patent pool and setting forth the business terms of such license including authorized fields of use, the manner of calculating and allocating royalties, and procedures for adding patents to, and deleting patents from, the patent pool.

Additionally, such agreement(s) may authorize the patent operator to take all actions reasonably necessary to research potential users of such rights and to commence, conduct, negotiate and conclude licensing agreements on behalf of the portfolio of patents with the users and/or prospective users of such patent pool in whole or relevant part. The agreement(s) may also set forth the patent pool operator's rights and obligations for collecting and distributing royalty income, and may optionally authorize the patent pool operator to initiate, prosecute and ultimately resolve enforcement actions against one or more parties reasonably believed to infringe some portion or all of such patents, submit timely fact testimony if and as requested in the event litigation ensues involving a patent in the patent pool and/or an intellectual property user who is a licensee of the patent pool, as well as to terminate and enforce the terms of licenses concluded with third-parties, as appropriate. Further, it is contemplated that in a preferred embodiment of the system, the agreement(s) may enumerate certain rights, expectations and responsibilities of such patent owners in respect to resolving differences of opinion concerning the fair and reasonable allocations of royalty income and the characterization of one or more patents as substitutes, as more particularly described below.

Without limitation, one preferred embodiment contemplates that the patent pool operator may serve as an agent on behalf of the patent owners and periodically be appointed by the owners to carry-out some portion or all of the foregoing duties. In this case, the agreement(s) may additionally set forth the compensation to be paid (such as on a flat fee basis or as a percentage of the royalties earned) to the patent pool operator for each of the functions he, she or it performs on behalf of the patent owners. An alternative embodiment of the system contemplates that the patent pool operator may negotiate with each patent owner a non-exclusive (or in some cases, although not preferred, an exclusive) license in and to the patent(s), such license providing an express right for the licensee thereof to, in turn, conclude non-exclusive sublicenses with third-parties, each such sublicense being without the right of further sub-licensing, and setting forth a formula, as applicable, for allocating future income from sub-licensing, if any, to and among the patent owners. And yet a third alternative embodiment of the system contemplates that the patent pool operator may acquire through purchase and assignment all of the rights, title and interest in and to at least some of the patents comprising the patent pool.

As will be apparent to those persons of ordinary skill in the art, the business terms of such arrangements may differ depending, among other things, on negotiations 204(b) by and between the patent pool operator and patent owners 203(a)-203(c). It is also deemed to be apparent that depending on the needs, interests and financial condition of the patent pool operator and various patent owners, all of these alternative structures may be used in varying degrees when forming a patent pool, and as a result the share of future revenues from sublicensing to which the patent pool operator shall earn may range from zero (in the case the operator may be compensated on a fee basis) to a significant percentage of future royalty income, which is preferably net of the actual costs of administering the patent pool and carrying out the responsibilities thereof.

To the extent that the patent pool contemplates limiting admission to only “essential patents” for a specific industry standard or expressly defined purpose, it is widely accepted that the patent pool operator should broadly solicit submissions of potentially applicable patents from all patent owners; that an independent patent expert who is familiar with both the applicable standard and/or purpose and the relevant technology will be engaged to review any such submissions; and that all patent owners who are identified as having an essential patent will be afforded the right to be included in the joint licensing program.

In a preferred embodiment, the patent pool might not be limited to only “essential patents.” Indeed, while there may be sound commercial reasons to limit a patent pool exclusively to essential patents, this would preferably not be done merely in order to ensure that such patent pool remains sufficiently pro-competitive under the antitrust rule of reason so as to avoid being objectionable to official regulatory authorities 202. Rather, as discussed herein, this role of satisfying such regulatory authorities 202 that the patent pool contains sufficient protections against anti-competitive risks so as to remain pro-competitive could be performed by various optional features of a preferred embodiment. Thereby freed of this limitation through the use of such optional features of the system and method, the patent pool could be structured to include a portfolio of those patents—essential and not—that the patent operator perceives may have the highest likelihood of satisfying the commercial needs and interests of its principal stakeholders (e.g., the patent owners and patent users, respectively).

Thus, once satisfied of the likely enforcement posture of official regulatory authorities 202, the patent pool operator or other organizer may preferably identify the patents and any pending patent applications that exceed a minimum threshold level of relevance to a particular industry or field or use, and contact all of such patent owners, affording each of them the right (preferably on a non-discriminatory basis) to be included in the patent pool and corresponding intended joint licensing program. In this regard, persons of ordinary skill in the art will be aware that there exist a variety of proprietary as well as non-proprietary analysis tools that have been proposed and/or that are presently available for identifying patents with relevance to a particular subject area and the owners thereof. Without limitation, two examples of techniques that may be useful to practicing this aspect of the system and method, and by which to identify patents and their corresponding owners for potential inclusion in the patent pool are U.S. Pat. No. 6,879,990 to Stephen Boyer and Alex Miller, which is entitled “System for Identifying Potential Licensees of a Source Patent Portfolio” ('990 patent); and the latent semantic analysis technique taught in the aforementioned '966 patent.

The method taught in the '966 patent is reportedly utilized in PatentCafe's so called ICO™ Suite, which is available through the PatentCafe web site at http://www.iamcafe.com/, which Web site is included herein by this reference. There, in return for a nominal fee, users may purchase a computer-generated analysis known as the “Patent Factor™ Indices” report, and which includes a section listing the “100 most relevant patents” that were used in generating the analysis, as well as a separate section listing the “most relevant unassigned patents.”

Communications link 204(b) illustrates the series of contacts, solicitations, communications, meetings, exchanges and negotiations (including in the form of documents and letters sent by mail and facsimile transmission, email messages, face-to-face and telephonic communications, etc.) that may be used in order to contact, interest, negotiate and ultimately consummate the participation agreement(s) with patent owners 203(a)-203(c).

Rectangular box 205 and link 207 illustrate the negotiation of licenses by the patent pool operator with various patent users or prospective users 206(a)-206(c). Persons of ordinary skill in the art will understand that such negotiations may take a wide variety of forms involving oral and written communications including by mail, email, telephone, facsimile and in face-to-face meetings, and employ a wide variety of more or less sophisticated methods to ascertain a fair and appropriate royalty. A number of books and articles have been written on the subject of valuing intellectual property and developing a reasonable royalty and corresponding licensing program. Three examples that may provide an useful background in practicing this part of the system and method are Technology Management: Developing and Implementing Effective Licensing Programs, Robert C. Megantz (John Wiley & Sons, 2002); “An Historical Look at Patent Infringement Damage Awards,” Julie L. Davis and Allison C. Moran, Intellectual Property Infringement Damages: 1995 Cumulative Supplement, published by Arthur Anderson LLP; and “Tiger by the Tail,” Niels Reimers, CHEMTECH, August 1987, 17 (8), pp. 464-471. Reprinted in 1995: The Journal of the Association of University Technology Managers, Volume VII.

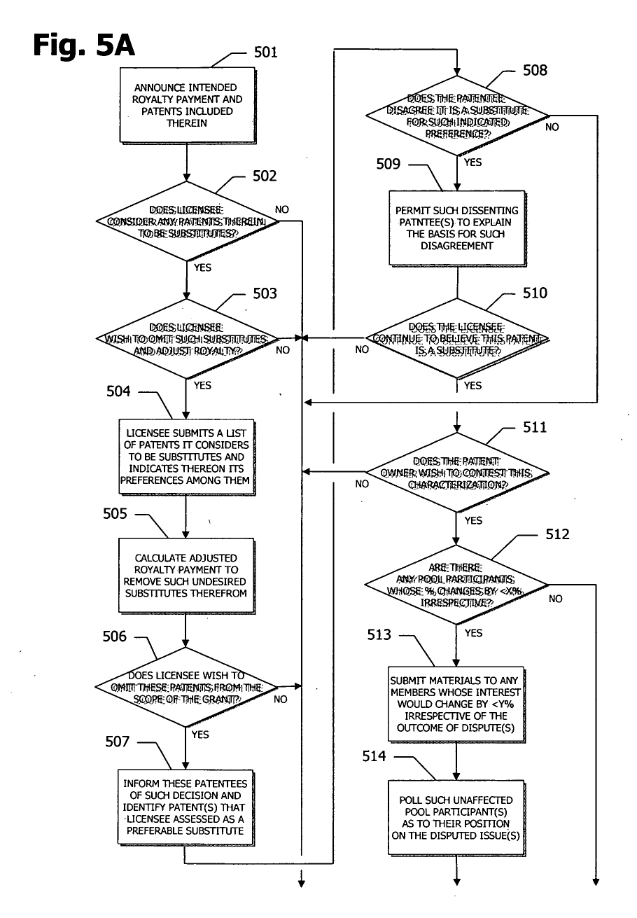

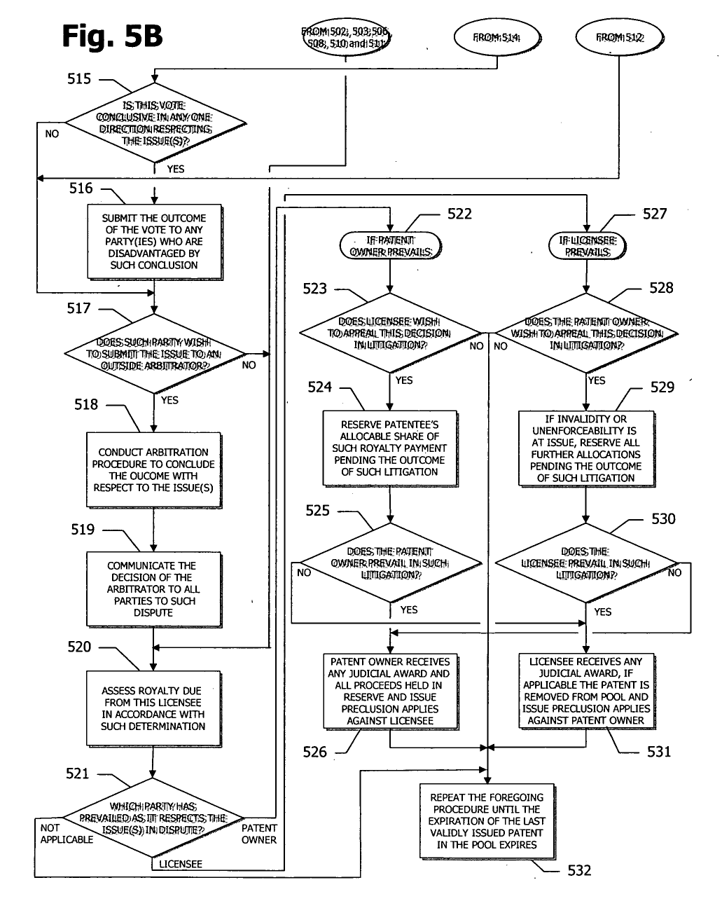

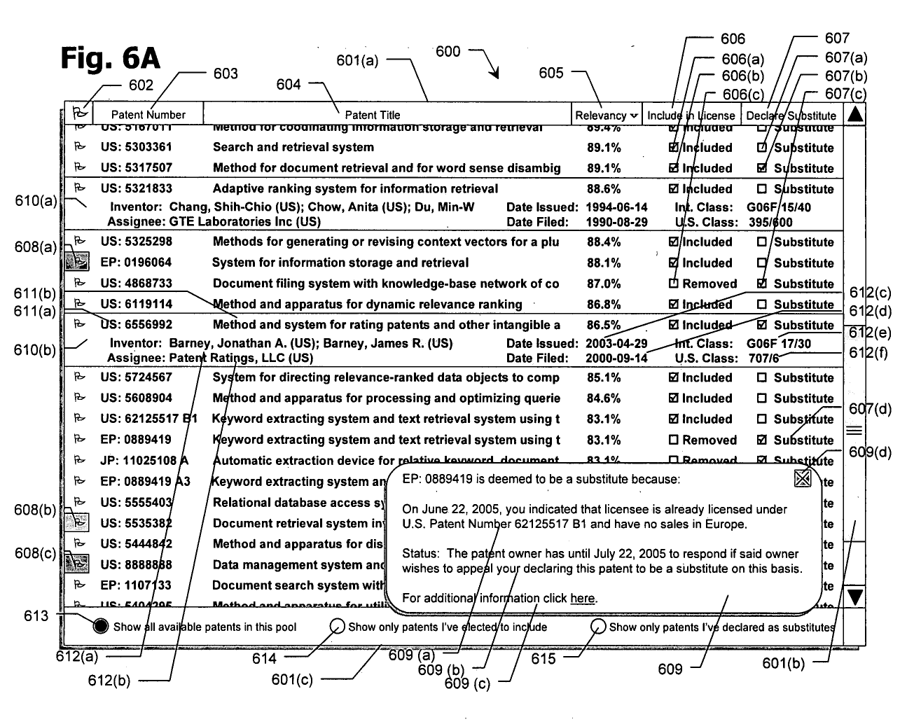

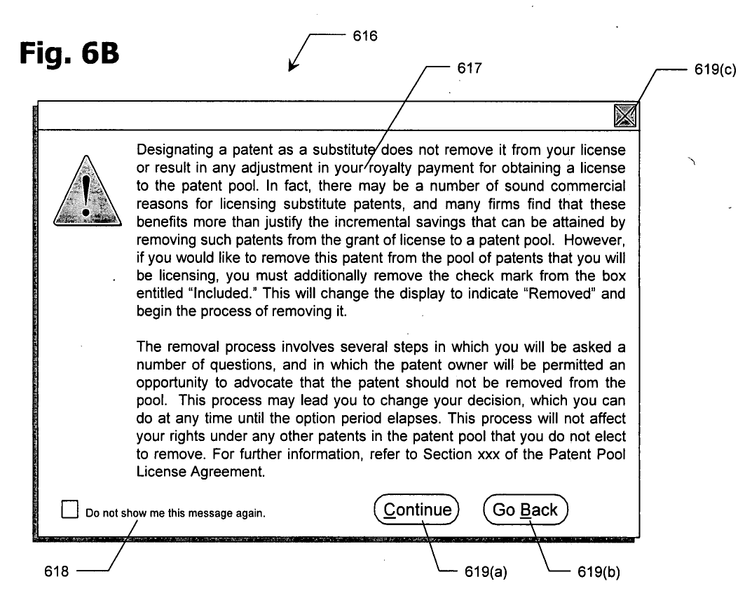

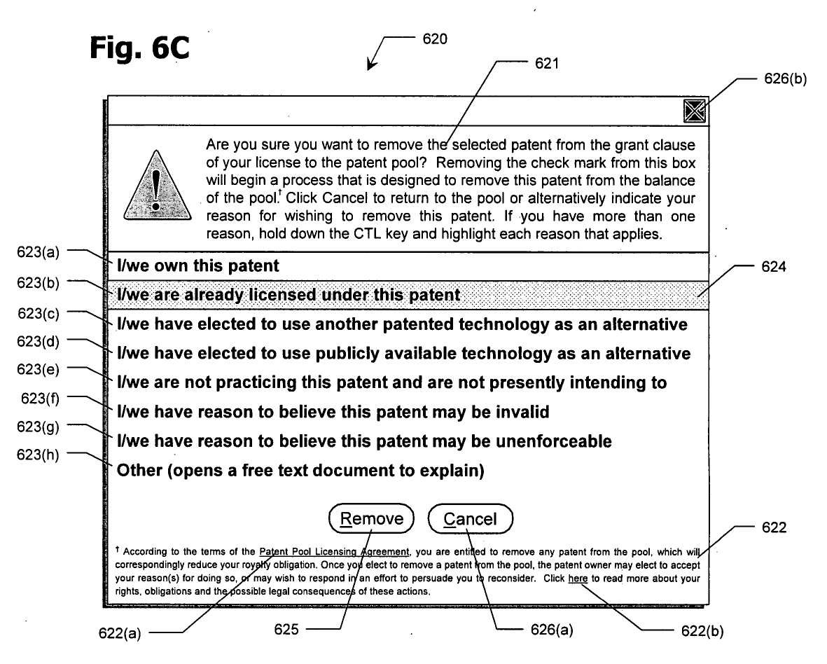

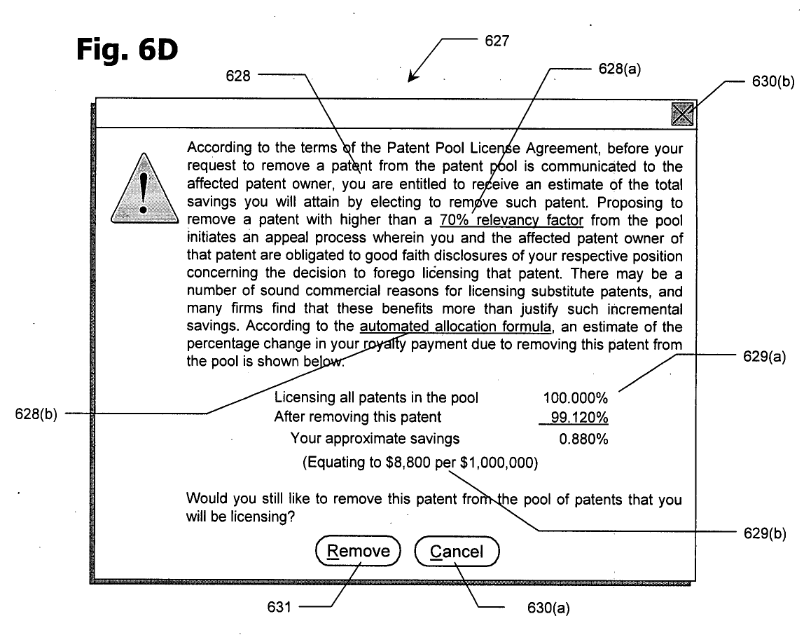

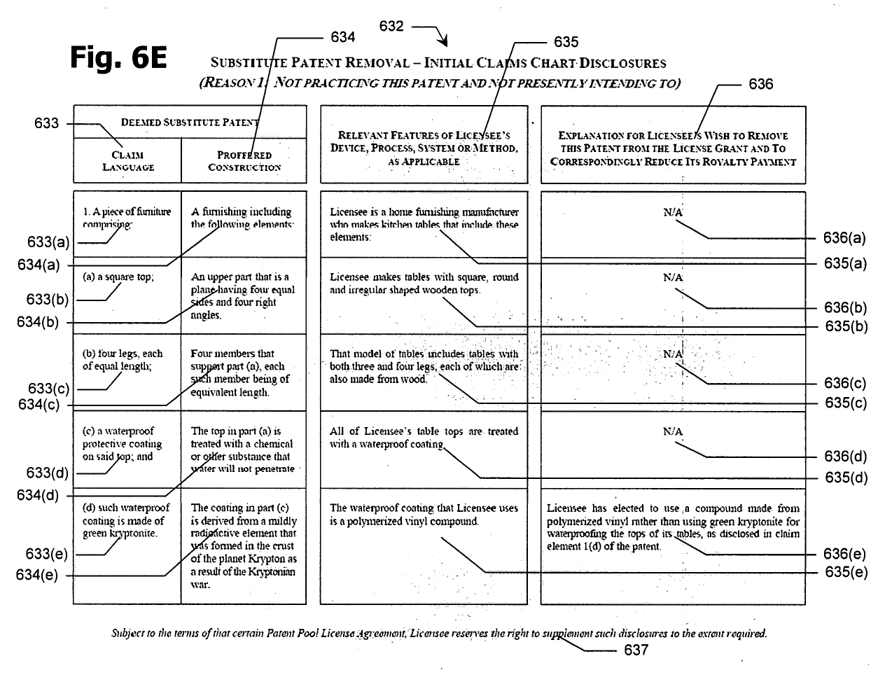

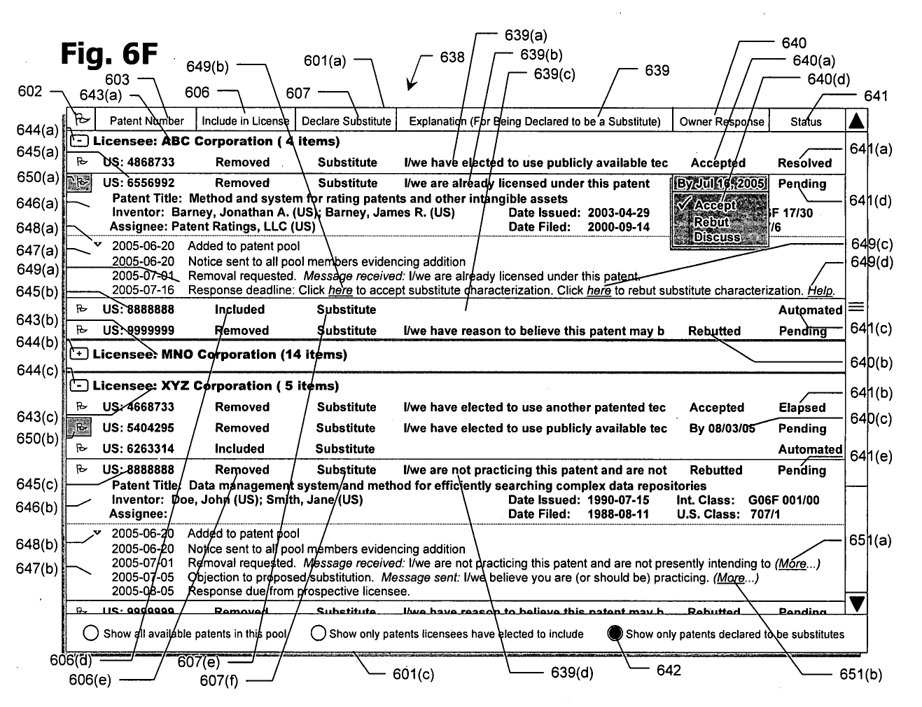

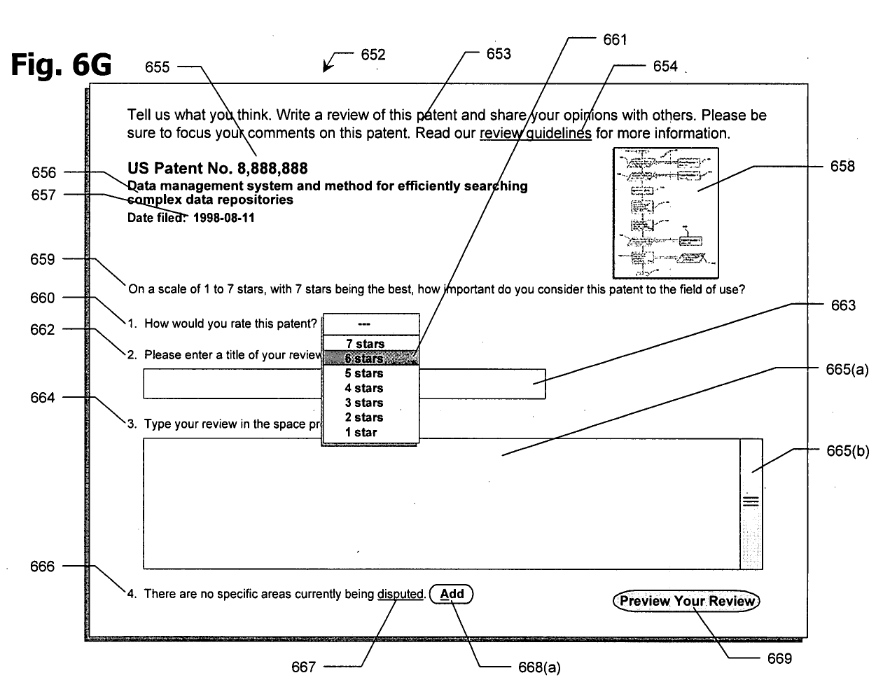

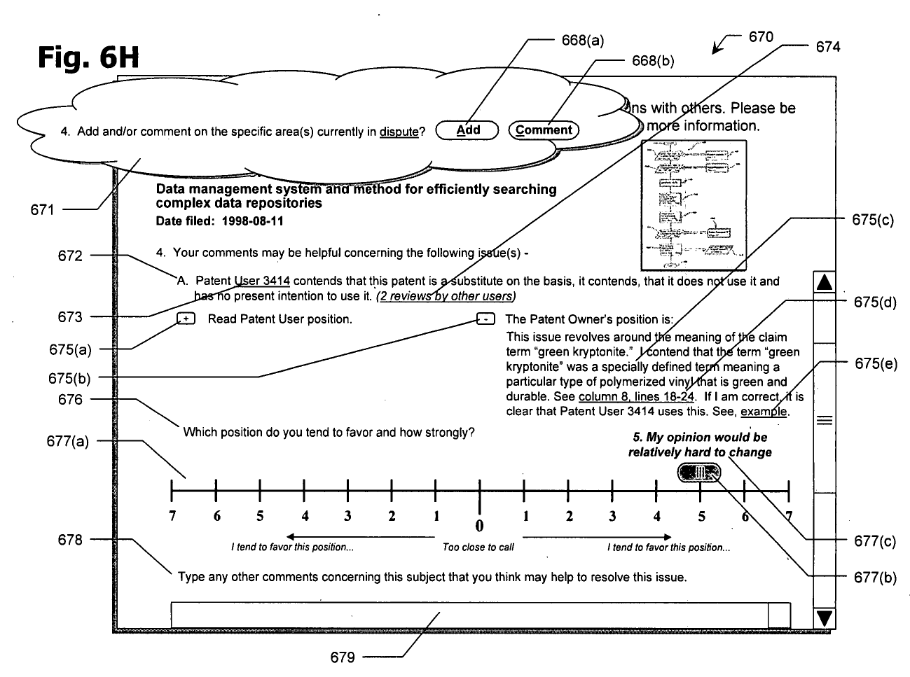

In a preferred embodiment of the system and method, a royalty may be assessed quarterly on the basis of usage in accordance with a negotiated royalty rate that takes into account all of the intellectual property assets within the portfolio rather than any single asset contained therein. Then, as described with regard to FIGS. 5 and 6, below, in one preferred embodiment of the invention, the licensee may be permitted for a limited period of time to remove from the grant of license to the patent pool any patents that it deems to be a substitute and the licensee may receive a corresponding reduction in the aggregate royalty based on the assessed value of that or those patent(s) to the total portfolio. The negotiation contemplated by rectangular box 205 will, in a preferred embodiment, additionally entail explaining the corresponding features of the system for managing such intellectual property assets including among other things the applicable rules and algorithms 108(b), as well as a licensee's rights and responsibilities attendant thereto. All of these rights and responsibilities will preferably be codified in a standard license agreement and system users' manual.

Although other methods of fairly valuing these assets and assessing such collective value through a royalty or other form of payment may be employed without departing from the principles of this disclosure, the foregoing method has several features, which are set forth below.

First, by dividing the task of valuing the entire portfolio from the step of removing substitutes, it focuses all of the users on the value of the intellectual properties within the patent pool that each user affirmatively desires to license, and then as a separate matter the benefits (and incremental cost) of removing substitute patents and potential blocking patents from the patent pool to tailor the portfolio to the licensee's particular needs, interests, budget, risk tolerances and preferences.

Second, charging for this value in the form of a running royalty based on the level of use has the advantage of making licensing costs nominal for small and newly-formed companies, and thereby provides these licensees with great value by providing them ready access to a portfolio of intellectual properties that is likely to represent key blocking patents. In turn, this may help assure a start-up company freedom to innovate without fear of intimidation by a more established competitor or inadvertently infringing on any of a substantial number of existing patented rights that have yet to expire and the related liability exposure this represents (such as described above by Mr. Greenhall).

Simultaneously, for larger and more established competitors, the cost may continue to vary with size, but is also far more likely to be offset by the allocation of royalty income earned by such established competitors from intellectual property assets that they contribute to the patent pool. Thus, larger firms with a substantial history of industry leadership may be rewarded for past innovations and provided a financial incentive to continue innovating in order to maintain or perhaps increase their share of aggregate royalties over time. Moreover, since these large firms have traditionally been the favored targets for high-priced (often contingency-fee based) patent infringement litigation and attempted hold-ups, as more fully described below, these firms stand to reduce their exposure from frivolous litigation while benefiting through avoiding stacked royalties and assuring freedom to migrate their business to a promising new area to the extent that a start-up firm's technology subsequently moves from the fringe into market prominence.

Although concerns have been voiced that “granting of licenses to future patents will reduce each company's incentive to innovate because its rival will be able to imitate its improvements,” Dr. Shapiro's research concerning the effect of cross-licensing suggests just the opposite from a practical perspective. He states: “While correct in theory, it is clear, at least in the case of semiconductors and no doubt more widely, that this concern is dwarfed by the benefits arising when each firm enjoys enhanced design freedom by virtue of its access to the other firm's patent portfolio. There is little doubt that [such] broad cross licenses permit the more efficient use of [technical personnel], better products, and faster product-design cycles. In other words, when IBM and Intel sign a forward-looking cross license, each is enabled to innovate more quickly and more effectively without fear that the other will hold it up by asserting a patent that it has unintentionally infringed. And neither firm is really all that worried that the other will actually copy its products just because the other has a license to most of its patents. Of course, the impressive rate of innovation in the semiconductor industry in the presence of a web of such cross-licenses offers direct empirical support for the view that these cross-licenses promote rather than stifle innovation.”

A third reason that a running royalty method of this kind is preferred is that by virtue of being (or at least being available to be) a portfolio that includes all or substantially all of the intellectual property rights above a minimum threshold level of relevancy for a given field of use, the cumulative effect of the aggregation of negative rights represented by the patent pool assets may tend to become a positive right to practice within that field. Several scholars have confirmed the benefits of this approach, writing in a 2004 paper entitled “Patent Portfolios”: “We find that for patents, the whole is greater than the sum of its parts: the true value of patents lies not in their individual worth, but in their aggregation into a collection of related patents, a patent portfolio. The benefits of patent portfolios are of such significance, we show, as to reveal that firms' patenting decisions are essentially unrelated to the expected value of individual patents. Rational firms will, therefore, typically seek to obtain a large quantity of related patents, rather than evaluating their actual worth. [ . . . ] [This] theory directly engages with the empirical and commercial realities of the modern patent system. Again, the real value of patents inheres not in some individuated utility, but rather in their aggregation in a portfolio of related patents.” A copy of this article (“Portfolio analysis article”) may be reviewed online at http://www.temple.edu/lawschool/dpost/PTW/Parchomovsky.pdf, and is incorporated herein by reference.

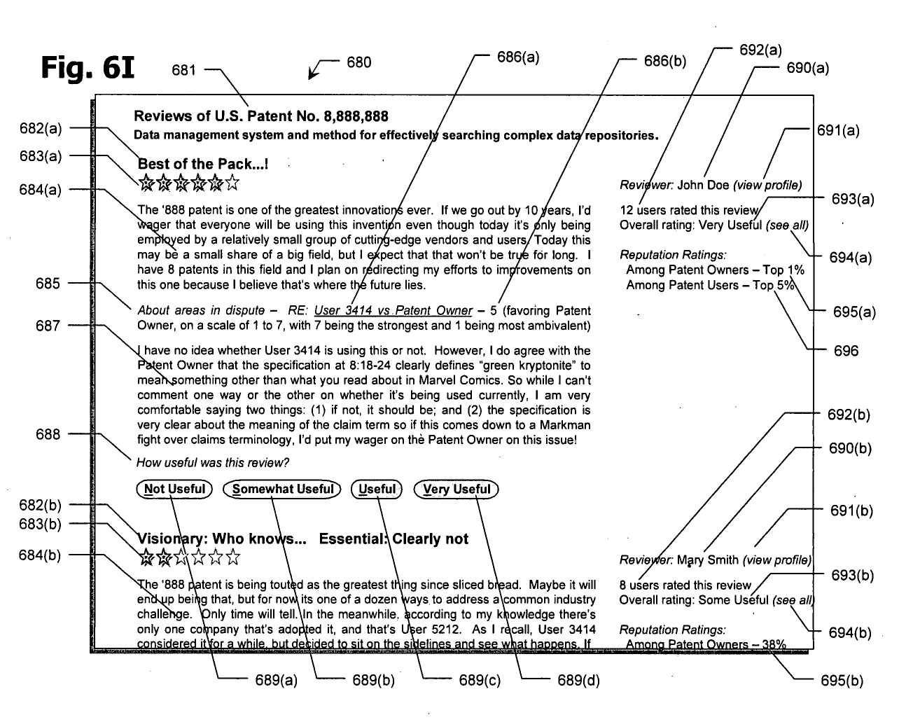

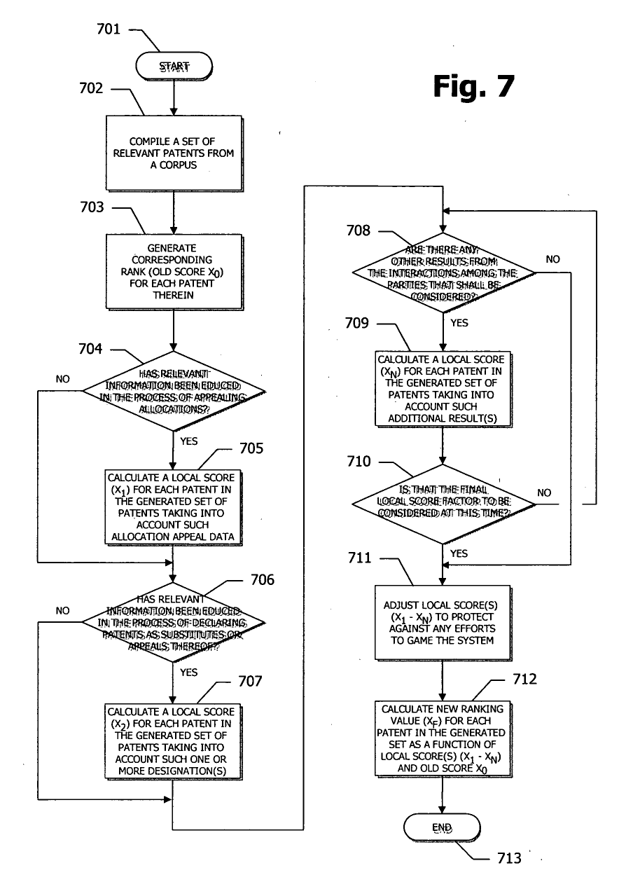

Fourth, by providing licensees with the right to opt-out of licensing one or more specific assets that are initially offered within the patent pool in return for receiving a reduction in the aggregate royalty commensurate with the percentage of the total royalty that the asset(s) represent individually, one preferred method establishes a basis for each licensee to tailor the pool to their particular needs and risk tolerance in terms of acquiring protection under all of the available assets. Additionally, as described below in connection with the optional feature illustrated in FIG. 7, in a preferred embodiment, as licensees increasingly opt out of licensing a patent, this may have a derivative effect of reducing the incremental cost of other firms deciding to incorporate that asset and correspondingly reduce the percentage share of the aggregate royalties collected to which that patent owner may be entitled.

And fifth, by employing a running royalty that is payable quarterly (and therefore subjects allocations of the collective royalties to quarterly review), one preferred method provides an opportunity for the allocation formulas by which such aggregate royalty fees may be distributed among patent owners 203(a)-203(c) to be dynamic in nature. As such, a small company or individual inventor who initially earns a small share of the aggregate royalty income may have a realistic opportunity to attain a much larger portion of the royalties over time to the extent that the field moves in the direction of their innovative contributions. This feature of a preferred embodiment is deemed extremely important to attracting inventors to join the pool early even though they are likely to earn only modest revenue initially by so doing. Additionally, this opens the prospect for financial incentives to be optionally offered in return for inventors subjecting their pending applications to review well before required to do so by prevailing statute. Inventors are commonly optimists, who believe that they have conceived something that is extremely valuable and that will be in great demand “once the world finds out about it.” By employing a dynamic allocation formula, the system and method of a preferred embodiment will inherently do just this.

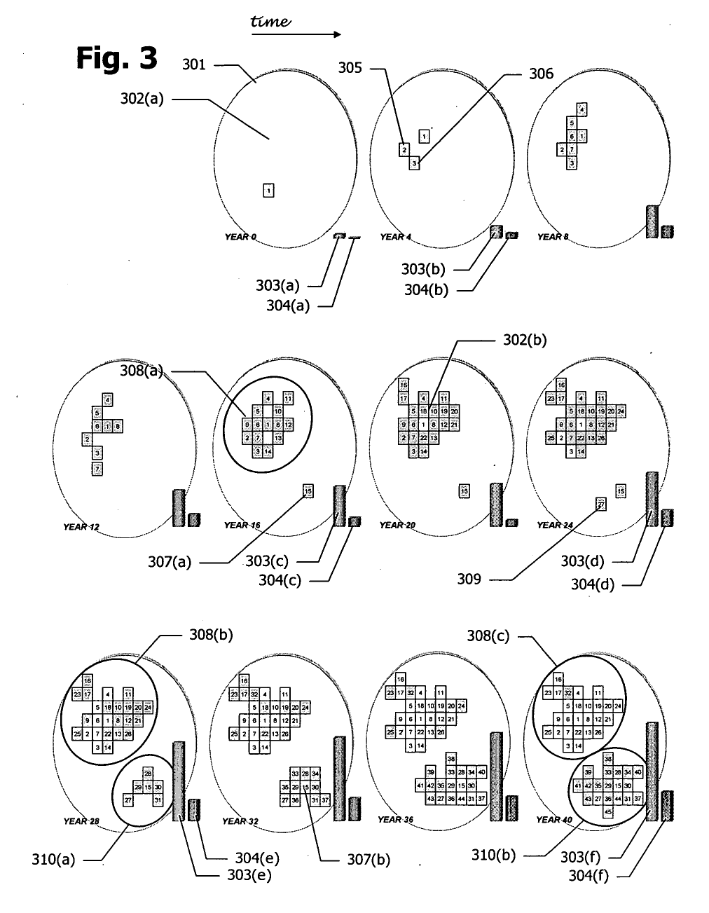

The foregoing aspects of a preferred embodiment will become more evident through the descriptions of FIGS. 3-7, which follow.

In terms of establishing the appropriate royalty rate for the patent pool as a whole, persons of ordinary skill in the art will understand that in Georgia-Pacific Corp. v. United States Plywood Corp., 318 F. Supp. 1116, 1120 (S.D.N.Y. 1970), U.S. District Court Judge Tenney articulated a comprehensive list of relevant factors for estimating damages and determining a reasonable royalty. Persons of ordinary skill in the art understand that application of the so called “Georgia-Pacific factors” outlined therein has become a well-recognized approach to determining what constitutes a “reasonable royalty” for patent infringement; and to the extent that litigation is required and successfully pursued to conclusion, this approach may be used to set the minimum level of damages in accordance with 35 U.S.C. § 284 (which states that a patentee is entitled to receive “ . . . in no event less than a reasonable royalty for the use made of the invention . . . ”). Inasmuch as the Federal Circuit has consistently endorsed Georgia-Pacific as constituting the appropriate factors to consider in assessing liability in the form of damages, the method described therein for estimating a reasonable royalty (or such other method as subsequently may be endorsed by the Federal Circuit in the future) is one preferred method for establishing the royalty to be charged for the collective assets of the patent pool before adjustment for any substitute patents that a licensee elects to remove from it on that basis.

Rectangular box 208, which is entitled “Administration of Licenses and Collection of Royalties,” illustrates the variety of activities involved in carrying out the contractual terms of the license agreement(s) concluded with prospective licensees in step 205, including but not limited to adjusting the scope of the license grant to reflect each such licensee's preferences respecting removal of any deemed substitute patents and correspondingly adjusting the applicable royalty rate for such licensees. In addition, this step entails collecting periodic royalties, reviewing the accuracy of royalty statements accompanying such payments, and following up to resolve any apparent deficiencies and/or over-payments. Further, this step may include conducting the appropriate enforcement activities to the extent any of patent users 206(a)-206(c) fails to adhere to the agreed terms of such executed licenses.

Persons of ordinary skill in the art will appreciate that the administration and collection activities comprising rectangle 208 may entail a variety of communications and exchanges of information (including through letters and documents that may be sent by mail and facsimile transmission, email messages, face-to-face and telephonic communications, etc.). These contacts are illustrated by link 209, which indicates such periodic direct intercommunications between the patent pool operator and licensed patent users 206(a)-206(c).

Additionally, one optional feature of the system and method contemplates that the administration of licenses and collection of royalties 208 may be conducted electronically using the distributed data processing network illustrated in FIG. 1. Accordingly, to the extent this optional feature is incorporated, it will be understood that link 209 will integrate such contract administration function 208 as illustrated by the communication link between the network 110 and licensed patent user workstation 109(b) of FIG. 1.

In one preferred embodiment, the system and method employs some portion or all of the optional royalty calculation and appeals process illustrated by rectangle 210 in conducting such contract administration services illustrated by rectangle 208 and link 209. In this regard, this optional feature entails the use of a variety of rules and algorithms 108(b) in conjunction with data contained in patents file 108(a), contracts file 108(c) and optionally activity log 108(d) to implement some portion or all of the activities represented by rectangles 210(a)-210(d) of FIG. 2 (preferably in accordance with the workflow illustrated in FIGS. 5A and 5B), as more particularly described below. It will be understood that the user may be assisted in carrying out these optional steps of rectangle 210 by employing relevant portions of the distributed network shown in FIG. 1, including the aforementioned digital data processor 101, as well as its sub-components 102-104 and peripherals 105-107; computers 109(a), 109(b) and optionally 109(c), and file server 111 communicating across network 110. And in yet another preferred embodiment, the system additionally employs the optional graphical user interface described below with respect to FIG. 6, in practicing the optional workflow described in FIG. 5 and rectangle 210 using these elements of the system. In another preferred embodiment, the system integrates banks and financial institutions 113 through automated money transfers to satisfy the royalty payment obligations of patent users 206(a)-206(c).

Rectangular box 211, which is entitled “Administration of Patent Pool, Allocations and Payment of Royalties,” illustrates the variety of activities involved in carrying out the contractual terms of the participation agreement(s) concluded with patent owners 203(a)-203(c) in step 201, including but not limited to estimating the appropriate allocation of royalties collected from the one or more licensees of the patent pool in step 208. In one embodiment, this allocation is made on the basis of employing the formula described below with respect to FIG. 3, which will be understood to be one of the algorithms illustrated by 108(b) in FIG. 1. In a preferred embodiment, the allocation algorithm may be applied dynamically, for example each time that an allocation of such collective royalties is about to be made (and therefore quarterly in one preferred embodiment). In yet an additional preferred embodiment, this step entails receiving any complaints stated by one or more patent owners respecting the outcome of applying such allocation formula being unfair, inaccurate or otherwise inappropriate, considering this input, preferably resolving such disagreements and then subsequently distributing the collected royalties to patent owners 203(a)-203(c) in accordance with an adjusted formula for allocation of the collective royalties.

Persons of ordinary skill in the art will appreciate that the activities comprising rectangle 211 may also entail a variety of communications and exchanges of information (including through letters and documents that may be sent by mail and facsimile transmission, email messages, face-to-face and telephonic communications, etc.). These contacts are illustrated by link 212, which indicates such periodic direct intercommunications between the patent pool operator and patent owners 203(a)-203(c).

Additionally, one optional feature of the system and method contemplates that the administration of the patent pool participation agreement, allocation and payment of royalties 211 may be conducted electronically using the distributed data processing network illustrated in FIG. 1. Accordingly, to the extent this optional feature is incorporated, it will be understood that link 212 will integrate such contract administration function 211 as illustrated by the communication link between the network 110 and patent user workstation 109(a) of FIG. 1.

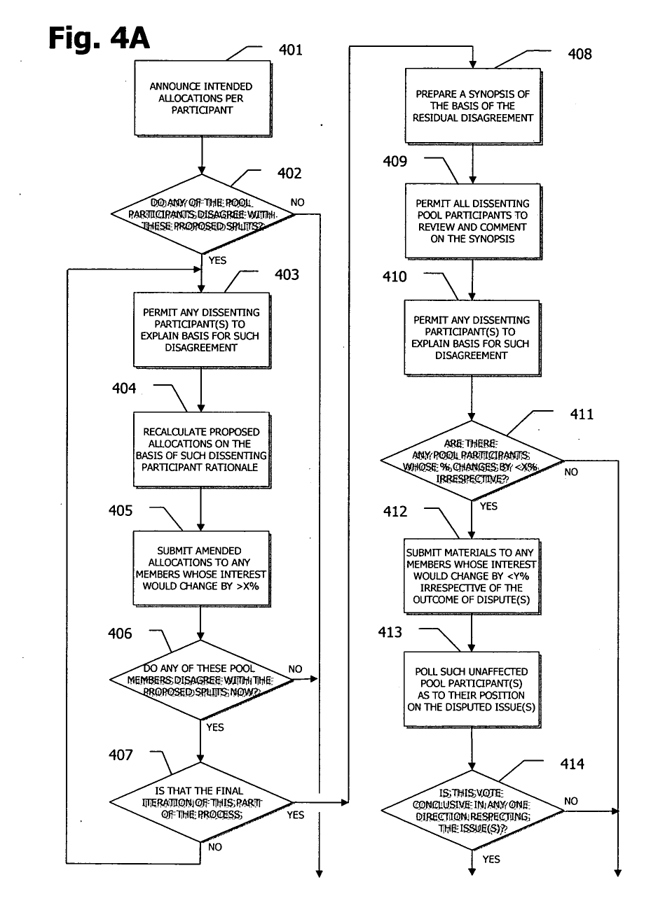

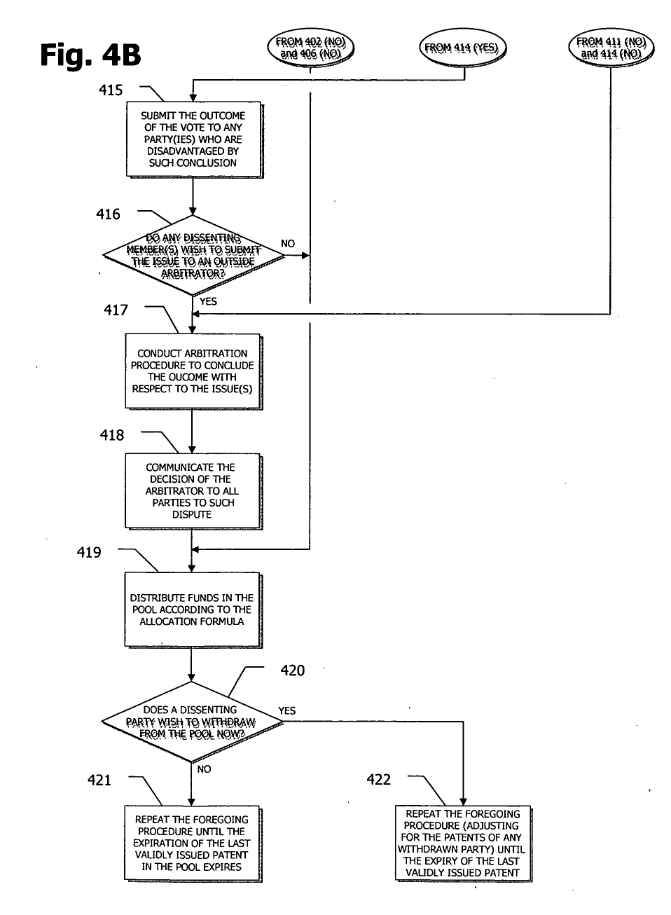

In one preferred embodiment, the system and method employs some portion or all of the optional royalty allocation and appeals process illustrated by rectangle 213 in conducting such contract administration services illustrated by rectangle 211 and link 212. In this regard, this optional feature entails the use of a variety of rules and algorithms 108(b) in conjunction with data contained in patents file 108(a), contracts file 108(c) and optionally activity log 108(d) to implement some portion or all of the activities illustrated by rectangles 213(a)-213(d) of FIG. 2 (preferably in accordance with the workflow illustrated in FIGS. 4A and 4B), as more particularly described below. It will be understood that the user may be assisted in carrying out these optional steps of rectangle 213 by employing the relevant portions of the distributed network shown in FIG. 1, including the aforementioned digital data processor 101, as well as its sub-components 102-104 and peripherals 105-107; computers 109(a) and optionally 109(c), and file server 111 communicating across network 110. And in yet another preferred embodiment, the system additionally employs the optional graphical user interface described below with respect to FIG. 6, in practicing the optional workflow described in FIG. 4 and rectangle 213 using these elements of the system. In another preferred embodiment, the system integrates banks and financial institutions 113 through automated money transfers to distribute royalty fee allocations to patent owners 203(a)-203(c).

Turning next to rectangle 214, it will be observed that the system and method contemplates that, in some instances, litigation may ensue on the basis that a disaffected party objects to the outcome of appeals process 210 (for urging a patent user to forego removing a patent from the license grant on the basis of deeming it to be a substitute) and/or appeals process 213 (for urging the reconsideration of the allocation of royalties a patent owner deems to be unfair). In accordance with the principles described herein, one optional feature involves the patent pool operator testifying, as illustrated by rectangle 214, as a fact witness in the subsequent litigation. Accordingly, in order to provide for this prospect, the terms of all participation agreements with patent owners 203(a)-203(c) and license agreements with patent users 206(a)-206(c) concluded with respect to the patent pool may include a provision requiring such appearance, if requested by a party to such litigation, and correspondingly waiving any objection to such appearance, as and if so requested.

In this regard, if called to testify in such a matter, the patent pool operator can be expected to describe the history and purpose of the patent pool, the procedures used to assure that the calculation and allocation of royalties is fair and reasonable, the multiple opportunities for amicably resolving differences that are built into the system, the rationale for having each of these protections, the extent to which one or both parties followed (or failed to adhere to) such prescribed appeals processes 210 or 213, as well as the results of each of the distinct-stages of that workflow as indicated in activity log 108(d).

Given the numerous protections afforded in a preferred embodiment to assure that all transactions are fair and reasonable, including multiple opportunities for review and appeal, it is deemed far more likely that where litigation arises, it may involve a party who has not contracted with the patent pool either suing or being sued by one or more of patent owners 203(a)-203(c) and/or patent users 206(a)-206(c). Accordingly, such adverse party is likely to fall into one of three major categories.

The adverse party in such a case could be an individual and/or firm that (for whatever reason) might simply prefer to “go it alone” but who is nonetheless fair and reasonable as it respects intellectual property rights. As such, to the extent such litigation may involve one of these parties, it should be capable of prompt resolution through educating such person or entity that such litigation is, in effect, moot since they can attain fair and reasonable treatment through the patent pool or, if they prefer, in direct dealings on a fair and reasonable basis (recalling that in a preferred embodiment of the invention, the patent pool agreements are non-discriminatory as well as non-exclusive, and therefore each party remains at all times able to become a member of the patent pool and/or to contract independently on its own behalf irrespective of whether it is a member).

Thus, setting aside this situation, the other two categories are likely to entail cases in which one party is attempting to take advantage of another and/or one party harbors highly unrealistic expectations; and in either case is attempting to realize these objectives through litigation or the threat thereof rather than by reasonable negotiations. This could entail an individual or company that is not a participant in the patent pool but which owns one or more patents that it contends one or more of patent users 206(a)-206(c) infringes. Alternatively, this could entail an infringement case brought by one or more patent owners 203(a)-203(c) against a company that is not a licensee of the patent pool but which they contend is infringing upon their rights (or a declaratory judgment action initiated by the user against the patent owner(s) seeking to preempt such enforcement action).

In accordance with the principles described herein, in a preferred embodiment the system and method addresses each of these cases through rectangle 215, entitled “Enforcement Actions and/or Optional Reserves.”

Persons of ordinary skill in the art will appreciate that patent litigation is often complex and can be extremely confusing, particularly when handled by highly skilled litigators who are experts at presenting their case in a compelling manner and making the best of the facts (even scanty favorable facts) that support their client's position. On the other hand, district court judges and juries are rarely experts in either patent law or the subject matter of the patent at issue; and as Microsoft's general counsel has said, can become confused. Notwithstanding, in such litigation proceedings, the judge is directed to rule on the meaning of the claims terms used in the patent as a matter of law (see Markman v. Westview Instruments, Inc., 52 F.3d 967, 970-71 (Fed.Cir.1995) (en banc), aff'd, 517 U.S. 370, 116 S.Ct. 1384, 134 L.Ed.2d 577 (1996)); and unless the matter is earlier settled or dismissed upon summary judgment, the jury will ultimately be asked to sort through the often contradictory and highly technical accounts to arrive at a conclusion that some jury consultants who specialize in such matters say boils down to “deciding which party is the good guy seeking simply to abide by the law” (and which one is not).

In such a case, the testimony of the patent pool operator, either through one or more declarations that may be taken into account by technical experts, and/or as a fact witness as described above with respect to rectangle 214, may provide useful evidence with respect to claims construction and the question of which party is being reasonable (and which party is simply trying to take advantage of the other through exploiting inefficiencies in the existing system).

In a March 2005 research paper entitled “The Changing Meaning of Patent Claim Terms,” Mark Lemely, a law professor and Director of the Program in Law, Science and Technology at Stanford Law School writes: “The claims of a patent are central to virtually every aspect of patent law. The claims define the scope of the invention, and their meaning therefore determines both whether a defendant's product infringes a patent and whether the patent is valid. One of the most significant aspects of patent litigation is ‘claim construction,’ the process of defining the words of the claim in other, theoretically clearer words. [ ] As Judge Rich succinctly put it, ‘the name of the game is the claim.’”

On Jul. 12, 2005, the Federal Circuit issued its long awaited en banc decision in Phillips v. AWH Corporation, 2005 WL 1620331 (Fed.Cir. Jul. 12, 2005) (en banc). In Phillips, the court set forth several guideposts that courts should follow when construing claims. To that end, the court held that the words used in a claim are generally given their ordinary and customary meaning; and that the ordinary and customary meaning of a claim term “is the meaning that the term would have to a person of ordinary skill in the art in question at the time of the invention.” Id. at *5. The Phillips court also reiterated the “well-settled understanding that inventors are typically persons skilled in the field of the invention.” Id. The Federal Circuit has separately held that “It is the person of ordinary skill in the field of the invention through whose eyes the claims are construed.” See Multiform Desiccants, Inc. v. Medzam, Ltd., 133 F.3d 1473, 1477 (Fed. Cir. 1998)

The patent pool operator may be in a unique position to assist the court in fulfilling its responsibilities of construing key claim terms in accordance with the foregoing applicable law (as, for example, through providing factual evidence upon which a qualified expert may, at least in part, base his or her opinion concerning how persons skilled in the art at the time of the invention would interpret such terms). Such information may optionally be ascertained through the system and by review of activity log 108(d), which may be provided to the court as a third-party neutral 112.

The fact that the patent owner and/or user fomenting litigation was unwilling to participate in the patent pool and thereby avail itself of the benefits (but also subject itself to the to the obligations) designed to assure a fair and reasonable outcome, whereas the other party was, may provide a useful “reasonableness indicator” as to the penultimate issues the jury must decide. Moreover, the system and method of a preferred embodiment may be used to calculate what could constitute a fair and reasonable royalty rate for the entire pool of related intellectual property assets and to what share of that total the instant patent may be entitled, which may come into evidence through an expert report or in rebuttal, further helping to assure a fair, principled and appropriate outcome.

In an alternative embodiment in which a party is infringing the rights of two or more patent owners 203(a)-203(c), the patent operator may elect to represent the patent owners in enforcement, including through litigation through a joint representation agreement, which may in turn help minimize related litigation costs.

Where the circumstances pertain to licensees 206(a)-206(c) who are willing to license all of the relevant technologies, but where a patent owner of a relevant patent is unwilling to participate in the patent pool (for whatever reason), the licensee(s) may voluntarily elect to pay an amount (herein a “pro forma assessment”) in accordance with rules and algorithms 108(c) and have the patent pool operator estimate the fair and reasonable allocation of the collective royalties including such pro forma assessment that should be reserved for the patent owner. In this optional feature, also illustrated by rectangular box 215, such reserves are maintained in an escrow or reserve account with banks 113 and maintained there on behalf of the patent owner for this express purpose. The patent pool operator may in turn inform the patent owner that it maintains this funded reserve account on its behalf, and will disburse these funds to it as soon as the patent owner either enters into a proper participation agreement with the patent pool or alternatively licenses the patent directly to the interested patent users.

Persons of ordinary skill in the art will understand that since a patent grants the owner the right to exclude all others from making, using, or selling the claimed invention, a patent owner may elect not to use or may refuse to license the invention without running afoul of antitrust laws except in very unusual circumstances. In a July 2002 article entitled “Per Se Legality for Unilateral Refusals to License IP Is Correct as a Matter of Law and Policy,” one of the attorneys to Xerox in the In RE Independent Service Organizations Antitrust Litigation (CSU, L.L.C. v. Xerox Corp.), 203 F.3d 1322 (Fed. Cir. 2000), cert. denied, 121 S. Ct. 1077 (2001), writes: “The statutory scheme of the IP laws, the legislative history of the IP and antitrust laws, and sound policy all support a rule of per se legality for unilateral refusals to license. The benefits of such a rule are reinforced by the modest benefit (if any) of a rule of compulsory licensing and the failings of alternative rules that would govern compulsory licensing.” A copy of this article may be reviewed online at http://www.abanet.org/antitrust/source/07-02/gleklen.pdf, and such paper (“2002 Gleklen paper”) is incorporated herein by this reference.

Persons of ordinary skill in the art will also appreciate that the Patent Misuse Reform Act of 1988 confirms that nonuse or refusal to license a patent is not misuse, and the foregoing optional feature of establishing reserves 215 is not in any way intended to, nor can it convey rights under the patent(s) nor compel any affected patent owner to accept these funds or grant any rights under the subject patent. Accordingly, under current U.S. law, this option may only be employed for patents that, in a preferred embodiment are designated as being a substitute (without limitation, see the discussion with respect to FIG. 6C and explanations 623(c)-623(h), below).

On May 11, 2001, Cecil D. Quillen, Jr., the former General Counsel of Eastman Kodak Company, presented a paper entitled “The U.S. Patent System: Is It Broke? And Who Can Fix It If It Is? ” at the Spring Meeting of the Association of General Counsel. A copy of these remarks (2001 Quillen paper) is presented online at http://www.ftc.gov/os/comments/intelproperty_comments/quillenattachments/isitbrokewhocanfixit.pdf, which 2001 Quillen paper is incorporated herein by reference.

Among other things, in his remarks, Mr. Quillen echoed the view of many party representatives involved in patent litigation (in most cases irrespective of whether they are the plaintiff or defendant in such actions), saying: “The other effect of the unnecessary uncertainty in our patent system is to increase the amount of patent litigation, since answers to many of the key questions about a patent, e.g., whether there is infringement, or whether the non-statutory factors can trump a determination of obviousness under the statutory test, cannot be known in the absence of litigation and an appeal to the Federal Circuit.”

Mr. Quillen's perspective, as an advocate for the harms this circumstance presents to large patent users such as his former employer, is that “[t]he uncertainty, and the risk of excessive, possibly crippling, damages also combine to make patent lawsuits and threats thereof frequent instruments of extortion.” This perspective has been discussed at length herein, as well as in the press. In the aforementioned February 2002 workshop, Joshua Kaplan, the founder and CEO of InTouch Group, a 12-year old company that owns two patents that it has asserted against a number of larger defendants, describes his experiences with many of the same uncertainties and inefficiencies, but from the perspective of a small patent owner. Mr. Kaplan states that in order to enforce its rights, InTouch has tried but failed to get any interest through the use of “nice, non-threatening letters,” over 95% of which had been ignored and the “1 or 2 responses [to which] went something like this: ‘Meritless patent. We don't believe we infringe, but send us a claim chart if you think that we do.” Accordingly, Mr. Kaplan explained that his firm had “gone through litigation now for almost three years [at a cost of between $2 and $3 million]. We have to face dozens of summary judgment motions that are really there specifically to try to invalidate your patent versus companies trying to legitimately take a license from you.”

The activities described above with respect to the aforementioned rectangles 214 and 215 are specifically designed, in a well-ordered system and method, to reduce the amount of litigation by increasing the likelihood that the most likely outcome—even if the adverse party prevails—will be precisely the same result as that concluded from the process described in appeals processes 210 and 213, and other features of a preferred embodiment, with one exception. In a well-ordered system, in considering the award of damages, the jury may take the costs expended on such proceedings into account and adjust the award accordingly, thus extracting the aforementioned prisoners' dilemma penalty against the party who they assess should have never fomented such action in the first place. Depending on the circumstances, this could take the form of an award of attorneys' fees for abusive litigation practices, a finding of willfulness or a reduction in the amount of the aggregate amount of the pro forma reserves to account for such costs of litigation, as appropriate.

The purpose of rectangular box 216, entitled “Indemnification for the Aggrieved Party (Patent Owner or Licensee)” is to take this even further in another optional feature of one preferred embodiment. What this box illustrates is the application of any of a variety of traditional risk-mitigation and/or risk-sharing techniques to the unique needs of large as well as small companies such as those illustrated by Mr. Quillen and Mr. Kaplan, including but not limited to a “mechanism for funding the litigation of a small company,” as suggested by Mr. Kaplan, in order to provide “a deterrent from people to simply take you on in litigation versus sitting down and negotiating some type of reasonable settlement.”

Among other things, illustrated by rectangular box 216 are the optional use of litigation risk coverage, title insurance-like coverage and indemnification insurance policies. Persons of ordinary skill will realize that for such insurance products to work involves a reliable means of assessing probable outcome (which in turn can be used to quantify risk exposure and establish an appropriate deductible amount) and a large pool of re-insurers. In a preferred embodiment, these attributes can be readily devised based on the inherent processes for calculating a fair and reasonable outcome (210(a) and/or 213(a)) and then permitting any dissenting party the opportunity for appeal through one-on-one interaction 210(b) and 213(b), via a poll of persons who are knowledgeable concerning the field and patents 210(c) and 213(c), and then through arbitration before a neutral 210(d) and 213(d), and activity log 108(d) thereby generated. Accordingly, in a preferred embodiment, any party who has gone through all of the steps of the aforementioned appeals process and, having done so, abided by the proposed “fair and reasonable” outcome of that process, may be entitled to purchase such traditional insurance protections. Thus, the reward for having “played by the rules” in a preferred embodiment may be access at a reasonable incremental cost, with reasonable deductible allowances and sufficiently-sized liability limits, to purchase insurance that may cover the cost of defense or prosecution by the best legal talent available for this purpose, as well as indemnification (not just reimbursement) in the event of a loss.

Persons of ordinary skill in the art also understand that while financial analysts have estimated that the value of intangible assets to constitute trillions of dollars in the U.S. alone and have shown that intellectual capital represents a significant percentage of the total capital value in publicly-traded companies, much of this value remains illiquid. Accordingly, although a number of traditional equity and debt investors and hedge funds have shown an increasing interest in intellectual-property based investing (including IP-backed loans, collateralized debt obligations (CDO's), royalty-backed securitizations and other forms of equity and/or debt investments in companies whose assets are predominately intellectual property and which have little or no ongoing operations or production), to date this represents a very shallow market by traditional capital markets standards. In addition, where pure intellectual-property backed financing transactions have occurred, these financings have primarily involved “affirmative rights” (e.g., if my IP is used, then I will be paid for it) such as based on streams of existing royalty income and for copyrighted music by well-known artists with proven market appeal, whereas “adverse rights” (e.g., if my IP is used, I can sue for damages) have not been highly regarded.

A preferred embodiment of the system and method contemplates converting, as illustrated by rectangle 217, entitled “IP-Backed Liquidity from Capital Markets” in conjunction with investors and financial institutions 218, the adverse rights inhering in the individual patents owned by patent owners 203(a)-203(c) into a share in the collective affirmative rights represented by the patent pool licenses to patent users 206(a)-206(c). Thus, whereas few if any of these patents could be “financable” as a standalone asset, the pool as a whole (and each of the individual patent owners respective rights to a share of the royalty income thereby generated) is anticipated as being amenable to financing for the reasons stated herein.

A 2001 whitepaper entitled “Patent Backed Securitization: Blueprint For A New Asset Class” authored by David Edwards, Vice President of Marketing Securitization of the Financial Solutions Group at Gerling NCM Credit Insurance (2001 securitization whitepaper); a March 2004 whitepaper entitled “Securitization of Intellectual Property: Recent Trends from the United States by John Hillary of Washington|CORE (2004 securitization whitepaper); and a 2005 dissertation entitled “Intellectual Alchemy: Securitization of Intellectual Property as an Innovative Form of Alternative Financing, by John Gabala, Jr. (2005 law review article) describe a number of promising financial structures available for implementing this final step. Copies of these three papers may, respectively, be reviewed online at http://www.Securitization.net/pdf/gerling_new_{—}0302.pdf, http://www.iip.or.jp/summary/pdf/WCORE2004s.pdf and http://www. jmls.edu/ripl/vol3/issue2/gabala-middle.html, all of which are incorporated herein by reference. Additionally, a number of pending applications including U.S. Patent Application No. 20050108118 by Malackowski et al., entitled “System and Method for Creation of a Patent Investment Entity” and U.S. Patent Application No. 20030225653 by Pullman, entitled “Method and Device for Pooling Intellectual Property Assets for Securitization” may be useful in practicing this portion of the invention.

Persons of ordinary skill in the art will appreciate that, as Mr. Edwards states, “[f]rom the investor perspective, a patent-backed transaction decouples technology risk from management and other operational risk. It also allows investors direct participation in narrow technology niches or specific patents depending on the structure of the vehicle. Finally, this structure offers a more finely tuned investment for a venture capitalist in that he can invest in the IP rather than the business and get quicker liquidity than through the usual sale or IPO. There are limitless applications for this type of financial technology . . . . ” Combined with the other aspects of the instant invention shown in FIG. 2 to, among other things, contain litigation risk and convert classical adverse rights into affirmative rights as part of the patent pool, this potential can be realized.

Although the foregoing represents one possible feature of the system and method, it will be understood by those of ordinary skill in the art that creating financial products with the lowest overall effective cost of capital may also benefit from complete integration of the investor into the system. Accordingly, in another preferred embodiment, the system additionally integrates investors 218 into relevant portions of the above-described interactions occurring on the distributed network shown in FIG. 1 by including therein the banks and financial institutions 113 across network 110.

For individual inventors seeking to convert innovative ideas into start-up capital and emerging companies seeking to capitalize on their intellectual property assets and hold down their cost of capital, this may provide a highly beneficial source of advantageous financing and/or liquidity. As the 2001 Quillen paper highlights: “The financial markets deal with risk and uncertainty through the cost of capital.” By reducing risks and limiting financial exposure in the manner described herein, a preferred embodiment the system and method is also anticipated to benefit patent users 206(a)-206(c) by eliminating uncertainty.

As Mr. Quillen explains: “Our Polaroid case provides an illustration of the effect of uncertainty on the cost of capital for innovation investments. The case was bifurcated and the initial damages judgment was in 1990, five years after the liability judgment in 1985. During this interval there was uncertainty as to the amount of damages Polaroid would be awarded. The damages judgment was announced at $905 million (later reduced to $873 million) and the equity market value of Kodak immediately increased by $921 million ($795 million at the fifth day after announcement). Thus elimination of the uncertainty as to the amount of damages was followed by an immediate increase in Kodak's market equity value, and a corresponding decrease in the cost of Kodak's equity capital. Given that the market equity value of Kodak was $11.2 billion immediately prior to the judgment, this represented a decrease of about 7% in the cost of Kodak's equity capital. Imagine if you will the savings to Kodak if the cost of its equity capital had been 7% less throughout the entire fifteen years the Polaroid litigation was pending, or even the five year interval between the liability judgment and the initial damages judgment. Those are truly astounding sums and should give some appreciation of the additional cost of capital borne by American industry as a consequence of the uncertainty that is the product of our present patent system.”

One skilled in the art will appreciate that the foregoing described system and methods can also be used in various environments other than the previously described embodiment. For example, such techniques can be employed in an electronic mail environment in which a proposed allocation is described in an electronic mail message along with an indication of the action that is to be performed to consent to or alternatively contest such proposal. Also, various communication channels may be used such as a local area network, wide area network, wireless service or point-to-point dial-up connection. Also, a server system may comprise any combination of hardware or software that can implement the algorithms described herein or generate the types of communications contemplated in response to the action being performed. A client system may comprise any combination of hardware or software that can interact with the server system. These systems may include cable, satellite and television-based systems and/or various other systems connected via a network through which the herein described communications may reasonably take place.

In a preferred embodiment, the foregoing described components may also be used to extend the scope of the disclosure to include steps preceding and/or following those steps described, including but not limited to locating and attracting prospective pool participants; explaining the patent pool arrangement to such prospective participants; facilitating the execution of a participation agreement; promoting the availability of such pool to prospective licensees; providing members with royalty statements and reports for federal and state income tax, securities compliance and other official purposes; and other communications involving the pool, its members, the organizer/operator of such pool, an optional arbitrator(s) and any other parties with whom one or more of these persons or entities may communicate.

Before turning to FIG. 3, it is worth reiterating that in a preferred embodiment, the workflow is effectively divided into two phases, the first focused on assessing a fair and reasonable collective royalty for a patent pool; and the second focused on allocating the net royalty fee income among the various patent owners who comprise such pool. In a well ordered system, there is a need for a trusted means of fairly allocating such royalty collections among individual patent owners on the basis of their respective contribution.

This need for an effective, reliable and trusted way to make such an allocation is illustrated by the above-referenced February 2002 testimony of Robert Kohn. As summarized above, patents may be valued according to various methods known in the art, some of the more common ones of which are referenced in the Background section.

Each of foregoing approaches produces a different measure or estimate of the value of a particular intellectual property asset under review. Some approaches (by way of example, but not limitation, PF/i reports, IPQ scores and the respective methods and systems disclosed under the aforementioned '966 and '992 patents) may be better suited to being implemented within a computerized system; whereas others (for example, the traditional cost, market and discounted cash flow approaches) tend to be highly fact intensive and involve the use of cost accounting and other technical experts. Notwithstanding that none of these techniques was developed with the specific needs of the instant system and method in mind, the underlying concepts they disclose may (to one degree or another) bear some relevance on valuing a patent pool and/or establishing the relative values of individual property assets comprising a patent pool, and each is therefore incorporated herein by reference.

The point has previously been made that the value of a patent pool as a whole may be worth substantially more than the simple sum of its individual parts. Thus the specific issue of establishing a reliable estimate of that portion of the royalties collected (in the aggregate) for a license to the patent pool which should be allocated to each of the individual assets comprising such pool (or in the case of pro forma assessments, as described above, additionally to the assets that could later be added thereto) represents a somewhat different issue than the subject addressed by these practices and/or proposals of the prior art. Here, the issue is fundamentally not how much each patent may be worth as a standalone asset; but rather what share of the collective royalty receipts each such patent should be entitled to receive.

In a preferred embodiment, the allocation of the royalties collected for licenses on the patents comprising the patent pool is made based upon calculations performed using the aforementioned digital data processor 101, as well as its sub-components 102-104 and peripherals 105 and 106, to apply rules and algorithms 108(b) to analyze patents contained in patents file 108(a) of FIG. 1 and other publicly available information as more particularly described herein. In an optional embodiment, the allocation system and method additionally integrates data collected from intellectual property owners 203(a)-203(c), preferably through IP computers 109(a) and file server 111 communicating across network 110.

Persons of ordinary skill in the art understand that a variety of econometric studies, empirical surveys and other analyses have demonstrated that a statistically significant relationship exists between the quality of scientific references in patents and a patent's value; and thus shown that the number of backward citations listed is positively correlated with a patent's value. Moreover, it is widely believed that a number of patents were issued over the past decade (particularly in the areas of software and business methods) based upon an insufficient review of the relevant prior art; and various patent litigation studies suggest that uncited prior art is the most common basis for court decisions invalidating U.S. patents. It is correspondingly speculated that a larger number of backward citations as well as non-patent citations disclosed during prosecution of the patent may point to a more serious effort by the applicant to differentiate its invention from the prior art and perhaps to a more thorough examination in the patent examiner, resulting in a stronger patent more likely to withstand challenge.

In one embodiment of the system and method, the foregoing algorithms 108(b) may cause the allocation of royalties among the patent owners comprising the patent pool (and optionally including pro forma assessments) to take into account backward citation analysis. In an optional embodiment, such backward citation analysis (or analyses) may take into account other factors that have been show to correlate to the frequency, speed, and/or breadth (or concentration) of fields of such backward citations.

Persons of ordinary skill in the art will also understand that there is also strong empirical evidence showing that a positive relationship exists between the number of citations made to an issued patent by other subsequently issued patents and the value of the patent to which these forward references refer. Thus, in another embodiment of the system and method, the foregoing algorithms 108(b) may cause the allocation of royalties among the patent owners comprising the patent pool (and optionally including pro forma assessments) to take into account forward citation analysis. Moreover, in an optional embodiment, such forward citation analysis (or analyses) may take into account the frequency, speed and/or breadth (or concentration) of fields of such forward citations.

By definition, the commercial value of a patent is determined by the sales associated with the technology covered by the patent and by the profit margin on such sales. This is because sales tend to represent how well a product and service provides features and functions for which there is market demand, thereby contributing to increased volume and/or higher unit prices; and profit margins tend to indicate how efficiently these desirable features and functions can be provided or produced. Thus, although sales and related cost of goods may sometimes be difficult to ascertain, where available, they may be used as a proxy for weighting the relative value of patents.

Persons of ordinary skill in the art understand that for publicly-traded companies, sales and profit margins are regularly reported in public disclosures, and also may be estimated by market analysts. Additionally, to the extent that royalty reports are provided by patent users 206(a)-206(c) as an integral part of a periodic reporting responsibility, these reports may contain applicable sales and/or profit margin data. Thus, in another embodiment of the invention, the foregoing algorithms 108(b) may cause the proposed allocations of royalties among the patent owners comprising the patent pool (and optionally including pro forma assessments) to take into account the aggregate sales of firms employing these patents. And in yet another embodiment, such algorithms may cause the proposed allocations to take into account the gross margin (defined as sales less related production cost or cost of goods sold, as applicable) achieved by the firms employing these patents. In a further optional embodiment, the sales and gross margin statistical analyses may take into account the timing and/or consistency of such achieved sales and/or gross margins.

In another embodiment of the system and method, the foregoing algorithms 108(b) may cause the allocation of royalties among the patent owners comprising the patent pool (and optionally including pro forma assessments) to be based on the IPQ score and/or PF/i report for each of the respective patents in the patent pool (optionally together with any patents in the pro forma assessments).

Persons of ordinary skill in the art will understand that in programming digital data processor 101 to employ such algorithms 108(b) to fulfill the objectives of the invention, various combinations of the foregoing elements also may be used. Moreover, in a preferred embodiment, the foregoing calculations may be performed dynamically in order to take into account changes that have taken place over time within the particular field of use. Thus, for example, in a preferred embodiment, as the field evolves and the intensity of forward citations to a particular patent combined with the sales and profitability achieved by companies that employ that patent versus other companies that do not may tend to direct an increasingly greater percentage of the allocation of collective royalties toward that patent, as more particularly described herein.

FIG. 3 depicts how a hypothetical field of use 301 evolves over time. Persons of ordinary skill in the art will understand that a “field of use” is generally understood to be a specific application, industry, product or product line and/or market. Thus, some patents may have applications in more than one field of use. For example, many biotechnology inventions may have applications as basic research reagents, components of diagnostics, reagents for process separations, agricultural uses (such as for pesticides, fertilizers and growth modulators) and/or human or veterinary therapeutics, whereas most companies do not handle more than one or a few of these business areas. Field of use will generally correspond to the scope of the grant included in the licenses concluded with patent users 206(a)-206(c). Accordingly, where possible in practicing the invention, it is deemed preferable that the field of use should be functional for the licensee or end user. Thus, in one preferred embodiment of the system and method, field of use 301 (which persons of ordinary skill in the art will understand generally corresponds to the preferred scope of a patent pool created as illustrated in rectangular box 201 of FIG. 2) is roughly coextensive with a single, coherent product occupying a distinct economic market.

As shown in FIG. 3, hypothetical field 301 begins with an initial innovation 302(a) and then subsequent development (either by the initial innovator or by others who come after that individual and/or firm) as the product and/or service begins to mature, as various problems arise and are overcome through further innovative contributions, and as the market for such product or service begins, on the one hand, to assert various market pressures and on the other to fuel such development through the generation of increased profitability. For the sake of ease and clarity of presentation, FIG. 3 illustrates ten incremental snapshots in time that are arbitrarily shown in 4-year increments and over an assumed 40-year period.

As presented, FIG. 3 shows only 45 patents as being relevant to the field of use during this 40-year period, despite the fact that persons of ordinary skill in the art will understand the quantity of patents is likely to be significantly greater in a preferred embodiment and the increments of time used for the purposes of applying the foregoing described algorithms and allocating total royalties collected by the patent pool may be more frequent; and as previously stated, may preferably be quarterly (e.g., 4 times per year). Also, for the sake of simplifying the illustration, the duration of time for which each patent is assumed to be valid and outstanding is 20 years, even though the actual period may be less from the date of publication and may likely differ somewhat based on a variety of factors.

Vertical bar 303(a) illustrates the level of sales of the firm or firms in field 301 who are employing patent 302(a), and vertical bar 304(a) illustrates the profitability from such sales, which in both cases are shown to initially be very low as one might naturally expect in a new field of use. By year 4, FIG. 3 illustrates that two more patents, including numbers 2 (305) and 3 (306) have been granted in hypothetical field of use 301, and shows modest growth in both sales 303(b) and profits 304(b). By year 8, the number of patents has increased to a total of seven, and this number is shown to remain relatively stable, with only one new patent having been issued through year 12.

Presuming, for example, that the patent pool was created in year 8, wherein as illustrated there are a total of 7 patents, one preferred embodiment of the system and method allocates the aggregate royalties collected for the use of all 7 patents on the basis of one or more of the foregoing described techniques. In this instance, it is likely that a disproportionate share of the royalties could be earned by the earlier patents upon whose “shoulders” the subsequent technologies were based.

By year 16, FIG. 3 shows that the industry has experienced additional innovative contributions; with the total number of patents having doubled over the number from four years earlier, presumably attracted by the historical sales and aggregate profitability within the field of use. Also in year 16, the hypothetical field of use shows the advent of new patent 15, designated 307(a), which departs from the established approach in some significant way. Persons of ordinary skill in the art will understand that this departure may be observed through a variety of analytical methods that lend themselves to use within the system and method, including among other things backward citation analysis and semantic analyses that are well known in the art.

Thus, while this hypothetical patent 307(a) is in the same field of use, it can be seen to differ somewhat significantly in its approach compared with historical approaches 308(a) employed in the field. While this innovation can be observed as presenting a dramatically different and, by definition, substitute approach, it is still uncertain whether this innovation will prove to be attractive to the market and/or widely adopted. By way of example, in the field of printers, which is known to have historically employed impact printing techniques evolving from manual typewriters to electric typewriters with swinging keys, and then later to the use of a typing ball and dot matrix printers as a separate device from the keyboard, this could be an early patent suggesting the use of inkjet technology or laser printing.

As persons of ordinary skill in the art will understand, and as illustrated by FIG. 3, it may take a number of years before the popularity of this new innovation will displace the historical approaches in the field of use. This has been referred to as the evolution from “freak to chic,” that is the process by which innovation moves from “the fringe,” where it has an audience of one or a very few, namely the original inventor(s), to the point that it attracts a mass market. See, The Deviant's Advantage: How Fringe Ideas Create Mass Markets, Ryan Matthews and C. Watts Wacker (Crown Publishing, 2002) Particularly in early periods, the new approach suggested in 307(a) may tend to incorporate a number of the component parts of the historical approach (in the instance of the example, the technologies used to grip and/or move the paper, the power components and the like).

As shown in FIG. 3, in year 20, the initial pioneering patent in the field is shown at 302(b) to expire. In accordance with the principles of the invention, at this point, this patent could no longer participate in the allocations of royalties paid to the patent pool inasmuch as the technology it covers moves into the public domain. The market size is considerably larger and each of the residual patents could share in the patent pool in accordance with their respective allocation percentage. Still, at this time, there continues to be considerable additional innovation in the historical direction of the field, presumably through the advent of additional competitors. Moreover, patent 15 remains on the fringe and entitled to a small share of the patent pool—essentially as an option payment by the patent users 206(a)-206(c) who elect to pay for it as a substitute patent rather than remove it from the pool as disclosed elsewhere with respect to a preferred embodiment.

In year 24, the illustration shows that a second innovation, represented by patent 27, which is labeled 309, takes place that is once again outside the historical approach and closer to the approach advanced within fringe patent 15. For example, this could be an innovation that makes the desirable features of that earlier patent more economical to produce and/or that makes it possible to provide an additional attractive feature. Also in year 24, the industry shows increases in both sales and marginal profits, as illustrated therein by vertical bars 303(c) and 304(c). The aforementioned algorithm 108(b) could in the manner described above reflect these facts in beginning to increase the allocation formulas to reflect the apparent pull of patent 15 in combination with patent 27.

By year 28, the industry shows that all of the innovation is now taking place around with respect to the approach 310(a) of patents 15 and 27, and correspondingly little new innovation taking place within historical approach 308(b). The dream of the early inventors of patents 15 and 27 is becoming realized as the potential for their patented breakthrough is moving from the fringe to the mainstream. Correspondingly, sales 303(e) and profits 304(e) show increases over prior periods, suggesting that this new innovation has found a market that is being profitably exploited. With this, the aforementioned algorithm 108(b) may direct an increasingly large percentage of the royalties to these patents. Notwithstanding, the earlier patents that remain relevant on the basis of the election of patents that are deemed to be essential to the practicing this field and/or that substitutes but that are nonetheless maintained as part of the portfolio by patent users 206(a)-206(c) receive a smaller percentage but of a significantly larger total.

In year 32, the initial patent 15 expires, as illustrated by 307(b), at which time this patent (like all the other patents that have expired) could no longer participate in the allocation of royalties as the technology it once protected moves into the public domain. As shown, by year 40, the historical approach 308(c) is illustrated as having only one residual patent sharing in the allocations and a considerable number of new patents within approach 310(b), continuing to fuel additional industry growth 303(f) and profitability 304(f) even though, by this time both of the pioneering patents of this once fringe (but now conventional) approach have expired and no longer share in the royalties collected.

As FIG. 3 reveals, all 45 patents in the field of use are not equal in importance, and the aforementioned algorithm 108(b) assures that each of patent owners 203(a)-203(c) are allocated an appropriate share of the royalty stream that fairly reflects their respective contribution to the value of the patent pool over time. In a preferred embodiment, this approach thus serves as an incentive to innovation (for instance, rewarding the pioneering role of early inventors such as patents 1 and 15, and additionally taking into account significant improvements such as patents 2, 3 and 27), while at the same time rewarding each of the contributors to the field commensurate with their earlier and/or more modest contributions until such time as the period of exclusivity to which they have been granted expires or is terminated, or to the extent that all of patent users 206(a)-206(c) designate such patents to be substitutes and further elect to remove them from the patent pool, as herein described. For the reasons discussed herein, this is preferable in instances where, as in a preferred embodiment, the patent pool incorporates both essential as well as non-essential patents because it inherently maintains rivalry both among patents contained in the patent pool as well as between patents that are included in the pool and patents outside it.

Additionally, this approach serves as an improvement over the existing state of the art for allocating royalties among participants in a patent pool even to the extent that all of the patents therein are deemed to be essential. Among other things, the system and method inherently provides an incentive to the patent owners to challenge the validity of an invalid patent, thereby overcoming one of the concerns expressed by the Department of Justice in its aforementioned 1998 Ruling Letter about a system that simply allocates to individual parties a negotiated percentage of the pool's earnings. Moreover, because the royalty allocation received by each patent owner may be directly affected by other patents in the patent pool, each such patent owner has a financial incentive to exclude each other's patents that do not contribute at least as much to the value of the patent pool as they take through their share of the allocable earnings, and simultaneously to conceive, patent and contribute more valuable innovations in order to increase their respective share of the collective royalties—thereby overcoming two other concerns expressed in the 1998 and 1999 Ruling Letters.

By bringing together complementary patent rights, the patent pool will, as the Department of Justice suggests in its 1998 Ruling Letter, “be ‘an efficient and pro-competitive method of disseminating those rights to would-be users.’ By reducing what would otherwise be [multiple] licensing transactions to one, the pool [will] reduce transaction costs for [patent users 206(a)-206(c)] and [patent owners 203(a)-203(c)] alike. By ensuring that each [patent owner's] patents will not be blocked by those of the other [patent owners], the pool [may] enhance the value of all [the patent owners'] patents.”

This conclusion is consistent with a number of technical papers written by economists specializing in the area of intellectual property and the effects of licensing agreements on market competition. See, for example, Dr. Shapiro's Nov. 23, 2003 written testimony to the European Commission entitled “EU Technology Transfer Draft Guidelines: Economic Analysis and Suggestions for Revisions,” a copy of which testimony is available online at http://europa.eu.int/comm/competition/antitrust/technology_transfer_{—}2/16_shapiro_en.pdf. This objective is reinforced in a situation where, as in one preferred embodiment, the patent pool operator is an independent entity who does not otherwise participate as either a patent user or patent owner in the applicable field of use, and whose compensation is based on a percentage of aggregate running royalties and thereby who maximizes its profit potential from achieving simultaneously the highest possible levels of licensing on behalf of patent owners 203(a)-203(c) and sales revenues by patent users 206(a)-206(c).

In a preferred embodiment, the foregoing described system and method of calculating the estimated allocation of the collective royalty among the patent owners comprising a patent pool is integrated with intellectual property owners, preferably through IP computers 109(a) and file server 111 communicating across network 110. And in yet another preferred embodiment, the system additionally employs the optional graphical user interface described below with respect to FIG. 6, in practicing the optional workflow described in FIG. 4 using these elements of the system. Also in a preferred embodiment, patent owners 203(a)-203(c) are given an opportunity to appeal the proposed allocation of the collective royalties, and once the period for making such an appeal has transpired, these allocations are then made to patent owners 203(a)-203(c), preferably in accordance with the workflow described in FIG. 4. Accordingly, in another preferred embodiment, the system additionally integrates banks and financial institutions 113 to disburse and/or receive the relevant portions of the above-described allocations in accordance with interactions occurring on the distributed network shown in FIG. 1 by including therein banks and financial institutions 113 across network 110.

Now turning to FIG. 4, it will be observed that a flow diagram is provided to illustrate the optional integration of dispute resolution into a preferred embodiment of this disclosure. As mentioned herein, by dispute resolution is meant any circumstance in which one or more members of the patent pool do not agree with the proposed allocation of royalty revenue.

Thus, according to FIG. 4, rectangle 401 indicates announcement, presumably by the operator of the patent pool, of the intended allocations per participant. This announcement may occur at any time, or from time to time, in accordance with the terms of the patent pooling arrangement agreed upon by the pool members. It is believed preferable in a non-limiting example that such arrangement make this announcement of intended allocations approximately sixty (60) days prior to each distribution of money by the operator, and that it be made in writing together with a brief explanation of the rationale for such allocation. In the event that a dynamic allocation formula is employed in calculating such allocations, it is anticipated that this description may indicate the reasons for changes, if any, compared with earlier periods. Such disclosure of allocations may be stated in absolute dollars or merely as a percentage of the total pool, or both, depending on the policies of the operator and/or the preferences of the patent pool members.

Assuming, for the sake of illustration, that the period of advance notice is sixty (60) days, then, in one preferred embodiment, all of the members of the patent pool could have approximately fifteen (15) days in which to decide, as shown in step 402, if they have any disagreement with the proposed allocation of earnings. If the answer is “Yes” (meaning that one or more member indicates that he, she or it disagrees with the intended allocation, as proposed by the pool operator), then such disagreement may be communicated to the patent pool operator. Although not shown in the attached illustration, a conversation by and between the operator and that party could preferably take place shortly after receipt of such notice. During such discussion, the operator would presumably listen to the concerns expressed by the member(s), provide an explanation concerning the rationale for the proposed distribution and describe the process for seeking a change therein based on the terms of the advance agreement by and between all of the pool members.

Decision step 402 illustrates a “No” response, referring to instances wherein none of the members indicates any disagreement with the proposed allocation and/or an initially dissenting member(s) concludes following the aforementioned discussion with the pool operator that he, she, they or it wish to withdraw any previously asserted notice of disagreement. As shown in FIG. 4, in the event that there was no disagreement (or to the extent that such disagreement was overcome by the aforementioned discussion), then as soon as practical following the predetermined period for asserting any disagreement, the patent pool operator could proceed to distribute funds held in such pool in accordance with the aforementioned intended allocation formula. This step is illustrated by rectangle 419, entitled “Distribute Funds in the Pool According to the Allocation Formula,” which step is more particularly described below.

Returning to decision step 402, it will be observed that a “Yes” response indicates that one or more members of the patent pool indicate disagreement with the proposed allocation of earnings, whereupon a process is commenced to resolve or at least to help facilitate resolution of such disagreement. In this instance, as illustrated by rectangle 403, entitled “Permit Any Dissenting Participant(s) to Explain Basis for Such Disagreement,” within a pre-agreed maximum number of days, any party who disagrees with such intended allocation may provide an explanation of the concerns he, she, they or it has with such intended allocation formula. By way of example but not limitation, if such patent owner deems the subject patent to be essential or to be blocking another patent that received a higher proposed allocation, he or she may express this view. Additionally, this step contemplates that such dissenting party may propose an alternative allocation that he or she believes to more fairly recognize the relative value of his or her asset. As noted herein, a preferred embodiment anticipates that the agreement by and between the parties who are members of the patent pool may include a compulsory arbitration provision to the extent the earlier attempts to resolve a disagreement concerning allocation of the royalty earnings prove unsuccessful. Accordingly, in a preferred embodiment, the explanation provided by any dissenting participants may ultimately become a portion of the parties' briefings to the arbitrator, thereby expediting that process and, in effect, serving to limit the scope of such arbitration to allocation issues.

Rectangular box 404 illustrates that upon receipt of the one or more dissenting explanations, the patent pool operator recalculates the allocations on the basis of that rationale and each alternative allocation recommendation. In a preferred embodiment, the system could consist of a number of pre-designed templates in which the dissenting member could be assisted in entering his, her or its alternative allocation recommendation and able to see the effect such alternative has both respecting his or her patents as well as on one or more other patents in the pool.

Thus, for example, if a participant in the patent pool were to take the position that another patent therein was invalid or unenforceable because of its failure to meet the conditions of patentability and/or to comply with the requirements of Title 35 of the United States Code, including 35 U.S.C. §§ 101, 102, 103, and/or 112, this assertion might result in eliminating that other patent owner from having any right to a share of the pool and correspondingly elevate the dissenting owner's share of the royalty earnings. Alternatively, a participant could assert that the scope of a claim was being improperly assessed for the purposes of the allocation of royalty earnings, which could result in shifting the allocation from a group of patents to a patent or different group of patents. In another example, a participant could assert that the use of the patent pool assets by one or more of the licensees was more directly infringing on the scope of a single patent and involved less significantly another patent or group of patents, which could in turn elevate the share of royalty to which that patent was entitled and corresponding reduce the allocable share to the other(s).

As will be obvious to those of ordinary skill in the art, the unique quality of the foregoing disagreements is that these pertain to allocation of earnings as opposed to the obligation of the licensee to utilize the pool. Those of ordinary skill will appreciate that defense counsel on behalf of a company confronted by an allegation of infringement—particularly by a thinly capitalized patentee—may employ aggressive litigation practices involving such defenses simply to deplete the financial resource of the patentee, in the hopes of confusing the judge and/or jury, and/or to increase the risks to the patentee to such an extent as to promote a reduced settlement sum. The system inherently removes this motivation and renders the licensee indifferent to such outcome except to the extent he, she or it believes that the allocation of royalties (including its own share thereof to the extent it participates as a member of the patent pool) is improper.

Once the dissenting member has employed the tools incumbent to steps 403 and 404 to conclude his, her or its proffered allocation in response to the intended allocation of step 401, in a preferred embodiment the system automatically submits the amended allocations to any member of the patent pool whose interest could change by a predetermined percentage compared with such initial intended allocation formula. This step is illustrated by rectangular block 405, it being understood that the portion of the title “ . . . Change By >X %” shown therein refers to an agreed percentage change threshold set forth in the participation agreement, wherein the participant may be informed of such change(s), if any.

As described below with respect to step 412, this threshold number also dictates which members are considered as being “unaffected but nonetheless interested and knowledgeable” parties and thereby permitted to vote on the resolution of such disagreements. Thus, a member who establishes a very low percentage number such as 0.01% could likely receive more indications that his, her or its interest in the pool is affected by a disagreement, but correspondingly be deprived of voting on such proposed changes. By the same token, a member who establishes a high percentage threshold such as 50% could likely have a far greater opportunity for voting to resolve future allocation disagreements, if any, but could be correspondingly deprived of submitting formal responses through the system in accordance with step 406.

Thus, now turning to decision step 406, entitled “Do Any of These Pool Participants Disagree with the Proposed Splits Now?” the system next solicits whether any member of the pool whose established percentage threshold allocation of the pool earnings was exceeded by another member's proposed change pursuant to step 404 disagrees with such amended allocation formula. As indicated in FIG. 4, in the event that none of such members of the patent pool disagree with such amended allocation (or to the extent that such disagreement was overcome by a discussion that may ensue between various parties), then as soon as practical following the pre-determined period for asserting any disagreement, the patent pool operator could proceed to distribute funds held in such pool in accordance with the aforementioned amended allocation formula. This step is illustrated by step 419, entitled “Distribute Funds in the Pool According to the Allocation Formula,” which step is more particularly described below.

Returning to decision step 406, it will be observed that a “Yes” response indicates that the one or more member of the patent pool whose established percentage threshold allocation of the pool earnings was exceeded by another member's proposed change in fact disagrees with such proposed alternative allocation of earnings, whereupon that or those member(s) so affected are provided an opportunity to explain the basis for such disagreement, and to advocate the original allocation formula or yet a different formula.

Decision step 407 reflects a regulator that is built into the system, and that could presumably implement the terms of the participation agreement concluded by and between the participants in the pool. In a preferred embodiment, at least one but possibly two or more iterations are desirable if there continues to be a narrowing of the affected members' positions respecting the proposed allocation formula. Thus, in the event that the number of acceptable iterations has not been exceeded, which is shown as a “No” in response to decision step 407, the patent pool member(s) who according to their established threshold are affected by the proposed change(s) and who disagree with such amended allocations are able to express the basis for their disagreement in accordance with step 403, described above. Additionally, these members are encouraged to consider and submit yet additional allocation formulas in accordance with step 404, which are in turn disbursed to some or all of the members in accordance with the above-described step 405, whereupon any member affected by a percentage amount greater than his, her or its threshold may decide whether they still disagree pursuant to decision step 406.

According to a preferred embodiment, with each successive iteration, the pre-agreed maximum number of days for an affected party to respond could decline in order to focus and narrow the issues in an analogous manner to the way that shorter page limits and reduced timeframes for filing reply and sur-reply briefs tends to focus the parties' arguments in a traditional litigation context. As indicated above, all of these proffers are retained by the system so that they can be considered by others (e.g., by the “unaffected but nonetheless interested and knowledgeable” parties in step 412, a third-party arbitrator in step 417 or a third-party fact finder in the event that litigation ensues subsequent to the withdrawal of a party from the patent pool pursuant to decision step 420) should such dissenting affected parties be unable to resolve the disagreement among themselves.

In a preferred embodiment, one step of this alternative dispute resolution process is involving any patentees whose percentage interests in the allocation are unaffected by such disagreement (or affected by a percentage that is less than the threshold used in step 405). As noted above, the system views these parties as being both interested and knowledgeable inasmuch as by their membership in the pool, they are by default patent owners of related art. This fact is likely to afford these individuals with an uncommon level of experience in the field, with the commonly understood meaning of the terminology used, and of the technologies involved. Moreover, because these individuals are either financially unaffected by the outcome such disagreement or affected by an amount that is less than the percentage threshold used in step 405, they are likely to be relatively unbiased as to the outcome. This combination of attributes renders them uncommonly good third-party decision influencers, and the invention takes advantage of this fact by permitting them to express their position as described below.

Thus, a “Yes” response in decision step 407 indicates that the number of permitted—or as the case may be, perceived as being productive—iterations of proffers by and between the dissenting parties has been reached without concluding an agreement on an acceptable allocation formula.

In this event, step 408 represents the patent pool operator preparing a written synopsis concerning the basis of the residual disagreement and summary of the alternative positions being advocated by any dissenting members. This synopsis may also include the operator's recommended allocation formula which, depending on the terms of the patent pool participation agreement, may either reiterate the original intended allocation formula (i.e., the allocation pursuant to step 401) or may permit the operator to change this position and support an alternative one (i.e., a formulation of its own creation or one being proffered by a dissenting member) if the operator so elects.

Thereafter, step 409 illustrates that each of the remaining dissenting parties may be allowed to review the synopsis prepared by the operator, and—as illustrated by step 410—be given an opportunity to comment thereon and/or emphasize certain elements thereof. Although the parties may revise these conditions in the patent pool participation agreement, one preferred embodiment assumes that each dissenting member's comments in step 410 may be subject to certain pre-agreed page limitations and rules such as prohibitions against introducing any new argument, evidence or support that was not previously disclosed in the briefing made during step 403.

As shown in FIG. 4, decision step 411 reflects a determination of whether there are any members of the patent pool who are, as described above, either financially indifferent or “relatively unaffected” financially based on the result of applying the alternative allocation formulas on their share of royalty earnings falling below the “X %” level of step 405. To the extent that there are no such members left in the patent pool, as indicated by a “No” response to decision step 411, then the system skips steps 412 through 415, and moves to a determination of whether any dissenting participant(s) wish to submit the matter to an outside arbitrator (as shown in decision step 416) in lieu of accepting the operator's recommended allocation at the conclusion of step 408.

Alternatively, a “Yes” response in decision step 411 indicates that there are indeed one or more pool participants whose allocable share of royalty earnings from the patent pool would change “less than X %” irrespective of which alternative allocation proffer is ultimately selected. In this event, step 412 indicates that the materials illustrated by steps 408 and 410 (namely the synopsis of the dissenting all members' positions, their respective proffers and the patent pool operator's recommended allocation schema) are submitted to all such financially indifferent or relatively unaffected members. In a preferred embodiment, such materials could contain hypertext links to appropriate backup materials including but not limited to supporting evidence provided by one or more of the dissenting members and other exhibits, thereby permitting the financially indifferent or relatively unaffected members reviewing these materials to conduct background research into the parties' briefing of the allocation issues if they so desire.

As discussed above, one preferred embodiment contemplates that intellectual property owners (including but not necessarily limited to patent owners 203(a)-203(c), or relevant portions thereof) may use computer workstations 109(a) in communication with server 111, rules and algorithms 108(b) and activity log 108(d) to vote on certain matters of governance and key decisions. Rectangle 413, entitled “Poll Such Unaffected Pool Participant(s) as to Their Position on the Disputed Issue(s),” illustrates one use of such assessment and/or polling functionality to facilitate a vote (preferably by the financially indifferent or relatively unaffected users of the system) concerning which of the alternative allocation proffers these users feel is the most fair. In turn, decision step 414 asks “Is This Vote Conclusive in Any One Direction Respecting the Issue(s),” which indicates that in one preferred embodiment the system may ascertain whether the minimum vote—which in a preferred embodiment is an arithmetic majority of those members having the right to vote concerning this matter—was attained for any one proposed allocation method.

In terms of practicing these (and other related) aspects of this disclosure involving interactive communications (and in a preferred embodiment voting over the Internet), those skilled in the art will appreciate that a number of systems have been previously proposed for online voting as well as online dispute resolution. Without limitation, these include systems and methods such as described in the aforementioned '029 patent, '045 patent and '900 patent, as well as systems sold by a number of commercial vendors (including assignees of the foregoing patented systems) for establishing a workflow, disseminating documents among interested parties, soliciting online voting from such interested parties, tabulating, analyzing and reporting the results thereof, and for performing dispute resolution, many of which systems operate over the Internet.

In the event the response in decision step 414 is “No,” then the vote of such financially indifferent or relatively unaffected pool participants was inconclusive (according to the minimum standards for such vote to which all pool participants agreed in advance). In this event, as shown on FIG. 4B, which is a continuation of FIG. 4A, the dissenting members may be obligated by the terms of the patent pooling agreement to refer the issues to arbitration.

Alternatively, a “Yes” response in decision step 414 on FIG. 4A indicates that indeed the minimum vote for one of the proposed allocation methods was attained in such poll. In this case, turning next to FIG. 4B, this outcome is communicated by the pool operator to any dissenting pool participant(s) whose allocable share of the royalty earnings would under that alternative be “less than X %” (as in step 405) lower than the share of the royalty earnings to which that party was advocating in their proffer (e.g., the proffer that was not accepted by the financially indifferent or relatively unaffected members of the patent pool).

In this event, as indicated by decision step 416, a preferred embodiment contemplates that such dissenting party or parties may have a limited number of days in which to decide if they wished to submit the issue to an outside arbitrator. It will be apparent that a “No” result in decision step 416 may be attained either by (1) receiving a response from the dissenting party or all of the dissenting parties that such dissenter(s) will accept the vote of the financially indifferent or relatively unaffected members of the patent pool as binding; or by (2) the expiry of the pre-agreed time for such party or parties to affirmatively elect arbitration. As indicated therein, as soon as practical following such result, the patent pool operator may proceed to distribute the funds held in such pool in accordance with the allocation formula that received such conclusive vote of the financially indifferent or relatively unaffected pool participants. This is illustrated by step 419, entitled “Distribute Funds in the Pool According to the Allocation Formula,” which is more particularly described below.

Alternatively, in the event that such dissenting party or parties affirmatively elected to institute arbitration prior to the end of the pre-agreed maximum number of days in which to make such election—as indicated by a “Yes” in decision step 416—then the issue(s) could be heard by an arbitrator. Similar to the case in which such vote of the financially indifferent or relatively unaffected pool participants was inconclusive (as described above with respect to a “No” in decision step 414 of FIG. 4A), the step of conducting arbitration in order to resolve such disagreement(s) concerning the appropriate allocation formula is illustrated by step 417.

As will be apparent to persons of ordinary skill in the art of commercial negotiations, there exist a wide variety of arbitration methods and procedures including among other things applicable evidentiary rules, procedures regarding selection of the arbitrator(s), rules regarding the method and length of written briefs by the parties, and stipulations concerning whether the arbitration is voluntary or compulsory, as well as whether the findings of the arbitrator will be binding on the participants or subject to subsequent judicial appeal. These and other variables may be established in advance as part of the patent pool participation agreement, and may vary between patent pools depending on negotiations with prospective members of such pooling arrangement and the preferences of the pool organizer/operator.

A preferred embodiment anticipates that the pooling agreement by and between the parties who are members of the pool may include a compulsory arbitration provision to the extent that the foregoing attempts to resolve a disagreement concerning allocation of the royalty earnings prove unsuccessful and at least one of the dissenting parties elects to arbitrate such issue(s). In a preferred embodiment, the parties may be restricted to the positions and evidence presented or relied upon in the aforementioned synopsis of the basis of the residual disagreement prepared by the patent pool operator (step 408) and each dissenting party's explanation, if any, of the basis for disagreement with such synopsis (step 410). Respecting selection of an arbitrator, in a preferred embodiment, the patent pool operator may suggest a list of names equal in number to at least one plus the actual number of dissenting members in such patent pooling arrangement, each such prospective arbitrator having experience in patent litigation and licensing disputes.

Each dissenting party, in one non-limiting example, may have the right (but not the obligation) to strike from such list one of the names, and in the event only one arbitrator's name remained following this process, then that individual could be designated as the arbitrator. Alternatively, if two or more individuals' names remain thereafter, then the dissenting member of the patent pool with the largest discrepancy between the economic effect to them if their proffered allocation formula (from step 410) was selected and the effect of the operator's proposed formula (from step 408) may be allowed to strike another name. If two or more individuals' names remained followed the foregoing reduction in the number of prospective arbitrators, then the party with the next largest discrepancy may be permitted to strike a single name, and so on until only one individual's name remains on the list; and that individual may be designated as the arbitrator.

Additionally, in the event that an allocation formula received a conclusive vote of the financially indifferent or relatively unaffected pool participants (as indicated by a “Yes” in the above-described decision step 416), the arbitrator may take this fact into account for whatever persuasive value he or she deems appropriate. Once he or she has reached a decision on the issue(s) in dispute, as indicated by step 418, the arbitrator shall communicate his or her decision to all parties to such dispute. In a preferred embodiment, the arbitrator may render this decision in writing, setting forth therein the reasons for such decision. Although in a preferred embodiment (which as described above involves a dynamic process for allocation of royalty earnings), the decision of the arbitrator may be binding on all of the parties. Although not shown in the drawings, in the event the process for allocating royalty earnings is based on a static formula (e.g., one that is not subject to review and adjustment), then it may be preferable that the decision of the arbitrator be subject to judicial review in the event that one or more pool participants so elects.

In accordance with the findings and recommendation of such arbitrator—or based on the uncontested result of the system described in steps 402, 406 or 416, as noted above—the patent pool operator may distribute the royalty earnings of the patent pool according to the allocation formula thereby concluded. The distribution of such earnings is illustrated by step 419.

Although the costs of the optional dispute resolution process illustrated in FIG. 4 may be allocated to the pool participants in accordance with a formula agreed to by and between such participants and the pool organizer/operator, in a preferred embodiment, all of these may be borne by the pool participants pro rata to their share of such distributable royalty earnings if the matter is resolved prior to commencing arbitration (e.g., at or before step 416). However, in a preferred embodiment and as an added incentive to resolve such disagreements without invoking arbitration, the arbitrator may be asked to allocate the costs of such dispute resolution among the participants and the written opinion of step 418 may include his or her recommendation in this regard. Thus, to the extent possible, in a preferred embodiment, the costs of the foregoing dispute resolution process may be deducted from each pool participant's share of such royalty earnings as an integral part of carrying out step 419.

A preferred embodiment recognizes the possibility that a pool participant may so vehemently disagree with the resolution of the foregoing described process that he, she or it may elect to withdraw from the pooling arrangement. Whether or not the other participants and/or the pool organizer/operator are willing to condone such right to withdraw from the pool may be addressed in advance in the pooling agreement. In accordance with a preferred embodiment, wherein such right of withdrawal is included provided that the withdrawing member has fully availed itself of the foregoing dispute resolution process, decision step 420 illustrates the question “Does a Dissenting Party Wish to Withdraw from the Pool Now?” As shown, in the event that the dissenting member does not wish to withdraw (indicated by a “No”in decision step 420), the foregoing procedure as set forth in FIG. 4 may be repeated until the last validly issued patent in the pool expires or is adjudicated as being invalid. This is illustrated by step 421.

Alternatively, as illustrated by step 422, in the event that one or more dissenting member wishes to withdraw from the pool at the conclusion of the foregoing process (as indicated by a “Yes” in decision step 420), the procedure set forth in FIG. 4 may be adjusted in order to take into account the patents owned by any withdrawing patent owner, whereupon this procedure may be repeated until the last validly issued patent in the pool expires or is adjudicated as being invalid. As described previously, a preferred embodiment contemplates that a portion of the patent pool may be set aside and retained for patent owners who are not pool participants, with such set-aside funds utilized in the manner described above.

Next turning to FIG. 5, it will be observed that a flow diagram is provided in order to illustrate the optional integration of a means for adjusting a royalty payment (and as a derivative matter, the corresponding allocation of royalty earnings). In accordance with the principles described herein, this process permits any one of patent users 206(a)-206(c) to remove there from one or more patents contained within the patent pool (or for which reserves have been established therein) that such patent user prefers to forego licensing on the basis of its belief that such patent(s) is a “substitute.”

With respect to FIG. 5A, it will be observed that step 501 indicates the announcement, presumably by the operator of the patent pool, of the royalty payment that is due from a licensee, which royalty statement may preferably be accompanied by a list of the patents included therein. Depending on the preferences of the licensee and/or practices of the patent pool operator, this list of patents may also be accompanied by the respective share of the patent pool earnings that each patent entitles its respective owner to receive, although under one preferred embodiment of the invention such allocation amounts might not be disclosed in order to more clearly segregate the process of licensing and paying royalties from the prior process of forming the pool and the subsequent process of allocating royalty earnings among the owners of the patents in such pool.

Decision step 502 illustrates that within a certain period of time (which period may preferably be pre-agreed and confirmed in the license agreement by and between the licensee and the licensing agent on behalf of the patent pool), the licensee may determine if it reasonably believes that any patent(s) within the patent pool are substitutes. Thus, if the result in respect to decision step 502 is “Yes,” this is understood to mean that the licensee believes that one or more patents are substitutes; and a “No” answer refers to instances wherein the licensee does not contend that any of such patents are substitutes.

In the event that the licensee does not contend within a pre-agree period of time that any of the patents are substitutes (e.g., when the answer in decision step 502 is “No”), the royalty payment made by such licensee shall be presumed final, and it may be distributed in accordance with the allocation and distribution procedures determined by and between the pool operator and the various pool participants. This is illustrated by rectangle 520, entitled “Assess Royalty Due from This Licensee in Accordance with Such Determination,” which step is more particularly described below.

Returning to decision step 502, it will be observed that a “Yes” response indicates that the licensee believes that one or more patent included in the pool is a substitute. This can be accomplished in a wide variety of ways depending on the desires of the licensee, patent pool operator and owners of patents comprising the patent pool, and may include various levels of detail. In a preferred embodiment, this may be achieved by using a mouse on a computer to place a check in a box that is provided for the purpose of allowing the licensee to designate purported substitute patents within a list of all of the patents that are included in the patent pool, generally as illustrated in FIG. 6A below (referring, for example to check box 607(b), 607(c) and the like).

Continuing with a discussion of FIG. 5A, decision step 503, entitled “Does Licensee Wish to Omit Such Substitutes and Adjust Royalty,” illustrates that when a licensee determines there to be one or more substitutes for a patent included in the patent pool, it may also determine whether it might be preferable to license such substitutes or remove them from the pool and correspondingly reduce his royalty payment. As described above, there may be legitimate business reasons that a licensee voluntarily elects to license a patent that it otherwise might reasonably contend to be a substitute. One preferred embodiment of the invention takes this fact into account and, if the answer in respect to decision step 503 is “No,” this will be understood to mean that the licensee does not elect to omit any such patents from the scope of his license irrespective of the fact that he has designated them as being substitutes. Accordingly, the licensee's royalty payment obligation will remain unchanged and in this case, as illustrated in FIG. 5A, the work flow may again skip all of the intervening steps and proceeds directly to step 520.

Alternatively, if the response in respect to decision step 503 is “Yes,” this will be understood to mean that the licensee would prefer to remove such substitute patent(s) from the pool, presumably with the hope of either correcting an error or reducing its overall financial exposure. The process of removing any substitutes from the grant clause of the patent pool with respect to such licensee can be accomplished in any of a variety of ways; and in a preferred embodiment this could be achieved by using a mouse on a computer to remove the check mark in the box indicating which patents are included in the pool, generally as illustrated in FIG. 6A below (referring, for example to check box 606(c)) and FIG. 6F (referring therein to check boxes 638 and 641(a), and the like).

Rectangular box 504 illustrates that within a pre-determined number of days, and preferably immediately upon making the determination that it could be preferable to forego licensing such substitute(s), the licensee may be obligated to identify its rationale for removing the specific patent(s) it considers to be substitutes, as such term is used herein. This can be accomplished in a wide variety of ways depending on the desires of the licensee, patent pool operator and owners of patents comprising the patent pool, and may include various levels of detail. In a preferred embodiment, this may be achieved by selecting from a pre-determined menu of options in a dialogue box that may appear in response to removing a check mark from the box associated with that patent being included in the patent pool. This process is illustrated in FIG. 6C, and is described in detail below.

Irrespective of whether this is achieved through use of these optional features of the system or in some other manner, in order to reasonably arrive at the result of decision step 503, the disclosures pursuant to step 504 could preferably include an identification by the licensee of one or more preferred substitutes (i.e., other patent(s), publication(s) or the like upon which the licensee proposes to rely, an explanation of the alternative to such intellectual property being needed by the licensee, etc.), and a claims chart in sufficient detail to explain why the patent(s) the licensee proposes to eliminate from the grant of the license on the patent pool and the calculation of royalties are believed to be a substitutes. A non-limiting exemplary form of claims chart is presented in FIG. 6E for carrying out this disclosure, and is described in detail below.

As will be evident to those who are skilled in the art, depending on how readily apparent it is that the patent at issue is a substitute, preparing such disclosure may involve considerably less than FIG. 6E, but in some cases it may involve considerably more in order to fulfill the duty of good faith and candor that a preferred embodiment assumes may be imposed on both the licensee and patent owner under the terms of the Patent Pool License Agreement. Providing this type of disclosure can involve a considerable expenditure of money and effort both on behalf of legal and technical personnel, and can take away from other competing priorities. For example, a number of companies commonly engage outside law firms to perform so called “Freedom to Operate” (FTO) or “Right to Use” studies on their behalf in order to identify patents that may raise a potential issue of infringement, as well as to identify relevant prior art and background technical information, particularly when planning to introduce a valuable product or service to the marketplace. Moreover, once there has been an assertion of infringement by a patent owner, many large companies feel obligated to engage outside counsel to prepare an advice of counsel opinion, such as a Non-Infringement Analysis,” both in order to provide guidance concerning the best defenses against such allegations and, in any case, to help minimize the risk of being liable for willful infringement in the event litigation ensues.

These sorts of analyses can cost tens of thousands of dollars, or even more in the instance of complex patents, which expense might in some instances exceed the cost of simply licensing rights under the substitute(s) in the first place. In accordance with one of the objects of a preferred embodiment of the invention, which is to reduce associated costs of licensing and principled intellectual property compliance, a preferred embodiment of the invention anticipates that the step illustrated by step 504 may involve several iterations (each presumably with an increasing degree of detail), such that certain portions of this step (e.g., preparation of a detailed claims chart) may be deferred until a later point in the workflow illustrated in FIG. 5, in response to the interaction between parties thereby illustrated. Thus, it should be understood that the point of connection of step 504 is optional and that it may be relocated in the workflow or subdivided into multiple tasks with increasing levels of detail and incorporated at multiple points in the workflow.

Step 505 indicates that upon receipt of the foregoing identification of any patents that a licensee wishes to remove from the grant of the license on the patent pool, the system may calculate the royalty payment amount by removing there from such deemed substitute patent(s). In certain instances, such as when the royalty payment allocation formula did not give any, or any significant weight to such patents, it may be possible that a de minimus portion of the total royalty amount may be affected. Thus, in the hypothetical case illustrated in the claims chart shown in FIG. 6E, the actual royalty amount might change by less than $1 given how utterly remote it is that the alternative covered by the substitute patent in question may be employed. Thus, in this instance, the licensee may determine that the marginal cost is so low that even given the remote benefit it may be relevant, the savings in time, administrative costs and risk of being “held up” by the patent owner at some point in the future, may well justify his continuing to include such patent within the pool.

Although it will be understood that there are a number of ways to communicate this economic effect to the licensee, the system may provide this information in response to receiving an indication that the licensee is considering removing a patent from the patent pool, and before this information is communicated to the affected patent owner. This process is illustrated in FIG. 6D, which is described below.

Decision step 506 next asks “Does Licensee Wish to Omit These Patents from the Scope of the Grant?,” which will be understood as being essentially the same question as presented in decision step 503, except this time in the context of such licensee being informed of the approximate royalty savings associated therewith. Button 630 in light of the information disclosed in text 629 of FIG. 6D illustrates one preferred embodiment of this step; and is described below in detail. With respect to the corresponding workflow illustration of FIG. 5A, if the answer in respect to decision step 506 is “No,” this will be understood to mean that the licensee does not elect to omit such patents that he could conceivably contend as being substitutes (corresponding to his selection of button 631(a) or 631(b) in FIG. 6D). In this instance, as illustrated in FIG. 5, the flow once again skips all of the intervening steps and proceeds directly to step 520.

Alternatively, if the licensee concludes that the marginal expense of licensing one or more of such substitutes outweighs (in the sole discretion of the licensee) the perceived marginal benefit there from, then a “Yes” response to decision step 506 is dictated. This decision is communicated through the system to the owner of any patent that the licensee wishes to remove from the scope of the patent pool license grant. This step is illustrated by rectangle 507 and the selection of button 630 in FIG. 6D. Depending on the agreed terms of the license pool, this communication may be accompanied by a description of the reasons why; and as noted above, a preferred embodiment anticipates that at least some explanation is given for such decision.

Upon receipt of this communication, as illustrated by decision step 508, the affected one of patent owners 203(a)-203(c) may need to decide whether he disagrees that his patent is merely a substitute. In certain instances (i.e., where concluding a license would result in double-licensing the patent, as illustrated by FIG. 6C and shaded box 624 therein, or where the sole purpose of the patent was to cover a alternative embodiment that the patent owner knows is not being employed by the licensee), then the determination to agree with the removal of the patent from the patent pool as it pertains to this licensee (e.g., this one of patent users 206(a)-206(c)) may be very easy. In other cases, such a where the patent owner is not familiar with the relevant facts, the disclosures (for example, such as those described above with respect to step 504, and illustrated in FIGS. 6C and 6E) may be instrumental to the affected patent owner arriving at a well reasoned and principled conclusion.

As illustrated, if the answer in respect to decision step 508 is “No” (e.g., the patent owner does not disagree that his patent is a substitute, as such term is herein defined) then the workflow once again may skip all of the intervening steps and proceed directly to step 520 of FIG. 5B, denominated “Assess Royalty Due from This Licensee in Accordance with Such Determination.” Thus, in this instance, the royalty payment may be amended in order to reflect the removal of the substitute patent(s) from the scope of the license grant for this patent user 206(a)-206(c).

Alternatively, a “Yes” response to decision step 508 is dictated if the patent owner believes that the licensee is incorrect in assessing the subject patent to be a substitute, or if the patent owner contends that its patent blocks what he or she believes to be relevant element(s) of another patent that the patent user has either not deemed as a substitute (or optionally which the patent user has deemed a substitute but has not elected to remove from the patent pool). As illustrated by step 509, in this case, this information may be communicated through the system to the licensee, together with an explanation for why the patent owner believes that a license could be appropriate.

The amount of information communicated by the applicable one of patent owners 203(a)-203(c) in step 509 may vary substantially depending on the preferences of the patent owner, licensee and/or patent pool operator. In a preferred embodiment, the explanation may contain a description of the portion of the licensee's device, system or practice that the owner believes employs (or should employ) the subject matter of such patent. Additionally, in a preferred embodiment, the patent owner may be encouraged to describe why he contends the patent(s) that the licensee proposes to remove are not merely a substitute (or why the patent owner believes that such licensee could benefit by licensing these rights for the purpose of relieving a potential blocking patent and/or incorporating the subject matter of the subject patent in the future).

It will be apparent that one of the benefits of this interchange is that the patent owner may be in a position to advocate the advantages of his patented technology being employed by the licensee. Thus, in addition to helping avoid misunderstandings borne out of poor and/or imprecise communications, improvement technologies can be explained in the hopes that the licensee may be persuaded to “pick up the option” of licensing the new technology for the purpose of possibly incorporating it in the future. As noted below, this could benefit both parties. The licensee may become better informed of new technologies that may improve his earnings or reduce his costs. And at the same time, the patent owner may achieve access to promote his innovations directly (albeit electronically in a preferred embodiment) to the firms who should have the greatest interest in using them. Moreover, given the dynamic nature of the allocation of royalties in a preferred embodiment of the invention, in the case the licensee does in fact become persuaded to adopt the new technology, the patentee may become entitled to an increased share of the royalty earnings of the patent pool as the use of his alternative increases and the prior supplanted alternative correspondingly declines.

Just as incorporation and use of a simplified claims chart may be preferable with respect to communicating the licensee's position, so to may a responsive claims chart in generally the same form as presented in FIG. 6E be preferable in highlighting areas where the patent owner wishes to draw attention to why the licensee should consider licensing his patent. Although not shown in either one of FIGS. 5A or 6E, it will be apparent that either by mutual agreement or as a result of rules established by the patent pool operator, the licensee and patent owner may have one or more subsequent discussions and/or continue to exchange information, either though the system or in the form of direct discussions by telephone, email, letter or in person, and in an effort to explore the possibilities and resolve a common view respecting whether or not the subject patent(s) are substitutes. Additionally, as illustrated by FIGS. 6G, 6H and 6I, a preferred embodiment of the system may provide one or more ways in which this interchange may be structured and the results normalized; and third-parties such as other ones of patent owners 203(a)-203(c) and/or patent users 206(a)-206(c) may comment on pertinent issues, the discourse and/or “rate” the parties' respective views. As more particularly describe herein, this may help persuade the parties to reach consensus and/or support other aspects of the process.

Returning to FIG. 5A, decision step 510 illustrates that after the licensee has had an opportunity to review the position advocated by the patent owner from step 509, then the licensee is preferably given an opportunity to change his mind and include the patent(s) as part of the pool or to continue to exclude them as unnecessary substitutes. As shown, decision step 510 asks: “Does Licensee Continue to Believe This Patent Is a Substitute?” As illustrated, if the response in respect to decision step 510 is “No” (e.g., the licensee concludes that the patent is not a substitute and/or is of sufficient benefit to him to incur the incremental cost disclosed in step 505), then the workflow may skip all of the intervening steps and proceed to step 520 of FIG. 5B, and in this case, the royalty payment is unchanged on the basis of retaining the patent(s) within the scope of the license grant on the patent pool.

Alternatively, if the licensee continues to believe the patent to be a substitute (and is unmoved by the arguments of the patent owner in step 509), then a “Yes” response to decision step 510 is dictated. In this case, this information is communicated through the system to the patent owner who, in a preferred embodiment, is given an opportunity to decide whether he wishes to use the system to try and overcome this assessment. This decision is illustrated by decision step 511, which reads “Does the Patent Owner Wish to Contest. This Characterization?” (e.g., referring to the continuing characterization of the patent as being a substitute and the decision by the licensee to remove it from the pool).

As illustrated, if the response in respect to decision step 511 is “No” (e.g., the patent owner concludes on the basis of what has transpired that it is not worth continuing to convince the licensee to take a license on the patent), then the workflow may skip the intervening steps and in move to step 520 of FIG. 5B, and in this case, the royalty payment (and the allocable share thereof to the patent owner) is reduced by virtue of removing such patent from the patent pool by this licensee. Alternatively, if the patentee elects to persist that his patent should be licensed by this licensee, then a “Yes” response to decision step 511 is dictated, and the system moves to step 512.

As previously discussed with respect to FIG. 4, a preferred embodiment may use those patent owners, if any, who will not be financially affected one way or the other by the outcome of this issue (e.g., whether or not the patent is characterized as a substitute as the licensee contends) as an informal advisory board to the licensing agent and both parties concerning the foregoing unresolved differences. This approach is anticipated to result in a variety of benefits, including among other things that by virtue of these individuals already being intimately familiar with patents, the field of use, and other art in the field, they may be uncommonly good decision influencers. Accordingly, this disclosure takes advantage of this fact by permitting these other patent owners to express their views in the manner described below.

As illustrated by decision step 512, the system first ascertains whether there are indeed any patent owners whose percentage interests in the allocation of royalty earnings may be unaffected by such disagreement concerning whether or not the particular patent is a substitute (or affected by a percentage that is less than a threshold level that has been agreed upon in advance by the pool participants and/or as established by the pool operator). To the extent that there are no such “financially disinterested” participants left in the patent pool, as indicated by a “No” response to decision step 512, then the system may skip elements 513 through 516, and move directly to a determination of whether any dissenting participant(s) wish to submit the matter to an outside arbitrator (as illustrated by decision step 517, described below).

Alternatively, a “Yes” response in decision step 512 indicates that there are indeed one or more pool participants whose allocable share of royalty earnings from the patent pool would change “less than X %” irrespective of whether the particular patent is removed from the patent pool on the basis of it being a substitute, as the licensee contends. In this case, step 513 indicates that the materials referenced with respect to steps 504 and 509 (namely the explanation of the licensee's and patent owner's respective positions concerning the matter) may be made available to all of such financially indifferent or relatively unaffected patent owners. In accordance with the above discussion concerning the benefit of such disclosures taking place in a series of steps in the hopes of not needlessly expending money on things that may not be required to achieve resolution, a preferred embodiment of the invention could permit a certain number of days for each party to revise and/or supplement their earlier positions and related disclosures, and perhaps provide for an opportunity for the exchange of responses and rebuttal-type argument, each side preferably being constrained in this process by certain pre-agreed page limits. Depending on the preferences of the respective parties and the patent pool operator, some limited discovery and/or use of third party experts may be also be permitted, but in a preferred embodiment this may not be necessary.

In a preferred embodiment, all of the foregoing materials may contain hypertext links to appropriate backup information including but not limited to supporting evidence provided by one or both of the dissenting parties and other exhibits, thereby permitting the financially indifferent or relatively unaffected patent owners who elect to review such materials to conduct background research into the parties' respective claims charts and written positions if they should desire to do so.

As noted previously, a preferred embodiment contemplates that the system includes polling functionality, thereby permitting these patent owners to vote on such matters. In this regard, step 514, entitled “Poll Such Unaffected Pool Participant(s) as to Their Position on the Disputed Issue(s),” illustrates the use of this functionality to facilitate a vote by the financially indifferent or relatively unaffected patent owners concerning the one or more instances where there is a residual disagreement over whether a patent is a substitute. In this regard it is worth noting that the issue to be decided is not whether the licensee is entitled to remove a patent from the pool—this being an inalienable right of the licensee at all times. Rather, what is at issue is the designation of a patent as being a substitute, as such term is defined above for the purposes of this disclosure, and further it being understood that in a preferred embodiment, the outcome of such vote shall be advisory only and not binding on either of the parties.

Turning now to FIG. 5B, which is a continuation of FIG. 5A, decision step 515 asks “Is This Vote Conclusive in Any One Direction Respecting the Issue(s),” which indicates that the system may ascertain whether the minimum vote—which in one preferred embodiment is an arithmetic majority of those patent owners having the right to vote concerning this matter—for either position respecting the issue of such patent being (or not being) a substitute was attained. Thus, in the event decision step 515 is “No,” then the vote by such financially indifferent or relatively unaffected patent owners was inconclusive (according to the minimum standards for such vote to which all pool participants agreed in advance or as established by the pool operator). As illustrated therein, in this event, in one preferred embodiment of the invention the parties could be given an opportunity to decide if they wished to submit the issue to a mutually acceptable third-party sitting as an arbitrator.

Alternatively, a “Yes” response in decision step 515 on FIG. 5B indicates that indeed the minimum vote for one position respecting the issue was attained in such poll, in which case, step 516 illustrates that this result is communicated by the pool operator to either the patent owner or the licensee, depending upon which of them was disadvantaged by such result. Thus, it could normally be anticipated that if the majority of the financially disinterested patent pool participants concluded that the patent was a substitute, this conclusion could be communicated to the patent owner; and alternatively, if a majority of the pool participants were of the view that the patent was not a substitute as it pertains to the licensee, then the determination in this regard could be communicated to the licensee—in both cases based on the hope that having received this input by patent savvy, knowledgeable, interested (but financially disinterested) parties might help them to see the logic of the other parties' perspective as it pertains to such matter and to a speedy and cost-saving resolution.

In this event, as indicated by decision step 517, one preferred embodiment contemplates that such dissenting party or parties could have a limited number of days in which to decide if they wished to submit the issue to an outside arbitrator. As indicated therein, as soon as practical following the earlier of (1) receiving a response from the dissenting party that he could accept the vote of the financially indifferent or relatively unaffected members of the patent pool as binding; or (2) the expiry of the pre-agreed time for such party or parties to affirmatively elect arbitration (collectively indicated by a “No” in decision step 517), the patent pool operator could promptly proceed to collect from such licensee the royalty payment calculated in accordance with the treatment of such patent (i.e., continuing to incorporate it in the pool or treating it as though it were a substitute concerning which the licensee desires to forego licensing) that received such conclusive vote of the financially indifferent or relatively unaffected pool participants. This step is illustrated by rectangle 520, entitled “Assess Royalty Due from This Licensee in Accordance with Such Determination,” which is more particularly described below.

Alternatively, in the event that such dissenting party or parties affirmatively elects to institute arbitration prior to the end of such pre-agreed maximum number of days, which is represented by a “Yes” in decision step 517, then such disputed issue(s) could be heard by an arbitrator. As shown in FIG. 5B, this step of conducting an arbitration process in order to resolve such disagreement(s) concerning whether a patent is indeed a substitute is illustrated by step 518. It will be readily appreciated that these resolution processes (and the similar procedures disclosed elsewhere in a preferred embodiment, including but not limited to FIG. 4) are increasingly time-consuming and costly. Inasmuch as no party should avail themselves of the implied escalation inherent in them unless the issues involved are truly substantive in nature, a preferred embodiment anticipates that the patent pooling participation agreement as well as the license agreement respecting the patent pool may set forth an escalating cost schedule associated with each such process. In addition to helping defray all of the related expenses of the patent pool operator and any professionals working to help amicably resolve such disputes, one objective for such escalating cost schedule in a preferred embodiment is to help ensure that a decision to pursue a matter even in the face of an adverse outcome from the earlier (and less consuming/less costly) means of resolving the issue is, at a minimum, not frivolous or fundamentally non-substantive.

Returning to step 518, as will be apparent to persons of ordinary skill in the art of commercial negotiations, there exist a wide variety of arbitration methods and procedures including among other things applicable evidentiary rules, procedures regarding selection of the arbitrator(s), rules regarding the method and length of written briefs and oral argument by the parties, and stipulations concerning whether the arbitration is voluntary or compulsory, as well as whether the findings of the arbitrator may be binding on the participants or subject to subsequent judicial appeal. These and other variables may be established in advance and expressly disclosed in both the patent pooling participation agreement as well as the license agreement respecting the patent pool, and may vary between patent pools depending on negotiations with prospective members of such pooling arrangement, various licensees and the preferences of the pool organizer/operator.

A preferred embodiment anticipates the use of compulsory arbitration to the extent that the foregoing attempts to resolve a disagreement concerning whether or not a patent is a substitute, and further contemplates such arbitration process may be binding as it pertains to the issue of whether or not the subject matter of a patent is being used by the licensee but non-binding in the event the issues pertain to validity or enforceability of the alleged substitute patent. In a preferred embodiment, the parties may be restricted to the positions (but not necessarily limited to the evidence) presented or relied upon in the aforementioned step 513. Thus, in accordance with one object of a preferred embodiment of the invention, which is to reduce the overall legal expense associated with resolving patent disputes, it will be understood for example that in the event the rules respecting step 513 encourage formal discovery (which is admittedly not preferred), then less additional supplementation could be allowed in respect to garnering evidence for the arbitration than if such rules associated with step 513 did not include formal discovery procedures and related tools. As a further example, it will be understood that in the event the rules respecting step 513 severely limit the length of the party's briefs (as is preferred), then greater supplementation could be allowed in respect to the latitude permitted in briefing the issues.

Respecting selection of an arbitrator for the procedure illustrated by step 518, in a preferred embodiment, for disputes the outcome of which involves a swing of less than $100,000 (or some other pre-agreed amount) in royalties, the patent pool operator may suggest three (3) names of prospective arbitrators, each preferably having experience in patent litigation and the subject matter of the patent in dispute. Both the licensee and the patent owner may then have the right (but not the obligation) to strike one individual and the remaining individual shall serve as a sole arbitrator. In the event that more than one name remains after each party has had an opportunity to strike one name, then the party who elected arbitration in decision step 517 may select the sole arbitrator from the remaining two or more names). In the event the outcome of the dispute involves a swing that is in excess of the aforementioned pre-agreed amount, then the parties may adhere to the same process except that the patent operator may initially recommend the names of five prospective arbitrators, each party may be permitted to remove one and the remaining three (or three selected by the party who elected arbitration in decision step 517 from the remaining 4 or more) may serve as a 3-person arbitration panel.

Additionally, in the event of a conclusive vote by the financially indifferent or relatively unaffected pool participants (as indicated by a “Yes” in the above-described decision step 515), the arbitrator may take this fact into account for whatever persuasive value he or she deems appropriate. Once the arbitrator(s) has(have) reached a decision on the issue(s) in dispute, as indicated by step 519, the arbitrator(s) shall communicate this decision to all parties to such dispute and the patent operator. In a preferred embodiment, the arbitrator may render this decision in writing, setting forth therein the reasons for such decision. As noted above, in a preferred embodiment, the decision of the arbitrator may be binding on all of the parties except in the event it pertains to validity or enforceability, in which cases the decision of the arbitrator may be subject to judicial review in the event that the losing party so elects.

In accordance with the findings and recommendation of such arbitrator—or based on the uncontested result of the system described in steps 508, 510, 511 or 517, as described previously—the patent pool operator may assess the royalty payment from the licensee (i.e., with or without the contested substitute, as appropriate) and distribute the royalty earnings of the patent pool pursuant to the allocation formula agreed upon by and between the participants of such patent pool. This royalty assessment and corresponding distribution of such royalty earnings (taking into account the outcome of the appeals process illustrated in FIG. 4, if necessary) is represented by step 520.

In most instances, it is anticipated that this may conclude the issue of which patents are in fact incorporated into the royalty payment due under the license agreement with the patent pool. This is illustrated on FIG. 5B by the line entitled “Not Applicable” emanating from decision step 521. It is anticipated that a licensee's products, practices and processes incorporating the patents in such pool are likely to change over time, inherently raising the possibility that certain patents that were once substitutes may become essential, and possibly vice-versa. Other changes may occur over time as the relevant technologies change and mature; and as new patents may be added to the pool. In order to take into account such changes and the dynamic nature of business and the use of technology, as illustrated by rectangle 532, it is anticipated that in a preferred embodiment of the invention, the foregoing procedure (e.g., the optional procedure described above with respect to FIG. 5A and 5B) may be available to the licensee each time that a royalty payment becomes due, thereby invoking the invoicing of royalties pursuant to the license agreement shown in step 501.

To the extent that the license agreement permits one or both parties to appeal any holdings of the arbitration process described above with respect to step 518, then a party whose position has not prevailed through the foregoing procedure may be entitled to institute a lawsuit seeking to vindicate such position through litigation (including any further appeals to the Federal Circuit or the appropriate court of appeal at the time) as a matter of last recourse. Under a preferred embodiment, such recourse to the traditional judicial system may be precluded by contract unless and until the full measure of the alternative dispute resolution process set forth above has been exhausted, including but not limited to the arbitration of step 518. Decision step 521 asks, “Which Party Has Prevailed?” referring to such arbitration process.

In the event that the patent owner has prevailed, as illustrated by oval 522, then decision step 523 inquires whether the licensee (i.e., the unsuccessful party in such earlier arbitration process) wishes to appeal such arbitration decision through filing a lawsuit seeking to overturn such result. To the extent the answer is “No,” then all of the remaining intervening steps may be skipped and, as described above with respect to step 532, the procedure is complete but remains available until the expiry of the last validly issued patent in the pool expires.

Alternatively, to the extent the response to decision step 523 is “Yes,” it will be understood that this indicates the preference of such licensee to seek to overturn such decision. In this case, as illustrated in step 524, the terms of the license agreement in a preferred embodiment may require the licensee to pay into a reserve account established by the pool operator for this purpose all of the license fees to which the patent owner could otherwise be entitled under the allocation formula of the patent pool were the licensee to abide by the outcome of the arbitration process. The proceeds of this reserve account may be paid, together with interest thereon, to the patent owner in the event he prevails in such litigation (as illustrated by a “Yes” answer to decision step 525 and corresponding step 526). Additionally, as indicated in step 526, in the event the patent owner prevails in such litigation, that owner may also be entitled to retain any judicial awards (including collection of attorneys fees and punitive damages on account of a finding of willfulness), and the licensee may be precluded from again raising this issue. Similarly, should the licensee prevail in such subsequent litigation, all of the funds held in such reserve account, together with interest thereon may be returned to the licensee as illustrated by a “No” answer to decision step 525 and step 531.

Returning to oval 527, it will be observed that this illustrates the workflow in the event the licensee prevails in the arbitration process shown in step 518. In this instance, decision step 528 inquires whether the patent owner (i.e., the unsuccessful party in such arbitration) wishes to appeal such arbitration decision through litigation. To the extent the answer is “No,” then all of the remaining intervening steps may be skipped and, as described above with respect to step 532, the procedure is complete but remains available until the expiry of the last validly issued patent in the pool expires. Alternatively, to the extent the answer to decision step 528 is “Yes,” it will be understood that this indicates the preference of such patent owner to seek to judicially overturn such ruling.

In this case, as illustrated in rectangle 529, the terms of the license agreement in a preferred embodiment may be that if the aforementioned arbitration process results in a holding by such arbitrator (or arbitration panel) that the patent is invalid or unenforceable, then until the outcome of such litigation seeking to vindicate the validity and/or enforceability of such patent is concluded, the patent pool operator may preferably suspend billing for any further royalties on behalf of this patent from any licensee and may correspondingly withhold all further allocations of royalty earnings from the patent pool with respect to this patent. The prospect that the licensee prevails in such litigation is illustrated by a “Yes” answer to decision step 530 and the corresponding step 531, indicating that in this case the licensee may retain any judicial award, the rules of issue preclusion may apply against this patent owner and the patent may be permanently removed from the patent pool in the event it is judicially determined to be invalid or unenforceable. Alternatively, the possibility that the patent owner prevails in this action is illustrated by a “No” answer to decision step 525 and step 531.

As noted above with respect to FIG. 2, (214 and 215), under a preferred embodiment described herein, in the event that litigation ensues (irrespective of which party brings it), the patent pool operator may be expected to testify as a fact witness, if so requested, and anticipated to testify on behalf of the patent pool, describing therein the nature of the patent pool, the multiple layers of alternative dispute resolution to which the parties submitted (or were required to submit but ignored) prior to pursuing such judicial resolution, and attaching copies of all documents generated in such process in order to give the court (directly or as introduced through an expert) an opportunity to take such efforts into account for whatever persuasive value the court (or the fact finders) deem it to have, and both parties shall waive in advance any objection to such testimony. In accordance with one of the objects of a preferred embodiment of the invention which is to reduce abusive litigation, “hold-ups” and “rip-offs,” it is anticipated that such testimony by the pool operator may serve the parties who have acted in a fair and principled manner, and correspondingly be persuasive to the court and the jury respecting any party who has not conducted their affairs in this manner. Moreover, even in the instance of “close calls,” where both parties have conducted themselves honorably (e.g. “some cases just need to be tried”) it is anticipated that the documents already generated through the foregoing process may help expedite and minimize the cost of such litigated resolution, which is another of the objects of a preferred embodiment of the invention.

Although the costs of the optional dispute resolution process illustrated in FIG. 5 may be allocated to the pool participants in accordance with a formula agreed to by and between such participants and the pool organizer/operator, in a preferred embodiment, all of these costs may be borne by the pool participants pro rata to their share of such distributable royalty earnings if the matter is resolved prior to commencing arbitration (e.g., at or before step 517). However, in one preferred embodiment and as an added incentive to resolve such disagreements prior to invoking arbitration, the arbitrator could be asked to allocate the costs of such dispute resolution among the participants and the written opinion of step 519 may include his or her recommendation in this regard. Thus, to the extent possible, in a preferred embodiment, the costs of the foregoing dispute resolution process may be deducted from each pool participant's share of such royalty earnings as an integral part of carrying out step 520.

Turning now to FIG. 6, it will be observed that this multi-part figure illustrates one preferred embodiment of the principles hereof in a network-based environment such as illustrated in FIG. 1, preferably using a traditional web browser such as Microsoft Internet Explorer, Netscape or the like on computer workstations 109(a) and/or 109(b).

FIG. 6A illustrates graphical user interface 600, which will be recognized as that portion of a preferred system that can be used to display a comprehensive list of the patents that are included in the patent pool, an estimate of their respective relevancy to the licensee and other related information that the user may wish to view. As more particularly described herein, it is anticipated that in a preferred embodiment, each user may be able to customize the appearance of this list in order to meet his or her particular needs. In this regard, it is preferable that such view customization may include the ability for each user to incorporate and/or remove from the current view specific fields (i.e., flag status, patent number, title, relevancy, etc.); to adjust the columnar widths of each such displayed field; to set a preferred sorting method (i.e., ascending or descending) for the data shown in the table; and to select various appearance attributes (i.e., font size and style, gridlines and the like). Although the subject matter and some of the operating characteristics are dramatically different in the ways described herein, a preferred embodiment anticipates that these capabilities for customizing the appearance of the graphical user interface may be similar to the manner in which users are able to customize the main window in Microsoft Office Outlook®, Version 11.0.

In carrying out these general objectives, it will be observed by reference to FIG. 6A that interface 600 displays a list of fields that an individual user desires to view, each shown horizontally across the top bar, labeled 601(a); has a slider adjustment 601(b) running along the right-hand side in order to allow such user to quickly move up and down the list; and several coarse sorting tools along the bottom bar, which is designated 601(c) in the illustration. It will be understood by those persons of ordinary skill in the art that the particular manner in which these elements are displayed may vary widely without changing the overall principles of the invention. Thus, by way of example but not limitation, whereas the course sorting tools shown along bottom bar 601(c) appear as a series of three radio dial buttons in FIG. 6A, the same principle could be practiced by one or more drop down selection menus that might appear in the upper part of the interface design and/or, as yet another alternative, as a floating menu. Additionally, it will be understood that in lieu of, and/or in addition to, the slider adjustment tool 601(b), the same principle of displaying more data than can be reasonably fit on one screen may be achieved by dividing the list into a fixed number of items or lines per page and including hypertext links, a drop down menu or another navigational tool of this sort to allow the user to move between a series of two or more such partial views.

FIG. 6A illustrates one such view that may be useful to carrying out the principles described herein, and in which display 600 shows columns for the flag status (602); patent number (603); patent title (604); relevancy factor (605); inclusion status (606) and substitution declaration status (607). Other columnar information that could be shown in this view and that may be useful to certain users of the system include any of the information that is reported as “fields” in the electronic database of patents and published patent applications maintained by the USPTO, which fields list may be viewed online at http://patft.uspto.gov/netahtml/search-adv.htm, and/or similar information contained in various other electronic databases of patents and published patent applications such as the esp@cenet® system and other free or paid services. Without limitation, this includes such information as filing date, publication date, name of the patent owner or assignee, various classification numbers, application number, priority number, issuance date and the like. Additionally, in a preferred embodiment, this view may also contain information educed through the system such as, in a non-limiting example, the average ratings described below with respect to FIGS. 6G and 6I.

By way of reference to column 605, entitled “Relevancy,” it will be observed that in one preferred embodiment, the system may utilize one of various statistical and/or computational analysis tools to estimate the relevancy of a particular patent or group of patents to a selected target such as another patent, classification or field of use, topic, term, concept, specified need, use or user. In this regard, persons of ordinary skill in the art will be aware that there exist a variety of proprietary as well as non-proprietary analysis tools that have been proposed and/or that are presently available for estimating such relevancy rank, among others including based on single and/or multivariate term searching, word stemming, term weighting, term occurrence frequency, factor analysis, multivariate analysis, fuzzy operators, clustering and analyses of semantic similarities.

Without limitation, several examples of techniques that may be useful to practicing this aspect of the system and method, and by which to place a numerical value on the relevancy of a patent include the aforementioned '992 patent and the corresponding computer-automated method of rating and ranking patents offered by Patent Ratings LLC; the '966 patent and the corresponding PatentCafe tools based on latent semantic analysis; and the clustering technique disclosed in U.S. Pat. No. 6,778,995, issued to Dan Gallivan and entitled “System and Method for Efficiently Generating Cluster Groupings in a Multi-Dimensional Concept Space” ('995 patent). Persons of ordinary skill in the art will recognize that each of these techniques for forecasting relevance (along with a variety of other approaches, including many that are referenced by these patents) has strengths and corresponding weaknesses. Thus, in a preferred embodiment, the system may allow individual users to select from a menu of such available techniques the one approach (or a composite based upon several approaches) that he or she wishes to utilize in accomplishing such relevancy ranking. Additionally, without departing from the spirit of the invention, to the extent that certain of these techniques are proprietary, the system may optionally provide for assessing users an incremental service fee or charge for using such “premium” techniques.

Returning to FIG. 6, it will also be observed that column header 605 also includes a downward arrow, which indicates that the user has designated that the data contained in the table should be should be sorted in accordance with the descending order of the information in this column (e.g., in this example, based on its respective relevance rank). Thus, in accordance with this selection, the patents at the top of the list are those with the highest relevancy ranking, and those toward the bottom are those which are ranked somewhat lower according to the selected relevance methodology. It will also be readily apparent that a well ordered system may allow each of the columns to be sorted in this manner. Thus, for example, by clicking on column header 603, the list could be portrayed in ascending or descending order based on patent number; and by clicking on column header 604, it could be organized in alphabetical or reverse alphabetical order based on the patent title. Similarly, by way of example but not limitation, if the individual user had displayed in interface 600 a column showing the name of the inventor of each patent, these names (or for that matter the names of the assignees, prosecuting law firm, etc.) could be used as the basis for sorting the data shown in the table.

Additionally, as described briefly above, FIG. 6A illustrates another feature of a preferred embodiment, which is the ability of the user to place or remove a checkmark from the designated boxes associated with each patent in columns 606 and 607, in order to manage the portfolio of patents. Thus, as a non-limiting example, an authorized user who is the designated manager of a licensee organization may be assisted in managing the licensee's portfolio by designating which patents he or she would prefer to include within the grant clause to use some portion or all of the patent pool (such as a result of placing or removing a check in boxes 606(a) and 606(c) and the like) as well as which patents the user deems to be a substitute, as such term is defined herein (such as by placing or removing a check mark in boxes 607(a), 607(b) and the like). While FIG. 6A illustrates these features as check boxes, it will be understood that any number of other techniques could be used to implement the foregoing features of the system, including as non-limiting examples word toggles (where clicking on the word results in moving it through a pre-determined menu), pull-down menus, radio dial buttons and the like.

A person of ordinary skill in the art will understand that such features may be employed, among other things, to facilitate the task of keeping track of a large number of patents having varying degrees of relevance to a licensee's business. This process, therefore, may make it possible for a manager, tasked with this responsibility, to quickly and efficiently decide which of such patents are considered to be substitutes and additionally which, if any, of the patents that licensee would prefer to remove from the grant clause of the license for the patent pool.

By way of illustration, but not limitation, by placing a check in check box 606(a) but no mark in check box 607(a), the system may recognize that the license to the patent pool includes the corresponding patent (e.g., the '361 patent in the illustration) and that the licensee does not consider this patent to be a substitute, as this term is defined herein. Alternatively, by having placed check marks 606(b) and 607(b), the system may recognize that this licensee's license to the patent pool includes the corresponding patent (e.g., the '507 patent in this example) and further that this licensee considers this particular patent to be a substitute. Finally, by removing the checkmark from check box 606(c) and including a check in box 607(c), the system may recognize that the grant clause of this licensee's license to the patent pool may not include the corresponding patent (e.g., the '733 patent in the illustration) and identify the fact that this licensee has indicated that, in its opinion, such expressly removed patent is a substitute for one or more reasons.

It will also be readily understood by persons of ordinary skill in the art that the user interface may “grey out” (i.e., render inactive) or selectively exclude showing particular features depending on any number of relevant factors built into the system's logic and workflow. Thus, for example, the ability for a user of a well-ordered system to make the foregoing selections concerning whether to characterize a patent as being a substitute and/or whether or not to include a patent in the license to the patent pool and the like might entail a particular level of authority. In this example, all other users (e.g., anyone not possessing the authority to make such declarations and/or licensing decisions) might be permitted merely to view the respective status of the patents in the pool, but not be able to amend that status. This could be accomplished either by graying out the checkbox feature or by omitting that portion of the column and simply displaying the resultant status (e.g., “included” or “removed” in the case of column 606) on such users' screen views.

Additionally, in a well ordered system designed to practice the principles of one preferred embodiment of the invention, once the period of time specified in the license agreement for making certain elections or designations (i.e., whether or not to remove a patent from a patent pool or to designate one or more patents therein as being substitutes, etc.), the system may preferably render such feature inactive and thereafter continue to display the actual status as of the end of such permitted period of time in which to have changed it.

Moreover, as described above, a preferred embodiment of the system may logically interconnect the operability of a number of features in such a way so as to facilitate licensees, patent owners, the pool operator and various authorized third parties to practice their respective rights and fulfill their respective obligations in accordance with contractual terms and applicable laws governing the patent pool. Thus, by way of example but not limitation, in a preferred embodiment, the system might inactivate (e.g., grey out) the inclusion status feature of column 606 unless the user has first declared such subject patent as being a substitute by taking the appropriate action in column 607; thereby making it impossible for such user to click on a check mark in an active box in column 606 (i.e., the check in box 606(a), which would have the effect of removing the '361 patent from the pool in this example), unless and until he or she has first done something else (i.e., in the case of the instant example, declared that such '361 patent is a substitute by placing a check in box 607(a), and any related process or workflow).

As a second example of the manner in which various components of the system such as those illustrated in FIG. 6A may be used to make the management of, participation in and regulatory oversight for a patent pool as simple, intuitive and transparent as possible, in a preferred embodiment, the flag status feature illustrated for each patent in column 602 could preferably be integrated with various events and/or an internal or remote system time-clock. Thus, for example, a flag status indicator may either be manually set by a user such as for a reminder, or may automatically be triggered in accordance with one or more pre-programmed workflow rules such as for an alert.

Thus, by way of example but not limitation, a green flag status, 608(a), may inform the user that he or she has an opportunity to make a selection (which depending on the terms of the license agreement may occur for a certain limited number of days or perhaps have been triggered by something that another user of the system did, etc.) Similarly, a yellow flag status, 608(b), may alert the user concerning such deadline approaching for that user to make a particular election or decision; and a red flag, 608(c), may denote that the passage of such deadline is imminent, such as at the end of a pre-determined number of hours or days.

As more particularly described herein, it is also anticipated that in a preferred embodiment, various entries in the body of table 600 may incorporate embedded links (including hypertext links, Java rollovers and the like) that may allow individual users to rapidly “drill down” into the data summarized therein for the purpose of accessing additional, related information. Thus, for example, clicking on the word “substitute” in column 607 of the interface may open a dialogue box, drop down window, pop-up window or floating window element summarizing the rationale for the licensee having previously deemed the corresponding patent asset as being a substitute, and the status of any related communications with the patent owner regarding this characterization. Accordingly, referring to FIG. 6A, clicking on embedded link 607(d) results in opening dialogue box 609. As shown, this reveals explanation summary 609(a), opposition status summary 609(b) and optionally link(s) 609(c) for getting further, more detailed information, such as in a separate browser window. Clicking on button 609(d) may result in closing such dialogue box.

Similarly, as illustrated by areas 610(a) and 610(b), in a preferred embodiment of the system, clicking on any patent number or title may open a drop-down panel in which more detailed information is provided. For example, clicking on number entry 611(a), or patent title 611(b), will be observed to have made it possible for the system user to observe in area 610(b) additional information concerning, in this case, the '992 patent. Without limitation, this could include such information as the inventor or inventors name(s), 612(a); assignee name(s), 612(b); issuance date, 612(c); original filing date, 612(d); various assigned codes referencing the invention classification and/or field of use, 612(e) and 612(f), and other information drawn from related patent databases. Although not shown in FIG. 6A, this could include the patent abstract, one or more claims, the specification or portions thereof, drawings, etc., and/or embedded links thereto.

In a well-ordered system, it is preferable that such additional elements be dynamically generated so as to include the available information about the selected patent that is not already being shown in the user-selected fields of table 600. Thus, for example, if the system user elected (in the manner described above) to omit the patent title column (604) when generating table 600, then title 611(b) might not appear until the user opened additional panel 610(b), such as by clicking on patent number 611(a). Similarly, if a user wanted to have his or her high-level view of the database of patents contained in the patent pool include, for example, the U.S. classification code for each patent, then code 612(f) could appear in a new column so designated for this purpose rather than being viewed only by opening panel 610.

On the lower portion of the graphical user interface display shown in FIG. 6A, it will be observed that one preferred embodiment includes a number of coarse adjustments for grouping the data and thereby permitting the user even greater control in focusing on areas of primary interest at a given time. Although any number of such grouping adjustments could be incorporated into the invention, one preferred embodiment of the system contains a selection that results in displaying all available patents in the pool (613); and two filter selections to display abbreviated lists of these patents in table 600. For example, clicking on radio dial 614 results in displaying only those patents that the licensee has elected to include in the grant clause of his, her or its license to use the patent pool. Alternatively, clicking on radio dial 615 results in displaying an abbreviated list comprised of only those patents within the pool that the system has automatically ascertained as being substitutes or that the licensee has previously declared to be a substitute.

Persons of ordinary skill will realize that the foregoing examples are listed merely to illustrate how various features of the system may be combined and integrated within a well-ordered system, it being understood that these are optional features and further, that each may be incorporated into the system in any number of ways in accordance with the principles of the invention and known network-based enabling infrastructure technology.

FIGS. 6B, 6C and 6D respectively illustrate various non-limiting exemplary pop-up messages that could preferably be displayed to a system user in assisting to carry out the principles of a preferred embodiment of the invention. Thus, message box 616 shown in FIG. 6B illustrates a message that may preferably be displayed the first time (or if the user so elects as described herein, each time) that the user designates a patent within the patent pool to be a substitute (e.g., as described above with respect to FIG. 6A, by clicking on empty box 607(a) or any other empty box in column 607 in order to fill it with a check similar to checkbox 607(b) in the figure).

As shown therein, message text 617 informs the system user that designating a patent to be a substitute does not remove it from the license agreement by and between the patent pool and the licensee nor result in any adjustment in the applicable royalty payment for licensing the patents in that pool. The text explains that there may be a number of sound commercial reasons to license substitute patents, and that these benefits may more than justify any incremental savings that could be attained by removing the patents from the grant of license to the patent pool.

Message text 617 also preferably contains a disclosure that in order to remove a patent from the patent pool directs the licensee to affirmatively remove that patent or patents from the pool, for example as described above with respect to FIG. 6A, by removing the check mark from the box entitled “Included” in column 606 of table 600. Message text 617 also preferably explains that the removal process involves a process in which the licensee explains why it deems the patent that it desires to remove from the license grant to be a substitute; and in which the patent owner is given an opportunity to advocate that his, her or its patent should not be removed from the patent pool. Also as shown in FIG. 6B, message text 617 preferably explains any other relevant provisions of the license agreement, including as a non-liming example, that the final decision concerning whether or not to remove a patent from the grant of license to the patent pool preferably be made unilaterally by the prospective licensee.

Message text 616 also preferably contains display preference 618, which persons of ordinary skill in the art will readily recognize enables the user to decide whether or not to have the system continue to display this message in the future. Thus, by placing a check mark in display preference box 618, a user is able to instruct the system not to show this message again; and alternatively, for as long as such display preference box 618 remains empty, the system may continue to show message box 616 each time the user designates a patent as being a substitute.

Message box 616 also preferably provides the user with two options. On the one hand, users can decide to proceed with the process of designating as a substitute one or more particular issued patent(s) and/or patent application(s) that may be licensed though the pool. In a preferred embodiment, this outcome is achieved by clicking on button 619(a), in which case message box 616 may close and a checkmark may appear in the appropriate box within column 607 of main screen 600. Alternatively, users can elect (on or before the expiration of the applicable option period) not to deem the patent(s) as a substitute, and instead simply return to main screen 600. In a preferred embodiment, as reflected in FIG. 6B, this outcome may be achieved by clicking either on the “Go Back” button 619(b) or on the close dialogue box button 619(c).

Turning next to FIG. 6C, message box 620 illustrates a pop-up message that is preferably displayed by the system when an authorized user proposes to remove a patent from the scope of the license to the patent pool (e.g., as described above with respect to FIG. 6A, any time an authorized user clicks on the check mark shown in boxes 606(a), 606(b) and/or any other checked box in column 606 in order to remove the checkmark from such box in the manner described above). As shown therein, message text 621 informs the system user that removing a patent from the patent pool begins a pre-agreed process for removing patents from the patent pool.

Message text 622 reinforces that the licensee is preferably under no obligation to license “all or nothing,” but is expressly permitted to remove any patent from the patent pool and to correspondingly reduce its royalty obligation. This principle is intended to be consistent with the objectives of the aforementioned 1997, 1998 and 1999 Ruling Letters, which in each instance emphasize the requirement that the “Portfolio license [should] not . . . foreclose competitive implementation options.” Although these Ruling Letters embrace the policy of limiting the Portfolio solely to “essential patents” as a strategy of achieving this objective, those persons of ordinary skill in the art will appreciate that one objective of a preferred embodiment of the invention is to provide a technological means to accomplish this pro-competitive objective while simultaneously overcoming a variety of the limitations in the present state of the art. Embedded links 622(a) and 622(b) may preferably provide the user with information concerning the contractual basis for its rights and obligations, as well as the possible legal consequences of these actions.

In addition to displaying message text 621 and 622, the system preferably gives the user an alternative of indicating one or more reasons for wishing to remove the selected patent from the patent pool, or deciding to forego removing such patent from the pool. In this regard, the main body of message box 620 illustrates one way in which the foregoing objectives can be achieved in accordance with the principles of the invention. As shown therein, the system preferably displays a list of the principal categories of reasons that a user might consider a patent to be a substitute and, on this basis wish to remove it from the patent pool. Although this step may be included at any time in the system workflow, including but not limited to when a user declares a patent to be a substitute (e.g., when the user places a checkmark in an open box in column 607, as described above), in a preferred embodiment of the system, this step of asking that a user provide an explanation why a patent is deemed to be a substitute may only be included in those instances when the user elects to remove a patent from the pool.

As illustrated in FIG. 6C, the available explanations for why a patent is deemed to be a substitute may preferably include that the user owns the patent in question, 623(a), or is already licensed under the patent, 623(b), each of which will obviously render obtaining such coverage through the patent pool as unnecessary. It will be understood that these explanations reinforce that the patent pool may preferably not have a exclusive license on any of the patents contained therein and may not prohibit any patent owner from buying, selling and/or separately licensing rights directly, which principles are in accord with the pro-competitive objectives of the aforementioned 1997, 1998 and 1999 Ruling Letters. Accordingly, as stated in the 1998 Ruling Letter, “[s]hould the agreed pool royalty prove economically unrealistic, each [patent owner]'s ability to grant licenses on its own to users of its [patent(s)] provides a backstop” may be reinforced within in a preferred embodiment of the system and method.

A second set of possible reasons for declaring a patent to be a substitute pertains to representing that licensing such patent is unnecessary due to business trade-offs, better alternatives and other practical considerations. Thus, as shown in FIG. 6C, this second major category of explanations preferably includes that the user elects to employ a different patented technology, 623(c), or an alternative, publicly-available technology, 623(d), in lieu of the technology covered by the patent in question; and/or that the user asserts that he, she or it is not practicing what the particular patent covers and has no present intention of so doing, 623(e). Although it is less likely that any of these reasons may apply to the extent that the patent pool is directed to only “essential” patents, the presence of these features in a preferred embodiment of the system nonetheless represents an improvement in the present state of the art that may help assure that the patent pool is pro-competitive.

In this regard, these features address one of the concerns raised in the 1998 Ruling Letter, namely that a “patent-expert mechanism [for assuring that only essential patents are included therein] is flawed,” and that “[w]ithout more, there would be justifiable skepticism that this structure would ensure a disinterested review of the ‘essentiality’ of the patent rights put forward.” Moreover, to the extent that the patent pool seeks to extend the state of art beyond “essential” patents, these features of a preferred embodiment may help ensure that each licensee may selectively opt-out of licensing non-essential rights and, if at all, is voluntarily licensing the remaining assets of the patent pool.

Persons who are knowledgeable in the field will realize that FIG. 6C also incorporates yet a third category of reasons for declaring a patent to be a substitute namely one or more legal reasons. Thus, as shown, selection 623(f) indicates that the user reasonably believes the patent in question to be invalid; and selection 623(g) is available for those instances in which the user reasonably believes the patent to be unenforceable for one or more reasons under applicable law. Additionally, message box 620 also preferably includes selection 623(h), including any other reasons that do not fit within any of the foregoing categories. Among others, this may include issues such as exhaustion, laches, equitable estoppel, collateral estoppel, the effects of foreign litigation, and antitrust, and may also provide space for entry of a brief free-text explanation.

Persons of ordinary skill in the art will appreciate the trade-offs and benefits of normalizing such explanations, as well as making the given selection alternatives as detailed as possible, while remaining “user-friendly.” Accordingly, other reasons may be listed in addition to the foregoing explanations, and/or may be included in one or more subordinate levels of inquiry that may be requested once a first level selection has been made by the user and/or in response to subsequent interactions with the patent owner.

The system may inquire about such more detailed explanations from the user at any time, including at this point in the workflow. In a preferred embodiment, the system may not inquire about such additional details at least until after the user has been provided an opportunity to confirm that, in fact, removing the patent for one or more of the higher level reasons such as 623(a) through 623(h), and the like, is (to such user) financially justified. Accordingly, as shown in FIG. 6C, the user may preferably highlight in message box 620 the one or more applicable explanation(s) for why that user considers the patent to be a substitute, as illustrated therein by selection area 624, and then click on the “Remove” button, 625, to complete the workflow step. Alternatively, if the user decides not to remove the patent from the pool, the user may click on the “Cancel” button, 626(a), or on the close message box button, 626(b), at any time, which may return the user to the main screen 600.

Turning now to FIG. 6D, message box 627 illustrates a message that in one preferred embodiment is displayed by the system each time that the user clicks on Remove button 625 shown in FIG. 6C, and preferably before any information concerning the user's possible decision to remove a patent from the patent pool is communicated to the affected patent owner. As shown, message text 628 informs the user that removing a patent from the patent pool entitles the affected patent owner to an appeal process in which the user and the patent owner are encouraged (or optionally required by the terms of the patent pool licensing agreement) to participate in good faith disclosures concerning the reasons for (and for opposing) the decision by the user to forego licensing that patent.

In one preferred embodiment of the system, the terms of the patent pooling agreement may dictate that such interactive appeal process is expressly limited to patents with at least a certain pre-determined minimum percentage relevancy factor, 628(a) (i.e., 70% relevancy in the illustration). Also, as shown, message text 628 may contain one or more terms, such as 628(a) and 628(b), that include embedded links to additional helpful explanations and/or back-up information that can be accessed by the user clicking on such links. Thus, in the example, if the user wanted to know the basis for the system's relevancy factors or how its automated allocation formulas were derived, he or she could click on links 628(a) or 628(b), and respectively, this information could be displayed.

Message text 628 also preferably contains an estimate of the approximate financial impact (e.g., estimated savings) to the user of removing the selected patent from the patent pool. In accordance with this feature of a preferred embodiment, calculation 629(a) shows one way in which the system can communicate this information to users. As shown, such calculations are preferably made on a percentage basis with, and without, the patent that the user is considering removing from the patent pool, as well as the net percentage savings potential represented by such decision. Additionally, message text 628 also preferably places this percentage savings into context on the basis of the user's applicable currency, as shown by the parenthetical explanation 629(b). Moreover, in order to tailor this explanation to the needs of system users, calculation 629(b) may preferably be generated dynamically in order to take into account the overall size of the licensee. In this way, more substantial numbers may be used in parenthetical explanation 629(b) in the event that the user is a larger firm or when the agreement contemplates a fully paid-up license; and more modest aggregate royalty amounts (i.e., thousands or tens of thousands of dollars) are used in the event the user is a smaller firm pursuant to a running royalty-based agreement.

Persons of ordinary skill in the art will appreciate that this process (particularly wherein the kind of information shown in calculations 629(a) and 629(b) is revealed in advance of commencing any sort of appeal process involving the patent owner) contrasts with the traditional process where a demand or notification letter from a patent owner to a user often contains unrealistically high numbers and, irrespective, is commonly either ignored or simply referred to outside counsel “to be handled” without knowing how much money is realistically at issue. One of the problems with the existing state of the art is that this practice can in turn result in a situation where the money spent by both sides on legal fees for patent enforcement and/or defense far exceeds the expected range of value of a principled commercial transaction between the user and patent owner. Yet all too often, neither party feels safe in discussing, much less committing to, its financial bottom-line early in the negotiation process.

This limitation is overcome in a preferred embodiment by bifurcating such negotiations and, as illustrated in message box 627, using the estimates generated by the system of incremental value of a single patent as a surrogate for such negotiations that may serve both parties but that neither party typically feels safe in undertaking. Thus, the system provides a neutral way (without waiving defenses, without conceding infringement, without litigation threats and without implying weakness or lack of resolve, etc.) for users to receive an estimate of the potential financial savings involved before incurring significant amounts of money on such prophylactic legal services. Users are thus empowered to weigh the incremental costs against the perceived value/incremental litigation exposure of foregoing such license and thereby assisted in making rational assessments concerning whether the likely benefit of designating a patent to be a substitute but nonetheless continuing to include it within the patent pool more than justify such incremental royalty expense.

In the event the user decides at this point not to remove the patent from the grant of license to the patent pool, clicking on the “Cancel” button 630(a) or the message box close button, 630(b), may, in either case in a preferred embodiment, return the user to graphical display 600 shown in FIG. 6A without removing the corresponding checkmark from the box in column 606. In one preferred embodiment, the patent owner may not be informed of a licensee having declared a patent to be a substitute provided that, notwithstanding such characterization, the user also elects to include such patent in the patent pool. However, depending on the selected method for calculating allocation formulas described above, the patent owner may optionally be informed each time a patent that he, she or it owns is declared to be a substitute, irrespective of whether the user elects to include it in the patent pool, and be given an opportunity to accept or rebut such characterization. Alternatively, in the event the user determines at this point to continue to remove the patent from the patent pool, such user clicks on the “Remove” button 631, which in a preferred embodiment may return the user to graphical display 600, remove the corresponding checkmark from the box in column 606 and automatically afford the patent owner an opportunity to respond.

As described above, the system contemplates varying levels of disclosure and the possibility for rebuttal concerning removal of a patent from the patent pool. Persons of ordinary skill in the art will appreciate that the system described herein is able to coordinate this workflow in accordance with pre-determined rules and preferences. As noted above, details concerning the reasons for considering a patent to be a substitute (or to argue that a patent should not be considered a substitute and/or should be licensed by the user notwithstanding) do not need to occur all at once and can be normalized to a substantial degree. Thus, in one preferred embodiment, once the user selects the Remove button 631, thereby confirming its desire to proceed with the process of removing such patent from the patent pool, the system may preferably solicit additional information from the user as the basis for the user having declared the patent to be a substitute.

By way of example, but not limitation, in the event the user deemed a patent to be a substitute and contended this declaration as being based on a reasonable belief that such patent is invalid (i.e., in a preferred embodiment, by selecting reason 623(f) in message box 620 shown in FIG. 6C), the system may at this point open a secondary list of all of the recognized bases for a finding of patent invalidity, from which the user may be asked to identify the specific invalidity contention(s). Persons of ordinary skill in the art will recognize that the menu of possible reasons could include contentions of obviousness, anticipation, inadequate written description, failure to disclose the best mode, failure to provide an enabling disclosure, and other bases for invalidity (including inventorship, prosecution errors, double patenting, inoperability and non-statutory subject matter and the like). Similarly, in the event the user declared a patent to be unenforceable, such as by selecting reason 623(g), then upon proceeding to the step where more detailed disclosure is dictated, the system may open a secondary list of all of the recognized bases for unenforceability, such as the patent having expired, the patentee's failure to have properly disclosed material information during prosecution of the patent (e.g., inequitable conduct), patent misuse, and the like. In accordance with the wishes of the patent pool operator and participants, these disclosures can occur in a series of message boxes that are functionally similar to message box 620, described above in relation to FIG. 6C, or any of a variety of ways for populating a normalized data table using known network-based tools.

Although these disclosures may not occur all at once, it is preferable that the system collect a sufficient explanation of the position of the user desiring to remove a patent before communicating this information to the patent owner. Once communicated, the patent owner may preferably be given an opportunity to respond using normalized communications in the form of dialogue boxes, structured email messages, and other known techniques described herein. Upon receipt, these messages could preferably trigger response flags 608(a)-608(c), described above in relation to FIG. 6A, and preferably give way, in turn, to inquiries seeking further, more detailed explanations of the user's position regarding removal of the patent from the patent pool.

For example, selection of invalidity based upon a claim of obviousness, may at the appropriate time in the workflow result in opening yet a third level query in which the user is prompted to disclose whether the prior art upon which such obviousness claim is being asserted consists of one or more earlier patents, published materials, prior public use, etc.; and in turn, even more specific inquiries such as seeking to identify particular references, facts and the like where such information is known to the user. In accordance with the objectives of one preferred embodiment of the invention, these disclosures could in turn trigger the opportunity for the patent owner to respond thereto and/or explain their position respecting such matters, in each case preferably through the interactive tools provided as part of a preferred embodiment of the system.

Persons of ordinary skill in the art will appreciate that claims construction issues often rest at the heart of disagreements between parties concerning whether a particular patent is a substitute (as such term is herein defined), and yet these issues are often some of the most challenging, time-consuming and costly to clarify. Accordingly, one preferred embodiment of the system provides a workflow and structure for facilitating at the appropriate time disclosure of each party's respective contentions concerning claims construction. The system may provide an opportunity for this disclosure to occur at various levels of precision during the workflow including an opportunity to supplement these disclosures at a later time should there be a need to do so.

FIG. 6E illustrates a claims chart 632 that can be used for the purpose of carrying out the principles of a preferred embodiment of the invention by providing initial disclosures concerning why a licensee proposes to remove a patent from the pool. As shown therein, column 633 reveals the actual language of the claim or claims that the patent owner has disclosed through the foregoing interactive process as being applicable to the prospective licensee and in response to such user having previously declared such patent to be a substitute and on this basis proposed to remove such patent from the patent pool. Using a hypothetical patent claim consisting of four elements, cells 633(a) through 633(e) show the language of each claim element exactly as shown in the issued patent. As will be apparent to persons of ordinary skill in the art, the system could automatically populate the contents of these cells from the official records of the patent office or the information could be manually entered by the user.

Column 634, entitled “Proffered Construction,” displays the proposed construction of each of these claims elements. Although this information could be entered manually by the user into a free-text field, in a well ordered system, the system preferably prompts the user to describe the meaning of each such claim element. Depending on the complexity of the claims language, this description may be a series of short affirmative statements such as illustrated by cells 634(a) through 634(e); and in more complex circumstances or where previous interactive communications between the parties reveals that there is a material difference of opinion respecting the meaning of a particular claim term(s), this may occur through the use of references to the intrinsic evidence (i.e., the patent specification, prosecution history and prior art cited during examination of the patent, etc.) and/or extrinsic evidence such as dictionary definitions, noted treatises and expert opinions, where applicable. As will be apparent to persons of ordinary skill in the art, the use of a variety of known network-based tools may permit such users to embed links to each of these references, which may facilitate review by third parties.

As shown, claims chart 632 pertains to a hypothetical situation where the user proposes to remove a patent as being a substitute on the basis that such user is not practicing this patent and is not presently intending to (e.g., following earlier having selected reason 623(e) in a preferred embodiment). Similar claims charts could be generated for each relevant explanation for having declared a patent to be a substitute, and persons of ordinary skill in the art will appreciate that the contents of columns 633 and 634 may remain constant in all such disclosures and that the remaining columns in the chart may differ depending on the specific requirements of the explanation(s) given. Accordingly, once generated in one context, these contents could be available for all other claims charts, when and as used.

Column 635 describes the relevant features of the licensee's (or the prospective licensee's) device, process, system or method corresponding to each claimed element, if any; and column 636 provides a corresponding explanation of the reasons the user wishes to remove the patent from the patent pool and correspondingly reduce its royalty payment. As illustrated in claims chart 632, the basis for the user taking the position that it is not practicing the patent or presently intending to do so is clarified within the descriptions provided in cells 635(a)-635(e) and 636(a)-636(e), respectively.

Thus, in the case of the hypothetical patent described in claims chart 632, it is revealed that the basis for the contention that the user is not practicing the patent is set forth in cell 635(e), where the user discloses what it is doing, and 636(e), where the user describes how this differs from the disclosed claim element of the subject patent. As noted by disclaimer 637, in one preferred embodiment of the system, these disclosures are made in good faith but are nevertheless subject to supplementation in the event they may be required (as more particularly described above with respect to FIG. 5A). Notwithstanding, even very limited disclosures may open the prospect for responsive claims charts to be introduced by the patent owner, thereby resulting in the principal areas of difference being highlighted and efficiently addressed. As will be apparent to those persons of ordinary skill in the art, this can be very useful to avoiding litigation by arriving at a shared perspective, reducing the number of issues in dispute thereby expediting resolution and/or to opening new possibilities.

For example, confronted with claims chart 632, the patent owner might accept the contention that his, her or its patent is a substitute (as illustrated by a “No” response in decision step 508 of FIG. 5A) or, alternatively, the patent owner might elect to rebut some aspect of the proffered construction for claim element 1(d) as contemplated by a “Yes” response in decision step 508 and step 509 of FIG. 5A. In the case of the hypothetical patent described in claims chart 632, such patent owner might, for example, point out in reply a specific passage within the specification to demonstrate that the proffered definition set forth in cell 634(e) is overly limiting (i.e., perhaps explaining in a responsive claims chart generated through the system that the term “green kryptonite” was a specially defined term meaning a particular type of polymerized vinyl that is green and durable), and use cell 635(e) to indicate on what basis the patent owner contends that such user is in fact employing that product.

This interaction may also provide the patent owner an opportunity to advocate why the user might wish to consider adopting the alternative covered by the subject patent as preferable over the present state of the art. Thus, in the foregoing hypothetical example, if persuaded by this interaction that the user was, in fact, employing a less desirable coating material, the patent owner might advocate the multifold advantages that the user could attain by voluntarily electing to change to the approach disclosed in the subject patent. Given access to the relevant incremental licensing cost from 629(a) and 629(b), the user could have all of the information necessary to make a reasoned decision whether to make such a change (resulting in withdrawing its decision to remove the patent on the basis of its being a substitute, as contemplated by a “No” response to decision step 506 of FIG. 5A), or to continue using its existing, non-infringing device, system, process or method.

Turning next to FIG. 6F, it will be observed that this exhibit illustrates a modified view of the graphical user interface shown in FIG. 6A, in this instance reflecting display 638, which is anticipated to be more useful to a patent holder and/or the patent pool operator (whereas the aforementioned display 600 is anticipated as being of greater use to a licensee or prospective licensee than these other system users). Accordingly, across top bar 601(a), display 638 indicates columns for flag status (602); patent number (603); inclusion status (606) and substitution declaration status (607), each such column having already been described above with particular reference to FIG. 6A. As described in greater detail below, top bar 601(a) also includes explanation column 639 for reporting the stated reason(s) why the licensee or prospective licensee deemed such patents as being substitutes, as applicable; response column 640 for reporting (or selecting, as appropriate) the patent owner's response (or upcoming response deadline to respond) to such declaration; and status column 641, describing the present workflow status for each patent asset.

As suggested above with regard to display 600, other columnar information could also be shown in display 638 to address the interests and preferences of the system user. Additionally, as noted previously, the system preferably includes various authorization levels with regard to being allowed to characterize a patent as being a substitute and/or decide whether or not to include a patent in a license to the patent pool. Thus, as stated above, the system preferably responds to an absence of sufficient authority to make and/or change such designations by “graying out” the checkbox feature on such users' screen views and/or omitting that portion of the column and simply displaying the resultant status (e.g., “included” or “removed” in the case of column 606, and “substitute” in the case of column 607) on such users' screen views.

Without intending to limit the system to such an approach, it is apparent that the latter design approach is preferred in display 638. Accordingly, consistent with the principles described herein and an assumption that the system user in the case of FIG. 6F is not the licensee or prospective licensee for any of the patents shown in display 638, columns 606 and 607 of display 638 incorporate solely the prior decision of such authorized entities and/or individuals in the hypothetical licensees ABC, MNO and XYZ Corporations, respectively, and do not provide an interface to modify these declarations.

It will also be observed that along bottom bar 601(c), FIG. 6F illustrates the selection of coarse adjustment 642, reflecting the user's preference that display 638 show only those patents that a licensee has declared as being a substitute. As suggested above with respect to FIG. 6A, any number of other coarse filter adjustments could be incorporated into the interface, and used to segregate the selections to show in display 638.

Additionally, as described briefly herein, FIG. 6F illustrates another feature of a preferred embodiment of the invention, which is the ability of the system user to selectively view the tabular data arranged by, among other things, the name of licensee. Accordingly, it will be observed that display 638 illustrates the activity of three licensees, respectively designated 643(a), “ABC;” 643(b), “MNO” and 643(c), “XYZ Corporation.” Next to each such licensee is a toggle button, respectively 644(a) through 644(c), which persons of ordinary skill in the art will understand can be used to display all of the contents of the list for that licensee (as in the cases of open toggle buttons 644(a) and 644(c) such that the applicable patents associated with each of ABC and XYZ Corporation are displayed) or rolled-up (as illustrated by closed toggle button 644(b), indicating that MNO Corporation has a total of 6 items that the user can display by toggling such button to the open position).

As described above with respect to panels 610(a) and 610(b) of FIG. 6A, in a preferred embodiment of the system, clicking on any patent number or title may open a drop-down panel in which more detailed information may be viewed. This feature is also illustrated in display 638, where for example, clicking on patent number entry 645(a) may be observed to have made it possible for the user to observe in panel 646(a) additional information concerning, in this instance, the '992 patent. A corresponding panel 646(b) shows information for the '888 patent. Persons of ordinary skill in the art will readily understand that the information indicated in the uppermost portion of these drop-down panels may be the same irrespective of the particular licensee. Thus, were a user to click on patent number entry 645(b)-corresponding to the '888 patent as it pertains to ABC Corporation, the additional information displayed in the resulting drop-down panel could be identical to that displayed in panel 646(b) with respect to the [same] '888 patent under XYZ Corporation.

Persons of ordinary skill in the art will also understand that the entries that appear in column 606 of display 638 are generated as a consequence of an authorized system user in the respective licensees having elected to retain (or alternatively remove) the corresponding patent from the patent pool (for example, in a preferred embodiment, in the manner described with respect to boxes 606(a) and 606(c) of FIG. 6A). Similarly, it will be understood that the entries that appear in column 607 of display 638 are generated as a consequence of an authorized system user in these licensees having declared (or declined to declare) as a substitute the corresponding patent from the patent pool (for example, in a preferred embodiment, in the manner described with respect to boxes 607(a) and 607(b) of FIG. 6A.

Thus, it is apparent from entries 607(e) and 607(f) in FIG. 6F that the authorized system user at both ABC Corporation and XYZ Corporation declared the '888 patent to be a substitute. Moreover, by reference to entries 606(d) and 606(e), respectively, it is also apparent that whereas the authorized user at ABC Corporation elected to include such '888 patent in the patent pool, his or her counterpart at XYZ Corporation proposes to remove that patent from the grant clause of the patent pool on the basis of deeming it to be a substitute.

As stated above, column 639 reports the one or more explanations given by each licensee or prospective licensee for deeming each applicable patent to be a substitute. Thus, for example, it will be apparent that explanation 639(a) in FIG. 6F corresponds to the prior selection of reason 623(d) of FIG. 6C; explanation 639(b) reports the earlier selection of reason 623(b); and explanation 639(d) refers to selection of reason 623(e) by the authorized user at XYZ Corporation. As more particularly described above with respect to FIGS. 5, 6B and 6D, in a preferred embodiment a licensee may only be requested to indicate such rationale in the event the licensee also elects to remove such patent from the patent pool. For this reason, cell 639(c) in display 638 is shown as being empty.

As summarized above, column 640 displays the patent owner's response, if any, to such explanation(s) for these patents being deemed as substitutes. As discussed above, there are preferably at least two (2) normalized responses, namely “accepted” as illustrated by 640(a), which will be understood to correspond with a “No” response in decision step 511 of FIG. 5A; and “rebutted” as illustrated by 640(b), which will be understood to correspond to a “Yes” response thereto. Until the earlier of the date upon which one of these positions is selected or the time period elapses for giving such response, as illustrated by notice 640(c), the system preferably displays the response deadline in column 640. In a well-ordered system, this deadline may be calculated as the number of days provided for such response according to the terms of the patent pooling agreement.

Also, in a preferred embodiment, the system provides pull-down menu 640(d) or any of a variety of conventional techniques by which the patent owner may indicate his, her or its response within this timeframe. As thereby illustrated, clicking on the deadline date in column 640 preferably results in opening pull-down menu 640(d), the default position for which may optionally be indicated by a check mark positioned in accordance with the terms of the patent pool licensing agreement. Thus, for example, in one preferred embodiment of the system, the terms of the patent pool licensing agreement may specify that in the absence of a patent owner affirmatively rebutting within a pre-determined number of days the characterization that a patent is a substitute that a user proposes to remove from the patent pool on this basis, then the patent owner shall be deemed to have accepted such characterization without prejudice to later revise this position for good cause. On this basis, therefore, as shown in pull-down 640(d), the “Accepts” response is shown as being the default setting. Thus, if by the deadline date, the patent owner has not revised this default, then such response may thereafter appear in column 640.

Alternatively, as shown in FIG. 6F and more particularly described with respect to FIG. 5A and 5B, the patent owner has the option of clicking on the “Rebut” response in pull-down 640(d) and thereafter providing further explanations on the basis of his, her or its good faith belief that such substitute characterization is incorrect. Finally, in one preferred embodiment, pull-down 640(d) also affords the patent owner the alternative of selecting the “Discuss” response. In accordance with the objectives of a preferred embodiment of the invention described above with respect to FIG. 6E, it will be understood that this selection indicates that the patent owner is prepared to accept such characterization, but wishes to advocate that the prospective user should change his, her or its mind and license the subject patent notwithstanding. In this event, whatever the licensee's decision is after reviewing such advocacy may dictate the response in column 640 upon the passage of a pre-determined period.

As summarized previously, it will be observed that column 641 indicates the status of the interactive communications respecting the foregoing issues. As shown in display 638, one preferred embodiment assumes at least four alternative status conditions. As indicated by status 641(a), the issue could be “Resolved,” meaning that the patent owner and licensee (or prospective licensee) have through the foregoing described process arrived at a common view (e.g., both agree that the patent is a substitute, as such term is defined herein, or the licensee agrees to include the patent within the license to the patent pool, which renders the issue moot in a preferred embodiment). A second alternative, indicated by status 641(b), is that the time period for a response passed, in which case the status is shown as “Elapsed” and the outcome is governed by the terms of the patent pool licensing agreement.

A third alternative is that the outcome is “Automatic,” meaning that it is governed by law and/or by the express terms of the patent licensing agreement. Examples of this situation include patents that are expired or invalid, which the system may automatically exclude from the patent pool; and in a preferred embodiment, patents that a licensee elects voluntarily to include in the patent pool thereby rendering such issue moot. Status 641(c), shown in display 638, is illustrative of this later situation. Fourth, as illustrated by status 641(d) and 641(e), the system may indicate that the issue remains “Pending,” meaning that it is not yet resolved, and that the pre-determined period of time for one party or the other to respond has not yet elapsed.

In one preferred embodiment of the system, double-clicking on any explanation (in column 639) or status (in column 641) may result in opening an additional drop-down panel in which the chronology of interactions between the parties is summarized for that particular patent. Thus, for example, double-clicking on explanation 639(b) or status 641(d) will be understood to have resulted in opening drop-down panel 647(a); and similarly double-clicking on explanation 639(d) or status 641(e) will be understood to have opened drop-down panel 647(b). As shown therein, each such lower drop-down panel includes directional indicator 648(a) and 648(b), respectively, which can be used to cause the log entries to be read in chronological order, as shown in display 638, or in reverse chronological order with the most recent event stated at the top of the list.

In each case, FIG. 6F illustrates that the system may show, by date, when the patent was added to the patent pool and the subsequent chronology of events from that time until the most recent event involving the patent holder and/or licensee, together with any upcoming deadlines. As shown in drop-down panel 647(a), in a preferred embodiment of the system, such upcoming deadline 649(a) is integrated with the date shown in the corresponding columnar summary, 640(d), as well as color-coded flag, 650(a). This feature is also illustrated by flag 650(b), corresponding to owner response deadline 640(c). In addition, a preferred embodiment of the system provides an intuitive interface when a drop-down panel is open anytime a user is expected to take the next action for displaying context-appropriate alternatives (649(b) and 649(c) in the hypothetical case illustrated in the figure) based on the pre-determined workflow and system clock.

In implementing this aspect of the system of a preferred embodiment, reference is made to the Case Management/Electronic Case Files (CM/ECF) system currently in use in approximately 80 district courts, 85 bankruptcy courts, the Court of International Trade and the Court of Federal Claims. For more information concerning this system, reference is made to a July 2005 summary of the system, which may be reviewed on line at http://www.uscourts.gov/cmecf/cmecf_about.html, which description (together with related links) is incorporated herein by this reference (“CM/ECF system”).

As shown in display 638, the interface also provides a link to assistance, 649(d), should the user not understand his or her alternatives, or should such user wish to turn for professional advice and/or context-dependent assistance. Moreover, where supplemental information or attachments are included as part of a party's disclosures, as with the aforementioned CM/ECF system, these documents are made accessible via embedded links (e.g., links 651(a) and 651(b) in the illustration).

Pay-to-subscribe, pay-per-use, pay-to-view and context-appropriate advertising represent known methods and consequential sources of income within a variety of well known network-based systems. Accordingly, in addition to charging a transaction-based percentage on licensing of the patent pool, which is one preferred method of the patent pool operator being compensated for its services hereunder, provision may also be made to incorporate these optional incremental revenue-generating capabilities into the system.

By way of example, and not limitation, a party seeking to access supplemental information or various attachments may be billed for this on a per page basis in a manner that is comparable to the Public Access to Court Electronic Records (PACER) electronic public access service that allows users to obtain case and docket information from Federal Appellate, District and Bankruptcy courts; or on a subscription or per document basis in a manner that is comparable to the Wiley InterScience® service that provides Web-based access to over 1,000 journals and other reference works to over 12 million users in 87 countries. Additionally, the system may optionally provide space for context-appropriate advertising that is, for example, similar to the paid advertising in Google, Inc. and numerous other Internet-based businesses.

Turning next to FIGS. 6G through 6I, it will be observed that several other non-limiting exemplary illustrations are provided for a graphical user interface that may be employed within a preferred embodiment of the system to permit authorized users to rate patents (and/or to provide input concerning specific attributes of patents that are at issue). Persons of ordinary skill in the art will understand that one of the benefits of such interface is to assist users to carry out aspects of the disclosed system including, among others in a preferred embodiment of the invention to help to decide “hits from duds” as described above and with respect to relevant portions of FIGS. 4, 5 and 7.

In this regard, screen 652, shown in FIG. 6G, illustrates an optional feature for helping fulfill certain ones of the group collaboration aspects of a preferred embodiment. As noted by text message 653, within pre-determined guidelines 654 enforced by the patent pool operator with regard to such commentary, system users including but not limited to patent owners 203(a)-203(c) and patent users 206(a)-206(c) may be assisted to share their opinions concerning a patent that is, or that is being considered to be, in the patent pool. Factual data 655 through 657, and drawing 658, indicate non-limiting examples of information that may be presented to assist such users to quickly recognize the patent and/or publicly-available portions of the patent file wrapper that bear on an issue for which an opinion of system users is solicited.

Instructions 659 explain, merely as a non-limiting example of such an issue, that in this instance, all or some subset of system users are asked to state an opinion concerning how important such commentators view a patent to be within a particular field of use. It should be apparent that this is merely an illustrative inquiry, and persons of ordinary skill in the art will understand there may be any number of pertinent issues on which the comments of persons who are highly knowledgeable concerning patents within a particular field of use could be useful in carrying out the objectives of the system described in this disclosure. Without limitation, other subjects for which such opinions may be helpful include queries bearing on claims construction and the meaning of key claims terms, whether or not a patent is a substitute, the extent to which a patent is useful and in fact is (or is not) being practiced, whether and the extent to which a patent is blocking, whether the subject matter of a patent claim is novel and non-obvious as of its priority date, and if the disclosure is sufficiently enabling. As indicated, the first inquiry 660 illustrates that in a preferred embodiment, the user may rate the patent on the basis of a normalized scale, which may be words, numbers, icons, emoticons or other widely understood ratings methods. As illustrated by pull-down list 661, the system preferably assists the user to assure that a response is capable of calculation with similar ratings provided by other users.

The second inquiry 662 provides an opportunity within fixed-length text field 663 for the user of the system to indicate a title for his or her opinion; and subsequent inquiry 664 in turn provides a more substantial free text field 665(a) for the user to compose a more lengthy statement indicating, by way of example but not limitation, the reasons supporting the rating stated in response to inquiry 660 and/or elucidating the title input in field 663. In a preferred embodiment, scroll bar 665(b) may permit the user to move up and down any text that may be typed into box 665(a) to the extent it does not fit within a single screen view.

As shown, the fourth inquiry 666 informs the user that at present there are no specific areas being disputed. This line preferably provides hypertext link 667, which may link to a list of the potential bases for dispute (each of which may preferably have a standard template for educing both normalized ratings as well as free text input), any limits on the system user roles that may be authorized to initiate disputes thereon, as well as the timeframe for initiating and responding thereto on the basis of guidelines 654. Additionally, “Add” button 668(a) may provide an opportunity for the system user to add a new issue as one in dispute. In a preferred embodiment, the system may only display such “Add” button 668(a) in cases when such user, based upon his or her login, is authorized to initiate a dispute in accordance with such pre-agreed guidelines for operation of the patent pool. Finally, button 669 may provide the user an opportunity to preview his or her composition and, if acceptable to send or post it, but if not to erase and/or return to the earlier screen to edit it before it is posted.

Turning next to FIG. 6H, it will be observed that balloon 671 shows an alternative way that line 666 (including hypertext link 667) of FIG. 6G may appear in the event that an authorized party has previously initiated a dispute. As shown in balloon 671, in this case the user is presented with “Add” button 668(a), as described above, in addition to “Comment” button 668(b), which also preferably provides a user who is authorized to comment thereon an opportunity to do so. In this regard, screen view 670 shows a non-limiting exemplary view of the interface that may be presented in the event that the system user clicks on the “Comment” button 668(b) to open a supplemental page summarizing such dispute(s) and providing an opportunity for such user to express his or her opinion thereon. By way of example, but not limitation, description 672 indicates the basis of a hypothetical dispute—in this non-limiting example, that a particular patent user (673) contends that the patent is a substitute that it does not use and has no plans to use, and the patent owner disagrees. Hypertext link 674 provides a link to reviews written by other users concerning this dispute between the patent user and the patent owner. Additionally, tabs 675 permit the user to hide, as illustrated by tab 675(a), or reveal, as illustrated by tab 675(b), the disputing parties' respective summary position statements. As shown therein, statement 675(c) illustrates such a summary, which in a preferred embodiment may include links to the factual record, 675(d) as well as supplemental factual evidence 675(e) posted by such user in support thereof.

As with group collaboration systems employed in other fields including eBay and eOpinions, among others, part of the strength of the disclosed system and method comes from the ability in a preferred embodiment to rate the comments of other parties, as well as to rate the raters thereof. Thus, inquiry 676 permits system users who are not directly involved in the dispute to indicate which position they tend to favor, and preferably an opportunity to normalize and record this information as shown in scale 677(a). Although a wide variety of interfaces may be employed in order to fulfill these objectives, the user may be able to move selection wand 677(b) from left to right along the stated scale, with the indicated preference (illustrated by 677(c)) appearing depending on the instant position of selection wand 677(b). In addition to such standardized data, query 678 and free-text box 679 provide an opportunity for written comments to be articulated in furtherance of such normalized rating.

FIG. 6I provides yet an additional non-limiting view (680) of the group collaboration features of a preferred embodiment of the system. As shown therein, identifier text 681 provides an indication of the subject matter (in this case, the patent itself) to which such review(s) pertain, such as, in this instance the patent number and title thereof. Although persons of ordinary skill in the art will understand that similar reviews may be provided concerning a variety of subjects, including among other things reviews of various reviewers, the interface is described with respect to the non-limiting example of reviews of a patent as described in FIG. 6G. In this regard, titles 682(a) and 682(b) reflect the titles given by reviewers in text field 663; and star ratings 683(a) and 683(b) indicate the ratings provided by such reviewers in response to query 660. Similarly, reviews 684(a) and 684(b) indicate, respectively, the free text entry into field 665(a) in response to query 664 by each such reviewer.

In a preferred embodiment, category 685 may also be shown to the extent that one or more disputes exist and that the user has additionally provided comments on this (or these) disputes. For example, link 686(a) indicates one such dispute between a patent user and the patent owner, and provides a hypertext link to the summary of each party's positions (such as reported in 675(a) and 675(b) of FIG. 6H. Additionally, rating 686(b) indicates the rating provided by this user in response to query 676; and review 687 indicates the free text entry given by such user in field 679 in response to query 678. Finally, query 688 may afford a user an opportunity, as discussed above, to rate the rating. By way of example, as shown in FIG. 6I, the user may be given a choice between a variety of alternative ratings, such as 689(a)-689(d).

FIG. 6I also illustrates that in a preferred embodiment, both the identity and history of each reviewer could additionally be provided. Thus, for example, reviewer identity 690(a) and 690(b) may indicate the authors, respectively, of reviews 682(a) and 682(b); and hypertext links 691(a) and 691(b) may permit each user to read the submitted profile (if any) for each such reviewer. Reviewer histories 692(a) and 692(b) may summarize the number of third-party users who have reviewed these comments and, in a preferred embodiment, by possibly responding to inquiry 688, provided a rating thereof. In such instances, summaries 693(a) and 693(b) may provide the average of such ratings and links 694(a) and 694(b) may additionally provide an opportunity to see all such ratings. Finally, in a preferred embodiment, the system could keep track of such ratings and provide an indication of the reliability of the rating party. By way of a non-limiting example, this indication of reliability may preferably be bifurcated to reflect the rating among system users who are patent owners, illustrated by 695(a) and 695(b), and among system users who are patent users, illustrated by rating 696.

Now turning to FIG. 7, it will be observed that a flow diagram is provided in order to illustrate yet another optional feature of one preferred embodiment wherein the system used to generate various factors (i.e., relevancy factors as described above with respect to column 605 of FIG. 6A, allocation formulas as described above with respect to steps 401 and 404 of FIG. 4A, adjustments for removing patents from the patent pool as described above with respect to steps 501 and 505 of FIG. 5A and others) is modified in order to additionally take into account the activity of one or more users of the system. Thus, as described herein, the algorithms, clusters, vectors and/or data matrices that are traditionally employed in calculating such factors are optionally modified to take into account information concerning patents that are deemed to be substitutes and that are removed from the pool on this basis, as well as the outcome of appeals respecting the allocation of royalties among the patent pool participants.

As will be evident from the ensuing description, the herein disclosed technique for incorporating information educed from the activities of system users is very versatile in that it can be tailored to enhance numerous operations of the system. As such, the point of contact of oval 701, which is designated “Start,” and oval 713, designated “End,” are intended to link the optional sub-routine into the system at one or preferably multiple points.

In accordance with this optional feature, as depicted by step 702, an initial set of relevant patents is compiled from a corpus based on one or more of the methods known in the art being applied to such corpus. Thus, for example, in the case of estimating relevancy, the corpus is likely to be comprised of all issued patents, or perhaps all issued patents within a particular field or for a specific country. Alternatively, for assessing allocation factors, the corpus may be limited solely to those patents in excess of a particular minimum threshold of relevance or to those patents that are included in the patent pool. And in other contexts, the corpus may include those patents that at least one user has declared to be a substitute, or that have been removed from the patent pool on that basis.

As depicted by step 703, this set of relevant patents is then ranked on the basis of one or more traditional methods, as previously described, and an initial ranking for each patent, x, in such returned set of relevant patents is generated, which rank is referred to herein and in step 703 as OldScore (x₀). Thus, by way of example, as previously described, the corpus of all issued patents may be analyzed using any of a variety of known and/or commercially available methods to ascertain an initial rank, from which a relevancy rating may be ascertained. In another simplified example, a licensee electing to remove one patent from a patent pool consisting of a total of 100 patents may achieve a reduction in the royalty rate from 100× to 99× if all patents in the pool are presumed to be of equal value. And in yet another example, a patent owner contributing a total of 25 patents out of a total of 250 patents in a patent pool may anticipate being allocated 10% of the total royalty fees, net of any administrative overhead charges, if all 250 patents in the pool are presumed to be of equal value; or the patent owner may be allocated a greater or lesser percentage of such total net royalty income based, for example, on a variety of allocation formulas as described above, including but not limited to the allocation formula of one preferred embodiment disclosed herein. Within each of these examples, the resultant is referred to as x₀ for the purposes hereof.

Next, as depicted by decision step 704, the system inquires whether any relevant information has been educed during the process of appealing royalty allocation estimates, as more particularly described with respect to FIG. 4, above. As illustrated therein, a “No” response to this inquiry would be anticipated to occur in the event that no appeals have been commenced (corresponding to a “No” response in decision step 402 of FIG. 4) or that any appeal that has been commenced has resulted in reaffirming the original allocation. In such cases, as FIG. 7 illustrates, this results in skipping step 705 and proceeding directly to decision step 706.

Alternatively, a “Yes” response in decision step 704 indicates that information can be educed from such appeals process (or processes) that was not be capable of being ascertained simply through traditional analytics and that may be relevant to establishing the relative value of one or more patents included in the patent pool. For example, if as part of the appeals process described above, one or more patents was shown to be entitled to a less substantial (or to no portion of the) allocation, then the system could in a preferred embodiment incorporate this information into, for example, refining the relevancy ratings shown in column 605 of FIG. 6A. Similarly, if the interaction between system participants, polling process, third-party arbitration and/or the courts resulted in according to one asset a larger allocation of the value of the patent pool, then a well-ordered system could similarly integrate this data, where applicable.

In such instances, as illustrated by step 705, the system calculates a second value, referred to herein as “LocalScore (x₁)” for each patent in the generated set of patents. The LocalScore (x₁) for each patent x is based on the relative weight given to that patent by the allocation formula resulting from the foregoing process.

For reasons that will be readily apparent to persons of ordinary skill in the art, patents that other patent holders consent to being entitled to earn a larger allocation of the royalty pool may have a higher LocalScore (xi); and patents receiving a smaller allocation of the royalty pool as a consequence of such allocation appeals process may tend to have a lower LocalScore (xi) value. In a preferred embodiment in which LocalScore (x₁) allocations are taken into account in calculating, for example, the savings resulting from a licensee removing a patent, this may result in decreasing the incremental savings associated with removing a patent with a smaller x₁ value. In turn, this may make it far more likely that a licensee may simply declare a patent with a small LocalScore (x₁) value to be a substitute but not seek to remove it from the patent pool inasmuch as the incremental cost of obtaining a license to that patent may be small compared with the value of avoiding the risk of costly patent litigation and/or “warehousing” the technology for possible future use.

Next, as depicted by decision step 706, the system inquires whether any relevant information has been educed during the process of declaring patents as substitutes and/or removing patents from the grant of license to the patent pool on this basis, as more particularly described above with respect to FIG. 5. As illustrated therein, a “No” response to this inquiry results in skipping step 707 and proceeding immediately to decision step 708. Alternatively, a “Yes” response to decision step 706 indicates that one or more users of the system have designated at least one patent within the patent pool as being a “substitute” (as such term is specially defined for the purposes hereof), and possibly one or more users has, on this basis, removed a patent from its license to the patent pool.

In this instance, as illustrated by step 707, the system calculates a second value, referred to herein as “LocalScore (x₂)” for each patent in the generated set of patents. By way of example, but not limitation, perhaps one non-limiting example of the function of the x₂ local score value is an instance in which a user declares a patent within the patent pool to be invalid (e.g., in one preferred embodiment, by selecting 623(f) in FIG. 6C), and where confronted with this assertion, the affected patent owner elects not to contest such characterization (either initially or following one or more unfavorable holdings in the process described above with regard to FIG. 5). As a result, the x₂ local score value for the subject patent, x, could be zero; and accordingly, in a preferred embodiment in which LocalScore (x₂) values are taken into account, the relevance of such invalid patent could be reduced to zero irrespective of how apparently “relevant” the patent appears on the basis of traditional analytics. Additionally, if the x₂ values are taken into account in calculating allocations, in this hypothetical case, no portion of the royalty fees paid to the patent pool would be allocated to the patent owner on account of such patent. Persons of ordinary skill in the art are well aware of the fact that no licensing scheme may be premised on invalid or expired rights, and will thus understand the value of a mechanism whereby this is result is automatically attained in the manner described.

A number of less extreme examples can be cited to illustrate the use of x₂ values in a preferred embodiment of the system. Compare, for instance, the seven cases shown in the table below, and wherein in each case, a patent pool has a total of twenty (20) licensees, some portion of which licensees declares a patent within the patent pool as being a substitute and some portion of which additionally elects (except in two cases) to remove the patent on this basis.

| Case number | 1 | 2 | 3 | 4 | 5 | 6 | 7 |
|---|---|---|---|---|---|---|---|
| Number of licensees | 20 | 20 | 20 | 20 | 20 | 20 | 20 |
| Number deeming “substitute” | 0 | 1 | 1 | 10 | 10 | 10 | 20 |
| Number electing to remove it | 0 | 0 | 1 | 1 | 5 | 10 | 20 |

| | | | |
|---|---|---|---|
| LocalScore (x₂) | Higher | 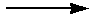 | Lower |

As the foregoing table indicates, the subject patent's x₂ value is higher where none of the 20 licensees declares the patent to be a substitute (i.e., case #1) than in case #7 wherein all 20 of the licensees consistently make this declaration and additionally propose to remove the subject patent from the patent pool on this basis. Each of the intermediate cases suggests a decline in the corresponding x₂ local score.

For example, comparing cases #1, #2 and #3, it is apparent that whereas one licensee out of 20 has, in case #2, deemed the patent as being a substitute (implicating a marginally lower x₂ score), that licensee is nonetheless unwilling to elect to remove the subject patent from the patent pool (all things being equal, implicating a higher x₂ score than in case #3, where the licensee also elected to remove such patent from the patent pool, thereby reducing its royalty rate but foregoing the protections of being licensed).

In this regard, it will be apparent that this optional feature of the system also preferably may take into account the reasons stated by the user for such decision. Thus, for example, if the reason that the user in case #3 indicated for declaring the patent to be a substitute and removing it on this basis was that the user is the owner or is already licensed under such patent (i.e., as appropriate, reason 623(a) or 623(b) in FIG. 6C), then the x₂ local score for cases #1 and #3 would be identical; and moreover case #3 would attain a higher x₂ rank than case #2 were the basis for declaring the sole patent deemed a substitute in that case any other reason (e.g., 623(c)-623(h) of FIG. 6C). Although not illustrated, persons of ordinary skill in the art will understand that the foregoing described approach may be employed for any number of additional attributes, assessments and assertions.

Next, as depicted by decision step 708, the system inquires whether any other results from the interactions among the parties should be considered. As illustrated therein, a “No” response to this inquiry results in skipping directly to step 711. Alternatively, a “Yes” response in decision step 708 indicates that one or more other factors arising from interactions by and among the parties may be of use in ranking the patents within the system.

In this case, as illustrated by step 709, such other data and/or information that may be useful in ranking patents within a given corpus is employed to generate one or more additional LocalFactors (x_{N}). This portion of the system is intentionally very flexible, thereby allowing a patent pool operator to tailor the system to include additional items that either reflect the wishes of the patent owners comprising such patent pool and/or are anticipated to address the needs of prospective licensees. Among other things, possible factors that may be considered in generating local score rankings include the share price, earnings or gross profit margin of companies adopting a particular patent or portfolio of patents, such that if a patent or group of patents can be directly correlated with superior economic performance versus an alternative patent or group of patents, a local factor value may reflect this material difference between substitutes.

Another potential local factor that a patent pool operator may wish to incorporate is the historical success in licensing third-parties and/or litigation, as well as the relative demand for a patent, as measured by how quickly users elect to incorporate patents into the patent pool, which LocalFactor persons of ordinary skill in the art will appreciate may be used to reward users taking a license at an earlier date versus those that are holdouts. As indicated in step 709, for each such factor until the answer to decision step 710 is “Yes,” the system calculates a rank, referred to herein as “LocalScore (x_{N})” for each patent in the generated set of patents.

Persons of ordinary skill in the art will realize that in a system such as the one contemplated herein, one or more users may endeavor to “game the system,” which is generally understood to mean that some users may attempt to manipulate the outcome in such a way in order to achieve a self-serving result and/or act in such a way so as to yield a result for which the system was not designed. Such “gaming” can take a variety of forms, the better known ones of which include the use of shills and frauds in online auctions (as experienced by eBay, among others); tricking information-retrieval software to give certain pages an artificially high rank (as experienced by Google, among others); and anonymous book reviews which turn out to come from authors (if pro) or their rivals (if con) (as experienced by Amazon, among others); and calls for coordinated action, such as to push a product or point of view up an electronic popularity list and/or to swing the results of a survey. Notwithstanding, persons of ordinary skill in the art will also appreciate that various methods have been devised to identify, intercept, discourage and overcome such efforts to game these systems. Step 711 contemplates the integration of such techniques into the system in order to protect the aforementioned LocalScores (x₁-x_{N}) and other aspects of the system against such tampering.

As illustrated by step 712, consecutive “No” responses to decision steps 704, 706 and 708 may result in this optional feature of a preferred embodiment merely applying the aforementioned techniques (711) known in the art to deter and/or minimize the adverse effects of attempts to game the system before employing the original ranking, OldScore (x₀), to the patents in the patent pool for one or more of the intended purposes described above. Thus, by way of several non-limiting examples, it may be preferable that a party with 200 patents in a patent pool comprised of a total of 500 patents not have four-times as much influence in helping to resolve an issue as a second party with only fifty (50) patents in the pool; or it may be preferable to discount a rating provided by a reviewer who is consistently assessed by others as being unreliable.

As illustrated by rectangle 712, the system also calculates a final, new ranking value (x_{F}) for each patent in the generated set based on the relative rank for that patent from each of LocalScores x₁-x_{N}, as applicable, and uses that adjusted value for the intended purposes, as described above. This application is depicted by the line leading from step 712 to the “End” designation, shown as oval 713.

Although, as mentioned above, all of the features of the system are not required in order to practice the principles of the invention and thus some are optional, it is deemed apparent that each of the features illustrated in the accompanying drawings and the foregoing description are attractive and add to the usefulness of the invention. Thus, for example manual entry of information in open text documents may be employed for some of the steps in lieu of a preferred use of interactive computer systems and pre-designed templates. Likewise, certain steps of a preferred embodiment which employ automated entry, calculation and/or reporting, may be conducted by telephone, through manually written documents or semi-automatically though operation of the system processor and communication by modem, wired or wireless networking and the like.

As will be evident to persons who are skilled in the art, a well-ordered system may provide for the foregoing steps at any number of points in its operation. Accordingly, although these process steps are shown in the drawings and accompanying written description at particular points, it should be understood that this is illustrative only and does not suggest that some or all of these steps may not take place at other points during operation of the system.

Additionally, although the disclosure hereof has been stated by way of example of preferred embodiments, it will be evident that other adaptations and modifications may be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of this disclosure.

What is claimed is:

1. A patent pooling method implemented by a computer-based system, comprising the steps of:
forming a patent pool in the computer-based system, including two or more patents;
licensing collectively said patents to at least one licensee; and
allocating earnings of said patent pool among owners of said patents according to a predetermined formula that includes consideration of forward citation analysis.

2. The method of claim 1, wherein all of the patents included in said patent pool are essential patents.

3. The method of claim 1, wherein none of the patents included in said patent pool is an essential patent.

4. The method of claim 1, wherein the patents in said patent pool consist of both essential and non-essential patents.

5. The method of claim 1, further comprising the step of:
providing for regulatory oversight to the patent pool.

6. The method of claim 5, wherein said regulatory oversight concerns compliance with one or more antitrust regulations.

7. The method of claim 6, wherein said providing for regulatory oversight includes permitting access to said computer-based system for monitoring communications of said licensees and/or patent owners.

8. The method of claim 1, wherein said allocating on the basis of forward citation analysis is dynamic.

9. The method of claim 1, further comprising the step of:
establishing an appeals process that may be initiated by a member of said patent pool.

10. The method of claim 1, further comprising the step of:
communicating to members of said patent pool one or more alternative allocations of earnings of said patent pool.

11. The method of claim 1, further comprising the step of:
permitting one or more of said patent owners to vote on the appropriate allocation of earnings of the patent pool.

12. The method of claim 1, further comprising the step of:
calculating relevance scores for the patents in the patent pool.

13. The method of claim 12, further comprising the step of:
calculating a local score value for at least two of the patents in the patent pool; and
refining relevance scores for the patents in the patent pool based on said local score values.

14. The method of claim 1, further comprising the step of:
calculating a local score value for at least two of the patents in the patent pool; and
refining an allocation of earnings for the patents in the patent pool based on said local score values.

15. The method of claim 1, further comprising the step of:
permitting said licensee to designate patents in said patent pool as substitutes.

16. The method of claim 15, further comprising the step of:
adjusting an allocation of earnings of said patent pool among the owners of said patents on the basis of the designation of patents in said patent pool as substitutes.

17. The method of claim 1, further comprising the step of:
permitting said licensee to cause one or more patents to be selectively removed from the license to said patent pool.

18. The method of claim 17, further comprising the step of:
adjusting a royalty paid by said licensee on the basis of patents selectively removed from the license to said patent pool.

19. The method of claim 18, further comprising the step of:
adjusting an allocation of earnings paid on the basis of the adjustment of royalties following selective removal of one or more patents from the license to said patent pool.

20. The method of claim 1, further comprising the step of:
permitting owners of any patent in said patent pool to designate one or more patents as blocking one or more other patents.

21. The method of claim 20, further comprising the step of:
adjusting the allocation of earnings of said patent pool among the owners of said patents on the basis of the designation of patents in said patent pool as blocking.

22. The method of claim 1, wherein said computer-based system includes a computer program comprising computer-executable instructions represented in computer storage.

23. The method of claim 1, wherein said computer-based system includes a server that provides patent licensing-specific information to one or more users of said system.

24. A patent pooling method implemented by a computer-based system, comprising the steps of:
forming a patent pool in the computer-based system, including two or more patents;
licensing collectively said patents to at least one licensee; and
allocating earnings of said patent pool among owners of said patents according to a predetermined formula that includes consideration of backward citation analysis.

25. A patent pooling method implemented by a computer-based system, comprising the steps of:
forming a patent pool in the computer-based system, including two or more patents;
offering a collective license on said patents to at least one prospective licensee;
permitting one or more prospective licensee to designate patents in said patent pool as substitutes; and
adjusting a royalty paid by one or more prospective licensee of the basis of patents selectively removed from the license to said patent pool.

26. A patent pooling method implemented by a computer-based system, comprising the steps of:
forming a patent pool in the computer-based system, including two or more patents;
entering into a license covering some portion or all of said patents with at least one licensee;
permitting said patent owners to designate one or more patents in said patent pool that block other patents; and
adjusting an allocation of earnings of said pool among the owners of said patents on the basis of said designation.

27. A system for patent pooling, comprising:
(a) at least one CPU having a processor configured to execute patent pool management and/or royalty allocation functions;
(b) means for communicating with owners of two or more patents concerning formation of a patent pool and collectively licensing rights under said patents to at least one licensee;
(c) means for allocating earnings of said patent pool among the owners of said patents on the basis of a formula that takes into account one or more factors including forward citation analysis.

28. The system of claim 27, wherein all of the patents included in said patent pool are essential patents.

29. The system of claim 27, wherein none of the patents included in said patent pool is an essential patent.

30. The system of claim 27, wherein the patents in said patent pool consist of both essential and non-essential patents.

31. The system of claim 27, further comprising:
means for providing for regulatory oversight to said patent pool.

32. The system of claim 31, wherein said regulatory oversight concerns compliance with one or more antitrust regulations.

33. The system of claim 32, wherein said means for providing of regulatory oversight includes permitting access to said computer-based system for monitoring communications of said licensees and/or patent owners.

34. The system of claim 27, wherein said means for allocating on the basis of forward citation analysis is dynamic.

35. The system of claim 27, further comprising:
means for a member of said patent pool to appeal said allocation of earnings.

36. The system of claim 27, further comprising the step of:
means for communicating to members of said patent pool one or more alternative allocations of earnings of said patent pool.

37. The system of claim 27, further comprising:
means for one or more of said patent owners to vote on the appropriate allocation of earnings of the patent pool.

38. The system of claim 27, further comprising:
means for calculating relevance scores for the patents in the patent pool.

39. The system of claim 38, further comprising:
means for calculating a local score value for at least two of the patents in the patent pool; and
means for refining relevance scores for the patents in the patent pool based on said local score values.

40. The system of claim 27, further comprising:
means for calculating a local score value for at least two of the patents in the patent pool; and
means for refining an allocation of earnings for the patents in the patent pool based on said local score values.

41. The system of claim 27, further comprising:
means for said at least one licensee to designate patents in said patent pool as substitutes.

42. The system of claim 41, further comprising:
means for adjusting an allocation of earnings of said patent pool among the owners of said patents on the basis of the designation of patents in said patent pool as substitutes.

43. The system of claim 27, further comprising:
means for said at least one licensee to cause one or more patents to be selectively removed from the license to said patent pool.

44. The system of claim 43, further comprising:
means for adjusting a royalty paid by said at least one licensee on the basis of patents selectively removed from the license to said patent pool.

45. The system of claim 44, further comprising:
means for adjusting an allocation of earnings paid on the basis of the adjustment of royalties following selective removal of one or more patents from the license to said patent pool.

46. The system of claim 27, further comprising:
means for an owner of any patent in said patent pool to designate one or more patents as blocking one or more other patents.

47. The system of claim 46, further comprising:
means for adjusting the allocation of earnings of said patent pool among the owners of said patents on the basis of the designation of patents in said patent pool as blocking.

48. A system for patent pooling, comprising:
(a) at least one CPU having a processor configured to execute patent pool management and/or royalty allocation functions;
(b) means for communicating with owners of two or more patents concerning formation of a patent pool and collectively licensing rights under said patents to at least one licensee; and
(c) means for allocating earnings of said patent pool among the owners of said patents on the basis of a formula that takes into account one or more factors including backward citation analysis.

49. A system for patent pooling, comprising:
(a) at least one CPU having a processor configured to execute patent pool management and/or royalty allocation functions;
(b) means for communicating with owners of two or more patents concerning formation of a patent pool and collectively licensing rights under said patents to at least one licensee;
(c) means for permitting one or more licensees to designate patents in said patent pool as substitutes;
(d) means for permitting one or more licensees to selectively remove one or more patents from the license to said patent pool; and
(e) means for adjusting the royalty paid by said one or more licensees on the basis of any patents selectively removed from said patent pool.

50. The system of claim 49, further comprising:
means for adjusting an allocation of earnings of said patent pool among the owners of said patents.

51. A system for patent pooling, comprising:
(a) at least one CPU having a processor configured to execute patent pool management and/or royalty allocation functions;
(b) means for communicating with owners of two or more patents concerning formation of a patent pool and collectively licensing rights under said patents to at least one licensee;
(c) means for permitting said patent owners to designate one or more patents in said patent pool as blocking one or more other patents; and
(d) means for adjusting the royalty paid by one or more licensees on the basis of any patents designated as blocking.

52. The system of claim 51, further comprising:
means for adjusting an allocation of earnings of said patent pool among the owners of said patents.
